(19) United States
(12) Patent Application Publication
(10) Pub. No.: US 2026/0003476 A1
(43) Pub. Date: Jan. 1, 2026

(54) USER INTERFACES FOR LOCATION CATEGORIZATION ON MAPS

(71) Applicant: Apple Inc., Cupertino, CA (US)

(72) Inventor: Johnson VINOTH KUMAR, Redwood City, CA (US)

(21) Appl. No.: 19/226,749

(22) Filed: Jun. 3, 2025

Related U.S. Application Data
(60) Provisional application No. 63/657,840, filed on Jun. 8, 2024.

(51) Int. Cl. G06F 3/0482; G01C 21/00; G01C 21/36; G06F 3/04817; G06F 3/0484

(52) U.S. Cl. CPC G06F 3/0482; G01C 21/3673; G01C 21/3811; G06F 3/04817; G06F 3/0484

(57) ABSTRACT

In some embodiments, an electronic device displays representation of one or more locations included in a user interface for a mapping application. In some embodiments, a representation of a location is displayed with a visual appearance that corresponds to a category that the corresponding location is associated with. In some embodiments, the category is one of a plurality of categories included in a library managed by an electronic device.

### CROSS REFERENCE TO RELATED APPLICATIONS

This application claims the benefit of U.S. Provisional Application No. 63/657,840, filed Jun. 8, 2024, the content of which is herein incorporated by reference in its entirety for all purposes.

### FIELD OF THE DISCLOSURE

This disclosure relates generally to an electronic device presenting user interfaces for mapping applications.

### BACKGROUND OF THE DISCLOSURE

User interaction with electronic devices has increased significantly in recent years. These devices can be devices such as computers, tablet computers, televisions, multimedia devices, or mobile devices. In some circumstances, users may wish to display locations on a map. The user may therefore desire efficient ways of displaying the user interface for locations on the map.

### SUMMARY OF THE DISCLOSURE

Providing efficient ways of displaying locations on a map enhances user interactions with the electronic device by reducing the time and inputs needed to view information represented by the user interface. Providing efficient ways of representing locations on a map enhances user interactions with the electronic device by reducing time and inputs needed to determine a corresponding category of the location and/or reducing inputs otherwise required to identify the location.

The full descriptions of the embodiments are provided in the Drawings and the Detailed Description, and it is understood that the Summary provided above does not limit the scope of the disclosure in any way.

It is well understood that the use of personally identifiable information should follow privacy policies and practices that are generally recognized as meeting or exceeding industry or governmental requirements for maintaining the privacy of users. In particular, personally identifiable information data should be managed and handled so as to minimize risks of unintentional or unauthorized access or use, and the nature of authorized use should be clearly indicated to users.

### BRIEF DESCRIPTION OF THE DRAWINGS

For a better understanding of the various described embodiments, reference should be made to the Detailed Description below, in conjunction with the following drawings in which like reference numerals refer to corresponding parts throughout the figures.

FIG. 1A is a block diagram illustrating a portable multifunction device with a touch-sensitive display in accordance with some embodiments.

FIG. 1B is a block diagram illustrating exemplary components for event handling in accordance with some embodiments.

FIG. 2 illustrates a portable multifunction device having a touch screen in accordance with some embodiments.

FIGS. 3A-3G is a block diagram of an exemplary multifunction device with a display and a touch-sensitive surface in accordance with some embodiments.

FIG. 4A illustrates an exemplary user interface for a menu of applications on a portable multifunction device in accordance with some embodiments.

FIG. 4B illustrates an exemplary user interface for a multifunction device with a touch-sensitive surface that is separate from the display in accordance with some embodiments.

FIG. 5A illustrates a personal electronic device in accordance with some embodiments.

FIG. 5B is a block diagram illustrating a personal electronic device in accordance with some embodiments.

FIGS. 5C-5D illustrate exemplary components of a personal electronic device having a touch-sensitive display and intensity sensors in accordance with some embodiments.

FIGS. 5E-5H illustrate exemplary components and user interfaces of a personal electronic device in accordance with some embodiments.

FIGS. 6A-6S illustrate exemplary ways in which an electronic device displays a representation of a location in a mapping user interface in accordance with some embodiments of the disclosure.

FIG. 7 illustrates a flow diagram illustrating a method in which an electronic device displays a representation of a location in a mapping user interface in accordance with some embodiments of the disclosure.

### DETAILED DESCRIPTION

In the following description of embodiments, reference is made to the accompanying drawings which form a part hereof, and in which it is shown by way of illustration specific embodiments that are optionally practiced. It is to be understood that other embodiments are optionally used, and structural changes are optionally made without departing from the scope of the disclosed embodiments.

Providing efficient ways of displaying locations on a map enhances user interactions with the electronic device by reducing the time and inputs needed to view information represented by the user interface. Providing efficient ways of representing locations on a map enhances user interactions with the electronic device by reducing time and inputs needed to determine a corresponding category of the location and/or reducing inputs otherwise required to identify the location.

Although the following description uses terms “first,” “second,” etc. to describe various elements, these elements should not be limited by the terms. These terms are only used to distinguish one element from another. For example, a first touch could be termed a second touch, and, similarly, a second touch could be termed a first touch, without departing from the scope of the various described embodiments. The first touch and the second touch are both touches, but they are not the same touch.

The terminology used in the description of the various described embodiments herein is for the purpose of describing particular embodiments only and is not intended to be limiting. As used in the description of the various described embodiments and the appended claims, the singular forms “a,” “an,” and “the” are intended to include the plural forms as well, unless the context clearly indicates otherwise. It will also be understood that the term “and/or” as used herein refers to and encompasses any and all possible combinations of one or more of the associated listed items. It will be further understood that the terms “includes,” “including,” “comprises,” and/or “comprising,” when used in this specification, specify the presence of stated features, integers, steps, operations, elements, and/or components, but do not preclude the presence or addition of one or more other features, integers, steps, operations, elements, components, and/or groups thereof.

The term “if” is, optionally, construed to mean “when” or “upon” or “in response to determining” or “in response to detecting,” depending on the context. Similarly, the phrase “if it is determined” or “if [a stated condition or event] is detected” is, optionally, construed to mean “upon determining” or “in response to determining” or “upon detecting [the stated condition or event]” or “in response to detecting [the stated condition or event],” depending on the context.

### Exemplary Devices

Embodiments of electronic devices, user interfaces for such devices, and associated processes for using such devices are described. In some embodiments, the device is a portable communications device, such as a mobile telephone, that also contains other functions, such as PDA and/or music player functions. Exemplary embodiments of portable multifunction devices include, without limitation, the iPhone®, iPod Touch®, and iPad® devices from Apple Inc. of Cupertino, California. Other portable electronic devices, such as laptops or tablet computers with touch-sensitive surfaces (e.g., touch screen displays and/or touch pads), are, optionally, used. It should also be understood that, in some embodiments, the device is not a portable communications device, but is a desktop computer or a television with a touch-sensitive surface (e.g., a touch screen display and/or a touch pad). In some embodiments, the device does not have a touch screen display and/or a touch pad, but rather is capable of outputting display information (such as the user interfaces of the disclosure) for display on a separate display device, and capable of receiving input information from a separate input device having one or more input mechanisms (such as one or more buttons, a touch screen display and/or a touch pad). In some embodiments, the device has a display, but is capable of receiving input information from a separate input device having one or more input mechanisms (such as one or more buttons, a touch screen display and/or a touch pad). In some embodiments, the electronic device is a computer system that is in communication (e.g., via wireless communication, via wired communication) with a display generation component (e.g., a display device such as a head-mounted device (HMD), a display, a projector, a touch-sensitive display, or other device or component that presents visual content to a user, for example, on or in the display generation component itself or produced from the display generation component and visible elsewhere). The display generation component is configured to provide visual output, such as display via a CRT display, display via an LED display, or display via image projection. In some embodiments, the display generation component is integrated with the computer system. In some embodiments, the display generation component is separate from the computer system. As used herein, “displaying” content includes causing to display the content (e.g., video data rendered or decoded by display controller 156) by transmitting, via a wired or wireless connection, data (e.g., image data or video data) to an integrated or external display generation component to visually produce the content.

In the discussion that follows, an electronic device that includes a display and a touch-sensitive surface is described. It should be understood, however, that the electronic device optionally includes one or more other physical user-interface devices, such as a physical keyboard, a mouse and/or a joystick. Further, as described above, it should be understood that the described electronic device, display and touch-sensitive surface are optionally distributed amongst two or more devices. Therefore, as used in this disclosure, information displayed on the electronic device or by the electronic device is optionally used to describe information outputted by the electronic device for display on a separate display device (touch-sensitive or not). Similarly, as used in this disclosure, input received on the electronic device (e.g., touch input received on a touch-sensitive surface of the electronic device) is optionally used to describe input received on a separate input device, from which the electronic device receives input information.

The device typically supports a variety of applications, such as one or more of the following: a drawing application, a presentation application, a word processing application, a website creation application, a disk authoring application, a spreadsheet application, a gaming application, a telephone application, a video conferencing application, an e-mail application, an instant messaging application, a workout support application, a photo management application, a digital camera application, a digital video camera application, a web browsing application, a digital music player application, a television channel browsing application, and/or a digital video player application.

The various applications that are executed on the device optionally use at least one common physical user-interface device, such as the touch-sensitive surface. One or more functions of the touch-sensitive surface as well as corresponding information displayed on the device are, optionally, adjusted and/or varied from one application to the next and/or within a respective application. In this way, a common physical architecture (such as the touch-sensitive surface) of the device optionally supports the variety of applications with user interfaces that are intuitive and transparent to the user.

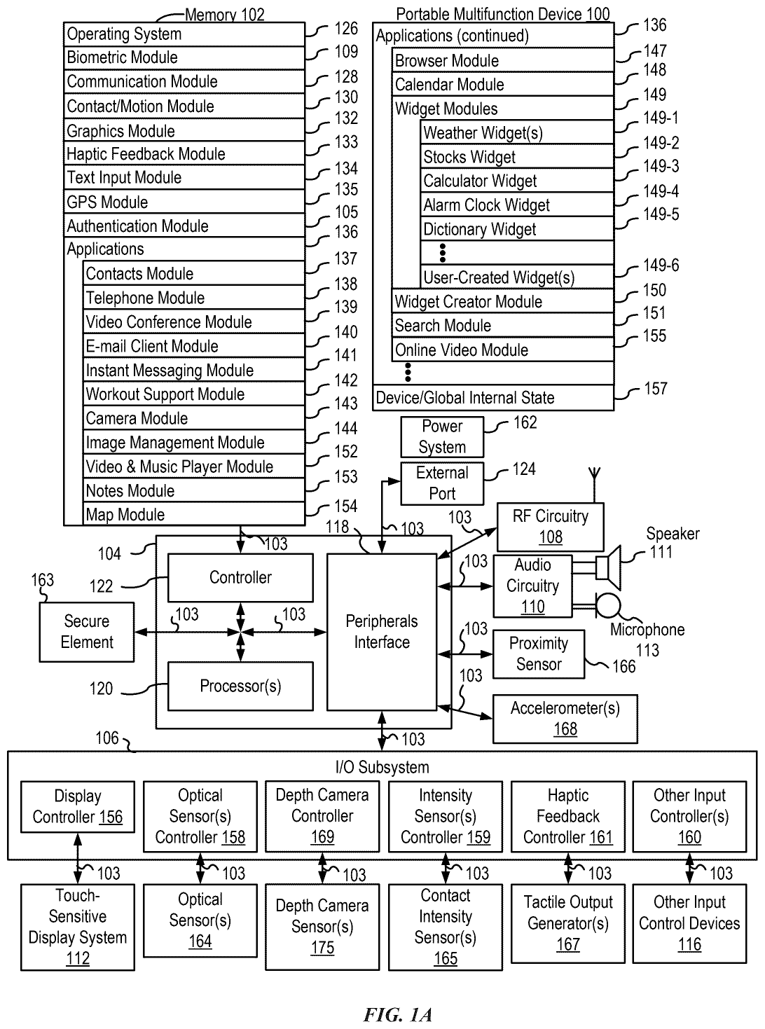

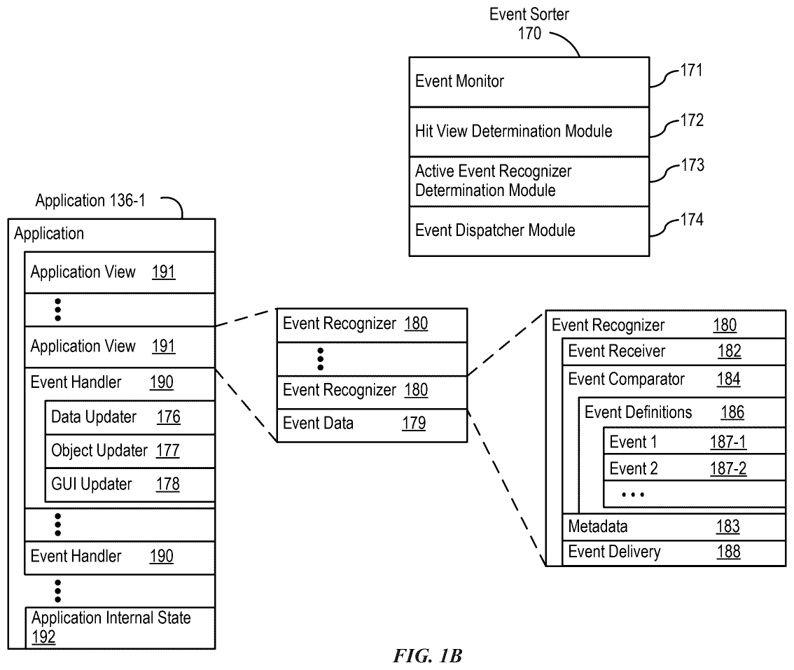

Attention is now directed toward embodiments of portable or non-portable devices with touch-sensitive displays, though the devices need not include touch-sensitive displays or displays in general, as described above. FIG. 1A is a block diagram illustrating portable or non-portable multifunction device 100 with touch-sensitive displays 112 in accordance with some embodiments. Touch-sensitive display 112 is sometimes called a “touch screen” for convenience, and is sometimes known as or called a touch-sensitive display system. Device 100 includes memory 102 (which optionally includes one or more computer readable storage mediums), memory controller 122, one or more processing units (CPU's) 120, peripherals interface 118, RF circuitry 108, audio circuitry 110, speaker 111, microphone 113, input/output (I/O) subsystem 106, other input or control devices 116, and external port 124. Device 100 optionally includes one or more optical sensors 164. Device 100 optionally includes one or more contact intensity sensors 165 for detecting intensity of contacts on device 100 (e.g., a touch-sensitive surface such as touch-sensitive display system 112 of device 100). Device 100 optionally includes one or more tactile output generators 167 for generating tactile outputs on device 100 (e.g., generating tactile outputs on a touch-sensitive surface such as touch-sensitive display system 112 of device 100 or touchpad 355 of device 300). These components optionally communicate over one or more communication buses or signal lines 103.

As used in the specification and claims, the term “intensity” of a contact on a touch-sensitive surface refers to the force or pressure (force per unit area) of a contact (e.g., a finger contact) on the touch-sensitive surface, or to a substitute (proxy) for the force or pressure of a contact on the touch-sensitive surface. The intensity of a contact has a range of values that includes at least four distinct values and more typically includes hundreds of distinct values (e.g., at least 256). Intensity of a contact is, optionally, determined (or measured) using various approaches and various sensors or combinations of sensors. For example, one or more force sensors underneath or adjacent to the touch-sensitive surface are, optionally, used to measure force at various points on the touch-sensitive surface. In some implementations, force measurements from multiple force sensors are combined (e.g., a weighted average) to determine an estimated force of a contact. Similarly, a pressure-sensitive tip of a stylus is, optionally, used to determine a pressure of the stylus on the touch-sensitive surface. Alternatively, the size of the contact area detected on the touch-sensitive surface and/or changes thereto, the capacitance of the touch-sensitive surface proximate to the contact and/or changes thereto, and/or the resistance of the touch-sensitive surface proximate to the contact and/or changes thereto are, optionally, used as a substitute for the force or pressure of the contact on the touch-sensitive surface. In some implementations, the substitute measurements for contact force or pressure are used directly to determine whether an intensity threshold has been exceeded (e.g., the intensity threshold is described in units corresponding to the substitute measurements). In some implementations, the substitute measurements for contact force or pressure are converted to an estimated force or pressure and the estimated force or pressure is used to determine whether an intensity threshold has been exceeded (e.g., the intensity threshold is a pressure threshold measured in units of pressure). Using the intensity of a contact as an attribute of a user input allows for user access to additional device functionality that may otherwise not be accessible by the user on a reduced-size device with limited real estate for displaying affordances (e.g., on a touch-sensitive display) and/or receiving user input (e.g., via a touch-sensitive display, a touch-sensitive surface, or a physical/mechanical control such as a knob or a button).

As used in the specification and claims, the term “tactile output” refers to physical displacement of a device relative to a previous position of the device, physical displacement of a component (e.g., a touch-sensitive surface) of a device relative to another component (e.g., housing) of the device, or displacement of the component relative to a center of mass of the device that will be detected by a user with the user's sense of touch. For example, in situations where the device or the component of the device is in contact with a surface of a user that is sensitive to touch (e.g., a finger, palm, or other part of a user's hand), the tactile output generated by the physical displacement will be interpreted by the user as a tactile sensation corresponding to a perceived change in physical characteristics of the device or the component of the device. For example, movement of a touch-sensitive surface (e.g., a touch-sensitive display or trackpad) is, optionally, interpreted by the user as a “down click” or “up click” of a physical actuator button. In some cases, a user will feel a tactile sensation such as a “down click” or “up click” even when there is no movement of a physical actuator button associated with the touch-sensitive surface that is physically pressed (e.g., displaced) by the user's movements. As another example, movement of the touch-sensitive surface is, optionally, interpreted or sensed by the user as “roughness” of the touch-sensitive surface, even when there is no change in smoothness of the touch-sensitive surface. While such interpretations of touch by a user will be subject to the individualized sensory perceptions of the user, there are many sensory perceptions of touch that are common to a large majority of users. Thus, when a tactile output is described as corresponding to a particular sensory perception of a user (e.g., an “up click,” a “down click,” “roughness”), unless otherwise stated, the generated tactile output corresponds to physical displacement of the device or a component thereof that will generate the described sensory perception for a typical (or average) user.

It should be appreciated that device 100 is only one example of a portable or non-portable multifunction device, and that device 100 optionally has more or fewer components than shown, optionally combines two or more components, or optionally has a different configuration or arrangement of the components. The various components shown in FIG. 1A are implemented in hardware, software, or a combination of both hardware and software, including one or more signal processing and/or application specific integrated circuits. Further, the various components shown in FIG. 1A are optionally implemented across two or more devices; for example, a display and audio circuitry on a display device, a touch-sensitive surface on an input device, and remaining components on device 100. In such an embodiment, device 100 optionally communicates with the display device and/or the input device to facilitate operation of the system, as described in the disclosure, and the various components described herein that relate to display and/or input remain in device 100, or are optionally included in the display and/or input device, as appropriate.

Memory 102 optionally includes high-speed random access memory and optionally also includes non-volatile memory, such as one or more magnetic disk storage devices, flash memory devices, or other non-volatile solid-state memory devices. Memory controller 122 optionally controls access to memory 102 by other components of device 100.

Peripherals interface 118 can be used to couple input and output peripherals of the device to CPU 120 and memory 102. The one or more processors 120 run or execute various software programs and/or sets of instructions stored in memory 102 to perform various functions for device 100 and to process data.

In some embodiments, peripherals interface 118, CPU 120, and memory controller 122 are, optionally, implemented on a single chip, such as chip 104. In some other embodiments, they are, optionally, implemented on separate chips.

RF (radio frequency) circuitry 108 receives and sends RF signals, also called electromagnetic signals. RF circuitry 108 converts electrical signals to/from electromagnetic signals and communicates with communications networks and other communications devices via the electromagnetic signals. RF circuitry 108 optionally includes well-known circuitry for performing these functions, including but not limited to an antenna system, an RF transceiver, one or more amplifiers, a tuner, one or more oscillators, a digital signal processor, a CODEC chipset, a subscriber identity module (SIM) card, memory, and so forth. RF circuitry 108 optionally communicates with networks, such as the Internet, also referred to as the World Wide Web (WWW), an intranet and/or a wireless network, such as a cellular telephone network, a wireless local area network (LAN) and/or a metropolitan area network (MAN), and other devices by wireless communication. The RF circuitry 108 optionally includes well-known circuitry for detecting near field communication (NFC) fields, such as by a short-range communication radio. The wireless communication optionally uses any of a plurality of communications standards, protocols, and technologies, including but not limited to Global System for Mobile Communications (GSM), Enhanced Data GSM Environment (EDGE), high-speed downlink packet access (HSDPA), high-speed uplink packet access (HSUPA), Evolution, Data-Only (EV-DO), HSPA, HSPA+, Dual-Cell HSPA (DC-HSPDA), long term evolution (LTE), near field communication (NFC), wideband code division multiple access (W-CDMA), code division multiple access (CDMA), time division multiple access (TDMA), Bluetooth, Bluetooth Low Energy (BTLE), Wireless Fidelity (Wi-Fi) (e.g., IEEE 802.11a, IEEE 802.11b, IEEE 802.11g, IEEE 802.11n, and/or IEEE 802.11ac), voice over Internet Protocol (VOIP), Wi-MAX, a protocol for e-mail (e.g., Internet message access protocol (IMAP) and/or post office protocol (POP)), instant messaging (e.g., extensible messaging and presence protocol (XMPP), Session Initiation Protocol for Instant Messaging and Presence Leveraging Extensions (SIMPLE), Instant Messaging and Presence Service (IMPS)), and/or Short Message Service (SMS), or any other suitable communication protocol, including communication protocols not yet developed as of the filing date of this document.

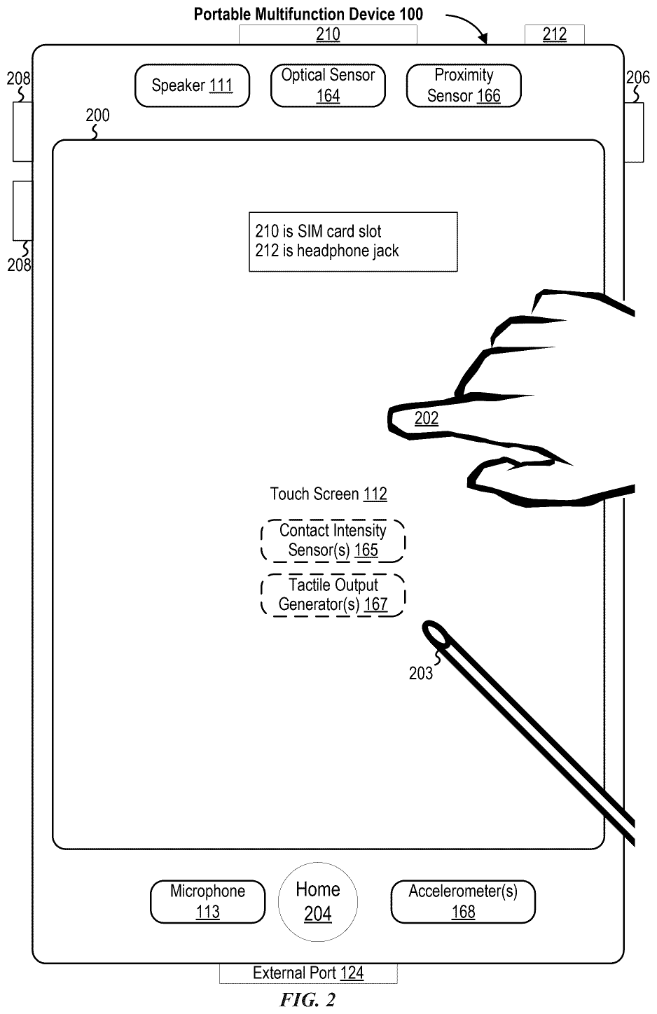

Audio circuitry 110, speaker 111, and microphone 113 provide an audio interface between a user and device 100. Audio circuitry 110 receives audio data from peripherals interface 118, converts the audio data to an electrical signal, and transmits the electrical signal to speaker 111. Speaker 111 converts the electrical signal to human-audible sound waves. Audio circuitry 110 also receives electrical signals converted by microphone 113 from sound waves. Audio circuitry 110 converts the electrical signal to audio data and transmits the audio data to peripherals interface 118 for processing. Audio data is, optionally, retrieved from and/or transmitted to memory 102 and/or RF circuitry 108 by peripherals interface 118. In some embodiments, audio circuitry 110 also includes a headset jack (e.g., 212, FIG. 2). The headset jack provides an interface between audio circuitry 110 and removable audio input/output peripherals, such as output-only headphones or a headset with both output (e.g., a headphone for one or both ears) and input (e.g., a microphone).

I/O subsystem 106 couples input/output peripherals on device 100, such as touch screen 112 and other input control devices 116, to peripherals interface 118. I/O subsystem 106 optionally includes display controller 156, optical sensor controller 158, intensity sensor controller 159, haptic feedback controller 161 and one or more input controllers 160 for other input or control devices. The one or more input controllers 160 receive/send electrical signals from/to other input or control devices 116. The other input control devices 116 optionally include physical buttons (e.g., push buttons, rocker buttons, etc.), dials, slider switches, joysticks, click wheels, and so forth. In some alternate embodiments, input controller(s) 160 are, optionally, coupled to any (or none) of the following: a keyboard, infrared port, USB port, and a pointer device such as a mouse. The one or more buttons (e.g., 208, FIG. 2) optionally include an up/down button for volume control of speaker 111 and/or microphone 113. The one or more buttons optionally include a push button (e.g., 206, FIG. 2).

A quick press of the push button optionally disengages a lock of touch screen 112 or optionally begins a process that uses gestures on the touch screen to unlock the device, as described in U.S. patent application Ser. No. 11/322,549, “Unlocking a Device by Performing Gestures on an Unlock Image,” filed Dec. 23, 2005, U.S. Pat. No. 7,657,849, which is hereby incorporated by reference in its entirety. A longer press of the push button (e.g., 206) optionally turns power to device 100 on or off. The functionality of one or more of the buttons are, optionally, user-customizable. Touch screen 112 is used to implement virtual or soft buttons and one or more soft keyboards.

Touch-sensitive display 112 provides an input interface and an output interface between the device and a user. As described above, the touch-sensitive operation and the display operation of touch-sensitive display 112 are optionally separated from each other, such that a display device is used for display purposes and a touch-sensitive surface (whether display or not) is used for input detection purposes, and the described components and functions are modified accordingly. However, for simplicity, the following description is provided with reference to a touch-sensitive display. Display controller 156 receives and/or sends electrical signals from/to touch screen 112. Touch screen 112 displays visual output to the user. The visual output optionally includes graphics, text, icons, video, and any combination thereof (collectively termed “graphics”). In some embodiments, some or all of the visual output corresponds to user-interface objects.

Touch screen 112 has a touch-sensitive surface, sensor or set of sensors that accepts input from the user based on haptic and/or tactile contact. Touch screen 112 and display controller 156 (along with any associated modules and/or sets of instructions in memory 102) detect contact (and any movement or breaking of the contact) on touch screen 112 and convert the detected contact into interaction with user-interface objects (e.g., one or more soft keys, icons, web pages or images) that are displayed on touch screen 112. In an exemplary embodiment, a point of contact between touch screen 112 and the user corresponds to a finger of the user.

Touch screen 112 optionally uses LCD (liquid crystal display) technology, LPD (light emitting polymer display) technology, or LED (light emitting diode) technology, although other display technologies are used in other embodiments. Touch screen 112 and display controller 156 optionally detect contact and any movement or breaking thereof using any of a plurality of touch sensing technologies now known or later developed, including but not limited to capacitive, resistive, infrared, and surface acoustic wave technologies, as well as other proximity sensor arrays or other elements for determining one or more points of contact with touch screen 112. In an exemplary embodiment, projected mutual capacitance sensing technology is used, such as that found in the iPhone®, iPod Touch®, and iPad® from Apple Inc. of Cupertino, California.

A touch-sensitive display in some embodiments of touch screen 112 is, optionally, analogous to the multi-touch sensitive touchpads described in the following U.S. Pat. No. 6,323,846 (Westerman et al.), U.S. Pat. No. 6,570,557 (Westerman et al.), and/or U.S. Pat. No. 6,677,932 (Westerman), and/or U.S. Patent Publication 2002/0015024A1, each of which is hereby incorporated by reference in its entirety. However, touch screen 112 displays visual output from device 100, whereas touch-sensitive touchpads do not provide visual output.

A touch-sensitive display in some embodiments of touch screen 112 is described in the following applications: (1) U.S. patent application Ser. No. 11/381,313, “Multipoint Touch Surface Controller,” filed May 2, 2006; (2) U.S. patent application Ser. No. 10/840,862, “Multipoint Touchscreen,” filed May 6, 2004; (3) U.S. patent application Ser. No. 10/903,964, “Gestures For Touch Sensitive Input Devices,” filed Jul. 30, 2004; (4) U.S. patent application Ser. No. 11/48,264, “Gestures For Touch Sensitive Input Devices,” filed Jan. 31, 2005; (5) U.S. patent application Ser. No. 11/38,590, “Mode-Based Graphical User Interfaces For Touch Sensitive Input Devices,” filed Jan. 18, 2005; (6) U.S. patent application Ser. No. 11/228,758, “Virtual Input Device Placement On A Touch Screen User Interface,” filed Sep. 16, 2005; (7) U.S. patent application Ser. No. 11/228,700, “Operation Of A Computer With A Touch Screen Interface,” filed Sep. 16, 2005; (8) U.S. patent application Ser. No. 11/228,737, “Activating Virtual Keys Of A Touch-Screen Virtual Keyboard,” filed Sep. 16, 2005; and (9) U.S. patent application Ser. No. 11/367,749, “Multi-Functional Hand-Held Device,” filed Mar. 3, 2006. All of these applications are incorporated by reference herein in their entirety.

Touch screen 112 optionally has a video resolution in excess of 100 dpi. In some embodiments, the touch screen has a video resolution of approximately 160 dpi. The user optionally makes contact with touch screen 112 using any suitable object or appendage, such as a stylus, a finger, and so forth. In some embodiments, the user interface is designed to work primarily with finger-based contacts and gestures, which can be less precise than stylus-based input due to the larger area of contact of a finger on the touch screen. In some embodiments, the device translates the rough finger-based input into a precise pointer/cursor position or command for performing the actions desired by the user.

In some embodiments, in addition to the touch screen, device 100 optionally includes a touchpad (not shown) for activating or deactivating particular functions. In some embodiments, the touchpad is a touch-sensitive area of the device that, unlike the touch screen, does not display visual output. The touchpad is, optionally, a touch-sensitive surface that is separate from touch screen 112 or an extension of the touch-sensitive surface formed by the touch screen.

Device 100 also includes power system 162 for powering the various components. Power system 162 optionally includes a power management system, one or more power sources (e.g., battery, alternating current (AC)), a recharging system, a power failure detection circuit, a power converter or inverter, a power status indicator (e.g., a light-emitting diode (LED)) and any other components associated with the generation, management and distribution of power in portable or non-portable devices.

Device 100 optionally also includes one or more optical sensors 164. FIG. 1A shows an optical sensor coupled to optical sensor controller 158 in I/O subsystem 106. Optical sensor 164 optionally includes charge-coupled device (CCD) or complementary metal-oxide semiconductor (CMOS) phototransistors. Optical sensor 164 receives light from the environment, projected through one or more lenses, and converts the light to data representing an image. In conjunction with imaging module 143 (also called a camera module), optical sensor 164 optionally captures still images or video. In some embodiments, an optical sensor is located on the back of device 100, opposite touch screen display 112 on the front of the device so that the touch screen display is enabled for use as a viewfinder for still and/or video image acquisition. In some embodiments, an optical sensor is located on the front of the device so that the user's image is, optionally, obtained for video conferencing while the user views the other video conference participants on the touch screen display. In some embodiments, the position of optical sensor 164 can be changed by the user (e.g., by rotating the lens and the sensor in the device housing) so that a single optical sensor 164 is used along with the touch screen display for both video conferencing and still and/or video image acquisition.

Device 100 optionally also includes one or more contact intensity sensors 165. FIG. 1A shows a contact intensity sensor coupled to intensity sensor controller 159 in I/O subsystem 106. Contact intensity sensor 165 optionally includes one or more piezoresistive strain gauges, capacitive force sensors, electric force sensors, piezoelectric force sensors, optical force sensors, capacitive touch-sensitive surfaces, or other intensity sensors (e.g., sensors used to measure the force (or pressure) of a contact on a touch-sensitive surface). Contact intensity sensor 165 receives contact intensity information (e.g., pressure information or a proxy for pressure information) from the environment. In some embodiments, at least one contact intensity sensor is collocated with, or proximate to, a touch-sensitive surface (e.g., touch-sensitive display system 112). In some embodiments, at least one contact intensity sensor is located on the back of device 100, opposite touch screen display 112 which is located on the front of device 100.

Device 100 optionally also includes one or more proximity sensors 166. FIG. 1A shows proximity sensor 166 coupled to peripherals interface 118. Alternately, proximity sensor 166 is, optionally, coupled to input controller 160 in I/O subsystem 106. Proximity sensor 166 optionally performs as described in U.S. patent application Ser. No. 11/241,839, “Proximity Detector In Handheld Device”; Ser. No. 11/240,788, “Proximity Detector In Handheld Device”; Ser. No. 11/620,702, “Using Ambient Light Sensor To Augment Proximity Sensor Output”; Ser. No. 11/586,862, “Automated Response To And Sensing Of User Activity In Portable Devices”; and Ser. No. 11/638,251, “Methods And Systems For Automatic Configuration Of Peripherals,” which are hereby incorporated by reference in their entirety. In some embodiments, the proximity sensor turns off and disables touch screen 112 when the multifunction device is placed near the user's ear (e.g., when the user is making a phone call).

Device 100 optionally also includes one or more tactile output generators 167. FIG. 1A shows a tactile output generator coupled to haptic feedback controller 161 in I/O subsystem 106. Tactile output generator 167 optionally includes one or more electroacoustic devices such as speakers or other audio components and/or electromechanical devices that convert energy into linear motion such as a motor, solenoid, electroactive polymer, piezoelectric actuator, electrostatic actuator, or other tactile output generating component (e.g., a component that converts electrical signals into tactile outputs on the device). Contact intensity sensor 165 receives tactile feedback generation instructions from haptic feedback module 133 and generates tactile outputs on device 100 that are capable of being sensed by a user of device 100. In some embodiments, at least one tactile output generator is collocated with, or proximate to, a touch-sensitive surface (e.g., touch-sensitive display system 112) and, optionally, generates a tactile output by moving the touch-sensitive surface vertically (e.g., in/out of a surface of device 100) or laterally (e.g., back and forth in the same plane as a surface of device 100). In some embodiments, at least one tactile output generator sensor is located on the back of device 100, opposite touch screen display 112 which is located on the front of device 100.

Device 100 optionally also includes one or more accelerometers 168. FIG. 1A shows accelerometer 168 coupled to peripherals interface 118. Alternately, accelerometer 168 is, optionally, coupled to an input controller 160 in I/O subsystem 106. Accelerometer 168 optionally performs as described in U.S. Patent Publication No. 20050190059, “Acceleration-based Theft Detection System for Portable Electronic Devices,” and U.S. Patent Publication No. 20060017692, “Methods And Apparatuses For Operating A Portable Device Based On An Accelerometer,” both of which are incorporated by reference herein in their entirety. In some embodiments, information is displayed on the touch screen display in a portrait view or a landscape view based on an analysis of data received from the one or more accelerometers. Device 100 optionally includes, in addition to accelerometer(s) 168, a magnetometer (not shown) and a GPS (or GLONASS or other global navigation system) receiver (not shown) for obtaining information concerning the location and orientation (e.g., portrait or landscape) of device 100.

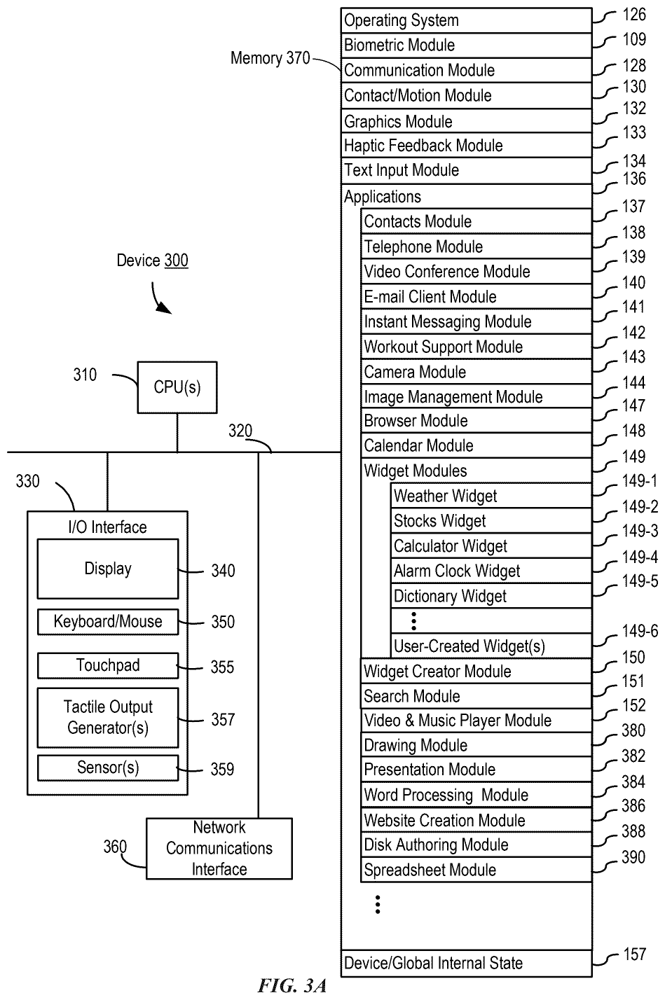

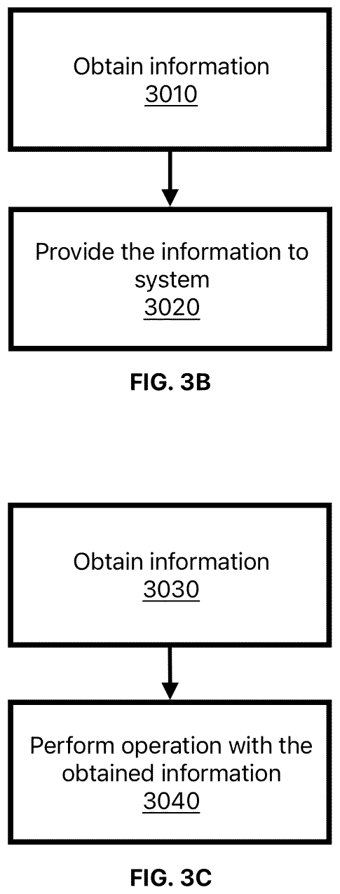

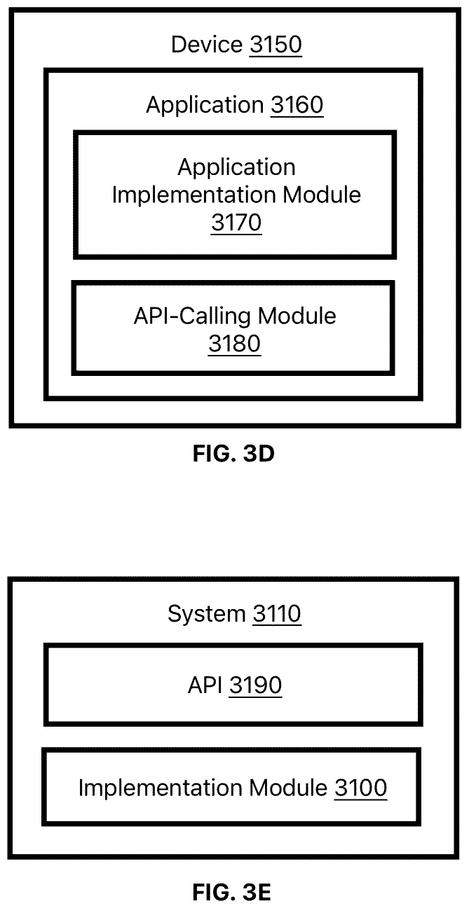

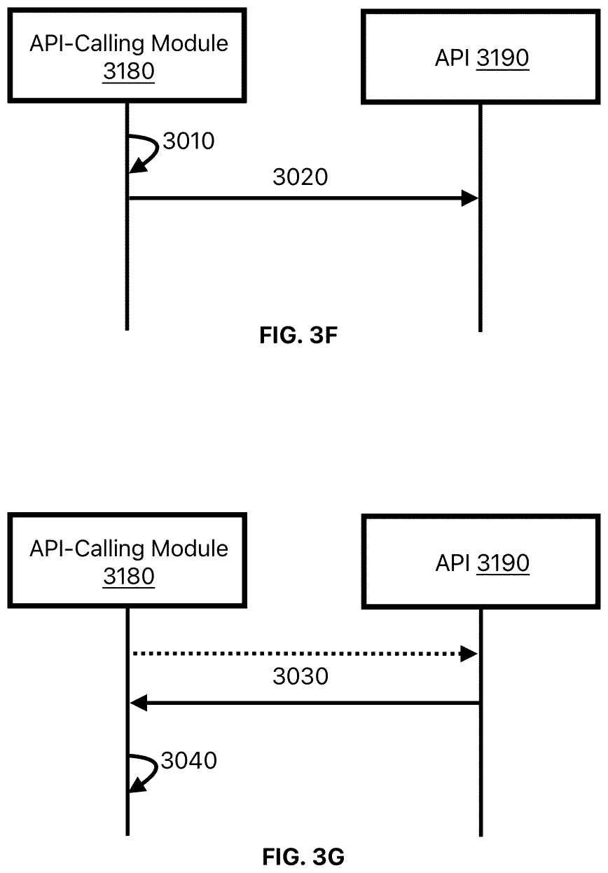

In some embodiments, the software components stored in memory 102 include operating system 126, communication module (or set of instructions) 128, contact/motion module (or set of instructions) 130, graphics module (or set of instructions) 132, text input module (or set of instructions) 134, Global Positioning System (GPS) module (or set of instructions) 135, and applications (or sets of instructions) 136. Furthermore, in some embodiments, memory 102 (FIG. 1A) or 370 (FIG. 3A) stores device/global internal state 157, as shown in FIGS. 1A and 3. Device/global internal state 157 includes one or more of: active application state, indicating which applications, if any, are currently active; display state, indicating what applications, views or other information occupy various regions of touch screen display 112; sensor state, including information obtained from the device's various sensors and input control devices 116; and location information concerning the device's location and/or attitude.

Operating system 126 (e.g., Darwin, RTXC, LINUX, UNIX, OS X, IOS, WINDOWS, or an embedded operating system such as VxWorks) includes various software components and/or drivers for controlling and managing general system tasks (e.g., memory management, storage device control, power management, etc.) and facilitates communication between various hardware and software components.

Communication module 128 facilitates communication with other devices over one or more external ports 124 and also includes various software components for handling data received by RF circuitry 108 and/or external port 124. External port 124 (e.g., Universal Serial Bus (USB), FIREWIRE, etc.) is adapted for coupling directly to other devices or indirectly over a network (e.g., the Internet, wireless LAN, etc.). In some embodiments, the external port is a multi-pin (e.g., 30-pin) connector that is the same as, or similar to and/or compatible with the 30-pin connector used on iPod (trademark of Apple Inc.) devices.

Contact/motion module 130 optionally detects contact with touch screen 112 (in conjunction with display controller 156) and other touch-sensitive devices (e.g., a touchpad or physical click wheel). Contact/motion module 130 includes various software components for performing various operations related to detection of contact, such as determining if contact has occurred (e.g., detecting a finger-down event), determining an intensity of the contact (e.g., the force or pressure of the contact or a substitute for the force or pressure of the contact) determining if there is movement of the contact and tracking the movement across the touch-sensitive surface (e.g., detecting one or more finger-dragging events), and determining if the contact has ceased (e.g., detecting a finger-up event or a break in contact). Contact/motion module 130 receives contact data from the touch-sensitive surface. Determining movement of the point of contact, which is represented by a series of contact data, optionally includes determining speed (magnitude), velocity (magnitude and direction), and/or an acceleration (a change in magnitude and/or direction) of the point of contact. These operations are, optionally, applied to single contacts (e.g., one finger contacts) or to multiple simultaneous contacts (e.g., “multitouch”/multiple finger contacts). In some embodiments, contact/motion module 130 and display controller 156 detect contact on a touchpad.

In some embodiments, contact/motion module 130 uses a set of one or more intensity thresholds to determine whether an operation has been performed by a user (e.g., to determine whether a user has “clicked” on an icon). In some embodiments at least a subset of the intensity thresholds are determined in accordance with software parameters (e.g., the intensity thresholds are not determined by the activation thresholds of particular physical actuators and can be adjusted without changing the physical hardware of device 100). For example, a mouse “click” threshold of a trackpad or touch screen display can be set to any of a large range of predefined threshold values without changing the trackpad or touch screen display hardware. Additionally, in some implementations a user of the device is provided with software settings for adjusting one or more of the set of intensity thresholds (e.g., by adjusting individual intensity thresholds and/or by adjusting a plurality of intensity thresholds at once with a system-level click “intensity” parameter).

Contact/motion module 130 optionally detects a gesture input by a user. Different gestures on the touch-sensitive surface have different contact patterns (e.g., different motions, timings, and/or intensities of detected contacts). Thus, a gesture is, optionally, detected by detecting a particular contact pattern. For example, detecting a finger tap gesture includes detecting a finger-down event followed by detecting a finger-up (liftoff) event at the same position (or substantially the same position) as the finger-down event (e.g., at the position of an icon). As another example, detecting a finger swipe gesture on the touch-sensitive surface includes detecting a finger-down event followed by detecting one or more finger-dragging events, and subsequently followed by detecting a finger-up (liftoff) event.

Graphics module 132 includes various known software components for rendering and displaying graphics on touch screen 112 or other display, including components for changing the visual impact (e.g., brightness, transparency, saturation, contrast or other visual property) of graphics that are displayed. As used herein, the term “graphics” includes any object that can be displayed to a user, including without limitation text, web pages, icons (such as user-interface objects including soft keys), digital images, videos, animations and the like.

In some embodiments, graphics module 132 stores data representing graphics to be used. Each graphic is, optionally, assigned a corresponding code. Graphics module 132 receives, from applications etc., one or more codes specifying graphics to be displayed along with, if necessary, coordinate data and other graphic property data, and then generates screen image data to output to display controller 156.

Haptic feedback module 133 includes various software components for generating instructions used by tactile output generator(s) 167 to produce tactile outputs at one or more locations on device 100 in response to user interactions with device 100.

Text input module 134, which is, optionally, a component of graphics module 132, provides soft keyboards for entering text in various applications (e.g., contacts 137, e-mail 140, IM 141, browser 147, and any other application that needs text input).

GPS module 135 determines the location of the device and provides this information for use in various applications (e.g., to telephone 138 for use in location-based dialing, to camera 143 as picture/video metadata, and to applications that provide location-based services such as weather widgets, local yellow page widgets, and map/navigation widgets).

Applications 136 optionally include the following modules (or sets of instructions), or a subset or superset thereof:
contacts module 137 (sometimes called an address book or contact list);
telephone module 138;
video conferencing module 139;
e-mail client module 140;
instant messaging (IM) module 141;
workout support module 142;
camera module 143 for still and/or video images;
image management module 144;
video player module;
music player module;
browser module 147;
calendar module 148;
widget modules 149, which optionally include one or more of: weather widget 149-1, stocks widget 149-2, calculator widget 149-3, alarm clock widget 149-4, dictionary widget 149-5, and other widgets obtained by the user, as well as user-created widgets 149-6;
widget creator module 150 for making user-created widgets 149-6;
search module 151;
video and music player module 152, which merges video player module and music player module;
notes module 153;
map module 154; and/or
online video module 155.

Examples of other applications 136 that are, optionally, stored in memory 102 include other word processing applications, other image editing applications, drawing applications, presentation applications, JAVA-enabled applications, encryption, digital rights management, voice recognition, and voice replication.

In conjunction with touch screen 112, display controller 156, contact/motion module 130, graphics module 132, and text input module 134, contacts module 137 are, optionally, used to manage an address book or contact list (e.g., stored in application internal state 192 of contacts module 137 in memory 102 or memory 370), including: adding name(s) to the address book; deleting name(s) from the address book; associating telephone number(s), e-mail address(es), physical address(es) or other information with a name; associating an image with a name; categorizing and sorting names; providing telephone numbers or e-mail addresses to initiate and/or facilitate communications by telephone 138, video conference module 139, e-mail 140, or IM 141; and so forth.

In conjunction with RF circuitry 108, audio circuitry 110, speaker 111, microphone 113, touch screen 112, display controller 156, contact/motion module 130, graphics module 132, and text input module 134, telephone module 138 are optionally, used to enter a sequence of characters corresponding to a telephone number, access one or more telephone numbers in contacts module 137, modify a telephone number that has been entered, dial a respective telephone number, conduct a conversation, and disconnect or hang up when the conversation is completed. As noted above, the wireless communication optionally uses any of a plurality of communications standards, protocols, and technologies.

In conjunction with RF circuitry 108, audio circuitry 110, speaker 111, microphone 113, touch screen 112, display controller 156, optical sensor 164, optical sensor controller 158, contact/motion module 130, graphics module 132, text input module 134, contacts module 137, and telephone module 138, video conference module 139 includes executable instructions to initiate, conduct, and terminate a video conference between a user and one or more other participants in accordance with user instructions.

In conjunction with RF circuitry 108, touch screen 112, display controller 156, contact/motion module 130, graphics module 132, and text input module 134, e-mail client module 140 includes executable instructions to create, send, receive, and manage e-mail in response to user instructions. In conjunction with image management module 144, e-mail client module 140 makes it very easy to create and send e-mails with still or video images taken with camera module 143.

In conjunction with RF circuitry 108, touch screen 112, display controller 156, contact/motion module 130, graphics module 132, and text input module 134, the instant messaging module 141 includes executable instructions to enter a sequence of characters corresponding to an instant message, to modify previously entered characters, to transmit a respective instant message (for example, using a Short Message Service (SMS) or Multimedia Message Service (MMS) protocol for telephony-based instant messages or using XMPP, SIMPLE, or IMPS for Internet-based instant messages), to receive instant messages, and to view received instant messages. In some embodiments, transmitted and/or received instant messages optionally include graphics, photos, audio files, video files and/or other attachments as are supported in an MMS and/or an Enhanced Messaging Service (EMS). As used herein, “instant messaging” refers to both telephony-based messages (e.g., messages sent using SMS or MMS) and Internet-based messages (e.g., messages sent using XMPP, SIMPLE, or IMPS).

In conjunction with RF circuitry 108, touch screen 112, display controller 156, contact/motion module 130, graphics module 132, text input module 134, GPS module 135, map module 154, and music player module, workout support module 142 includes executable instructions to create workouts (e.g., with time, distance, and/or calorie burning goals); communicate with workout sensors (sports devices); receive workout sensor data; calibrate sensors used to monitor a workout; select and play music for a workout; and display, store, and transmit workout data.

In conjunction with touch screen 112, display controller 156, optical sensor(s) 164, optical sensor controller 158, contact/motion module 130, graphics module 132, and image management module 144, camera module 143 includes executable instructions to capture still images or video (including a video stream) and store them into memory 102, modify characteristics of a still image or video, or delete a still image or video from memory 102.

In conjunction with touch screen 112, display controller 156, contact/motion module 130, graphics module 132, text input module 134, and camera module 143, image management module 144 includes executable instructions to arrange, modify (e.g., edit), or otherwise manipulate, label, delete, present (e.g., in a digital slide show or album), and store still and/or video images.

In conjunction with RF circuitry 108, touch screen 112, display controller 156, contact/motion module 130, graphics module 132, and text input module 134, browser module 147 includes executable instructions to browse the Internet in accordance with user instructions, including searching, linking to, receiving, and displaying web pages or portions thereof, as well as attachments and other files linked to web pages.

In conjunction with RF circuitry 108, touch screen 112, display controller 156, contact/motion module 130, graphics module 132, text input module 134, e-mail client module 140, and browser module 147, calendar module 148 includes executable instructions to create, display, modify, and store calendars and data associated with calendars (e.g., calendar entries, to-do lists, etc.) in accordance with user instructions.

In conjunction with RF circuitry 108, touch screen 112, display controller 156, contact/motion module 130, graphics module 132, text input module 134, and browser module 147, widget modules 149 are mini-applications that are, optionally, downloaded and used by a user (e.g., weather widget 149-1, stocks widget 149-2, calculator widget 149-3, alarm clock widget 149-4, and dictionary widget 149-5) or created by the user (e.g., user-created widget 149-6). In some embodiments, a widget includes an HTML (Hypertext Markup Language) file, a CSS (Cascading Style Sheets) file, and a JavaScript file. In some embodiments, a widget includes an XML (Extensible Markup Language) file and a JavaScript file (e.g., Yahoo! Widgets).

In conjunction with RF circuitry 108, touch screen 112, display controller 156, contact/motion module 130, graphics module 132, text input module 134, and browser module 147, the widget creator module 150 are, optionally, used by a user to create widgets (e.g., turning a user-specified portion of a web page into a widget).

In conjunction with touch screen 112, display controller 156, contact/motion module 130, graphics module 132, and text input module 134, search module 151 includes executable instructions to search for text, music, sound, image, video, and/or other files in memory 102 that match one or more search criteria (e.g., one or more user-specified search terms) in accordance with user instructions.

In conjunction with touch screen 112, display controller 156, contact/motion module 130, graphics module 132, audio circuitry 110, speaker 111, RF circuitry 108, and browser module 147, video and music player module 152 includes executable instructions that allow the user to download and play back recorded music and other sound files stored in one or more file formats, such as MP3 or AAC files, and executable instructions to display, present, or otherwise play back videos (e.g., on touch screen 112 or on an external, connected display via external port 124). In some embodiments, device 100 optionally includes the functionality of an MP3 player, such as an iPod (trademark of Apple Inc.).

In conjunction with touch screen 112, display controller 156, contact/motion module 130, graphics module 132, and text input module 134, notes module 153 includes executable instructions to create and manage notes, to-do lists, and the like in accordance with user instructions.

In conjunction with RF circuitry 108, touch screen 112, display controller 156, contact/motion module 130, graphics module 132, text input module 134, GPS module 135, and browser module 147, map module 154 are, optionally, used to receive, display, modify, and store maps and data associated with maps (e.g., driving directions, data on stores and other points of interest at or near a particular location, and other location-based data) in accordance with user instructions.

In conjunction with touch screen 112, display controller 156, contact/motion module 130, graphics module 132, audio circuitry 110, speaker 111, RF circuitry 108, text input module 134, e-mail client module 140, and browser module 147, online video module 155 includes instructions that allow the user to access, browse, receive (e.g., by streaming and/or download), play back (e.g., on the touch screen or on an external, connected display via external port 124), send an e-mail with a link to a particular online video, and otherwise manage online videos in one or more file formats, such as H.264. In some embodiments, instant messaging module 141, rather than e-mail client module 140, is used to send a link to a particular online video. Additional description of the online video application can be found in U.S. Provisional Patent Application No. 60/936,562, “Portable Multifunction Device, Method, and Graphical User Interface for Playing Online Videos,” filed Jun. 20, 2007, and U.S. patent application Ser. No. 11/968,67, “Portable Multifunction Device, Method, and Graphical User Interface for Playing Online Videos,” filed Dec. 31, 2007, the contents of which are hereby incorporated by reference in their entirety.

Each of the above-identified modules and applications corresponds to a set of executable instructions for performing one or more functions described above and the methods described in this application (e.g., the computer-implemented methods and other information processing methods described herein). These modules (e.g., sets of instructions) need not be implemented as separate software programs, procedures, or modules, and thus various subsets of these modules are, optionally, combined or otherwise rearranged in various embodiments. For example, video player module is, optionally, combined with music player module into a single module (e.g., video and music player module 152, FIG. 1A). In some embodiments, memory 102 optionally stores a subset of the modules and data structures identified above. Furthermore, memory 102 optionally stores additional modules and data structures not described above.

In some embodiments, device 100 is a device where operation of a predefined set of functions on the device is performed exclusively through a touch screen and/or a touchpad. By using a touch screen and/or a touchpad as the primary input control device for operation of device 100, the number of physical input control devices (such as push buttons, dials, and the like) on device 100 is, optionally, reduced.

The predefined set of functions that are performed exclusively through a touch screen and/or a touchpad optionally include navigation between user interfaces. In some embodiments, the touchpad, when touched by the user, navigates device 100 to a main, home, or root menu from any user interface that is displayed on device 100. In such embodiments, a “menu button” is implemented using a touchpad. In some other embodiments, the menu button is a physical push button or other physical input control device instead of a touchpad.

FIG. 1B is a block diagram illustrating exemplary components for event handling in accordance with some embodiments. In some embodiments, memory 102 (FIG. 1A) or 370 (FIG. 3A) includes event sorter 170 (e.g., in operating system 126) and a respective application 136-1 (e.g., any of the aforementioned applications 137-151, 155, 380-390).

Event sorter 170 receives event information and determines the application 136-1 and application view 191 of application 136-1 to which to deliver the event information. Event sorter 170 includes event monitor 171 and event dispatcher module 174. In some embodiments, application 136-1 includes application internal state 192, which indicates the current application view(s) displayed on touch-sensitive display 112 when the application is active or executing. In some embodiments, device/global internal state 157 is used by event sorter 170 to determine which application(s) is (are) currently active, and application internal state 192 is used by event sorter 170 to determine application views 191 to which to deliver event information.

In some embodiments, application internal state 192 includes additional information, such as one or more of: resume information to be used when application 136-1 resumes execution, user interface state information that indicates information being displayed or that is ready for display by application 136-1, a state queue for enabling the user to go back to a prior state or view of application 136-1, and a redo/undo queue of previous actions taken by the user.

Event monitor 171 receives event information from peripherals interface 118. Event information includes information about a sub-event (e.g., a user touch on touch-sensitive display 112, as part of a multi-touch gesture). Peripherals interface 118 transmits information it receives from I/O subsystem 106 or a sensor, such as proximity sensor 166, accelerometer(s) 168, and/or microphone 113 (through audio circuitry 110). Information that peripherals interface 118 receives from I/O subsystem 106 includes information from touch-sensitive display 112 or a touch-sensitive surface.

In some embodiments, event monitor 171 sends requests to the peripherals interface 118 at predetermined intervals. In response, peripherals interface 118 transmits event information. In other embodiments, peripherals interface 118 transmits event information only when there is a significant event (e.g., receiving an input above a predetermined noise threshold and/or for more than a predetermined duration).

In some embodiments, event sorter 170 also includes a hit view determination module 172 and/or an active event recognizer determination module 173.

Hit view determination module 172 provides software procedures for determining where a sub-event has taken place within one or more views when touch-sensitive display 112 displays more than one view. Views are made up of controls and other elements that a user can see on the display.

Another aspect of the user interface associated with an application is a set of views, sometimes herein called application views or user interface windows, in which information is displayed and touch-based gestures occur. The application views (of a respective application) in which a touch is detected optionally correspond to programmatic levels within a programmatic or view hierarchy of the application. For example, the lowest level view in which a touch is detected is, optionally, called the hit view, and the set of events that are recognized as proper inputs are, optionally, determined based, at least in part, on the hit view of the initial touch that begins a touch-based gesture.

Hit view determination module 172 receives information related to sub-events of a touch-based gesture. When an application has multiple views organized in a hierarchy, hit view determination module 172 identifies a hit view as the lowest view in the hierarchy which should handle the sub-event. In most circumstances, the hit view is the lowest level view in which an initiating sub-event occurs (e.g., the first sub-event in the sequence of sub-events that form an event or potential event). Once the hit view is identified by the hit view determination module 172, the hit view typically receives all sub-events related to the same touch or input source for which it was identified as the hit view.

Active event recognizer determination module 173 determines which view or views within a view hierarchy should receive a particular sequence of sub-events. In some embodiments, active event recognizer determination module 173 determines that only the hit view should receive a particular sequence of sub-events. In other embodiments, active event recognizer determination module 173 determines that all views that include the physical location of a sub-event are actively involved views, and therefore determines that all actively involved views should receive a particular sequence of sub-events. In other embodiments, even if touch sub-events were entirely confined to the area associated with one particular view, views higher in the hierarchy would still remain as actively involved views.

Event dispatcher module 174 dispatches the event information to an event recognizer (e.g., event recognizer 180). In embodiments including active event recognizer determination module 173, event dispatcher module 174 delivers the event information to an event recognizer determined by active event recognizer determination module 173. In some embodiments, event dispatcher module 174 stores in an event queue the event information, which is retrieved by a respective event receiver 182.

In some embodiments, operating system 126 includes event sorter 170. Alternatively, application 136-1 includes event sorter 170. In yet other embodiments, event sorter 170 is a stand-alone module, or a part of another module stored in memory 102, such as contact/motion module 130.

In some embodiments, application 136-1 includes a plurality of event handlers 190 and one or more application views 191, each of which includes instructions for handling touch events that occur within a respective view of the application's user interface. Each application view 191 of the application 136-1 includes one or more event recognizers 180. Typically, a respective application view 191 includes a plurality of event recognizers 180. In other embodiments, one or more of event recognizers 180 are part of a separate module, such as a user interface kit (not shown) or a higher level object from which application 136-1 inherits methods and other properties. In some embodiments, a respective event handler 190 includes one or more of: data updater 176, object updater 177, GUI updater 178, and/or event data 179 received from event sorter 170. Event handler 190 optionally utilizes or calls data updater 176, object updater 177, or GUI updater 178 to update the application internal state 192. Alternatively, one or more of the application views 191 include one or more respective event handlers 190. Also, in some embodiments, one or more of data updater 176, object updater 177, and GUI updater 178 are included in a respective application view 191.

A respective event recognizer 180 receives event information (e.g., event data 179) from event sorter 170 and identifies an event from the event information. Event recognizer 180 includes event receiver 182 and event comparator 184. In some embodiments, event recognizer 180 also includes at least a subset of: metadata 183, and event delivery instructions 188 (which optionally include sub-event delivery instructions).

Event receiver 182 receives event information from event sorter 170. The event information includes information about a sub-event, for example, a touch or a touch movement. Depending on the sub-event, the event information also includes additional information, such as location of the sub-event. When the sub-event concerns motion of a touch, the event information optionally also includes speed and direction of the sub-event. In some embodiments, events include rotation of the device from one orientation to another (e.g., from a portrait orientation to a landscape orientation, or vice versa), and the event information includes corresponding information about the current orientation (also called device attitude) of the device.

Event comparator 184 compares the event information to predefined event or sub-event definitions and, based on the comparison, determines an event or sub-event, or determines or updates the state of an event or sub-event. In some embodiments, event comparator 184 includes event definitions 186. Event definitions 186 contain definitions of events (e.g., predefined sequences of sub-events), for example, event 1 (187-1), event 2 (187-2), and others. In some embodiments, sub-events in an event (187) include, for example, touch begin, touch end, touch movement, touch cancellation, and multiple touching. In one example, the definition for event 1 (187-1) is a double tap on a displayed object. The double tap, for example, comprises a first touch (touch begin) on the displayed object for a predetermined phase, a first liftoff (touch end) for a predetermined phase, a second touch (touch begin) on the displayed object for a predetermined phase, and a second liftoff (touch end) for a predetermined phase. In another example, the definition for event 2 (187-2) is a dragging on a displayed object. The dragging, for example, comprises a touch (or contact) on the displayed object for a predetermined phase, a movement of the touch across touch-sensitive display 112, and liftoff of the touch (touch end). In some embodiments, the event also includes information for one or more associated event handlers 190.

In some embodiments, event definition 187 includes a definition of an event for a respective user-interface object. In some embodiments, event comparator 184 performs a hit test to determine which user-interface object is associated with a sub-event. For example, in an application view in which three user-interface objects are displayed on touch-sensitive display 112, when a touch is detected on touch-sensitive display 112, event comparator 184 performs a hit test to determine which of the three user-interface objects is associated with the touch (sub-event). If each displayed object is associated with a respective event handler 190, the event comparator uses the result of the hit test to determine which event handler 190 should be activated. For example, event comparator 184 selects an event handler associated with the sub-event and the object triggering the hit test.

In some embodiments, the definition for a respective event (187) also includes delayed actions that delay delivery of the event information until after it has been determined whether the sequence of sub-events does or does not correspond to the event recognizer's event type.

When a respective event recognizer 180 determines that the series of sub-events do not match any of the events in event definitions 186, the respective event recognizer 180 enters an event impossible, event failed, or event ended state, after which it disregards subsequent sub-events of the touch-based gesture. In this situation, other event recognizers, if any, that remain active for the hit view continue to track and process sub-events of an ongoing touch-based gesture.

In some embodiments, a respective event recognizer 180 includes metadata 183 with configurable properties, flags, and/or lists that indicate how the event delivery system should perform sub-event delivery to actively involved event recognizers. In some embodiments, metadata 183 includes configurable properties, flags, and/or lists that indicate how event recognizers interact, or are enabled to interact, with one another. In some embodiments, metadata 183 includes configurable properties, flags, and/or lists that indicate whether sub-events are delivered to varying levels in the view or programmatic hierarchy.

In some embodiments, a respective event recognizer 180 activates event handler 190 associated with an event when one or more particular sub-events of an event are recognized. In some embodiments, a respective event recognizer 180 delivers event information associated with the event to event handler 190. Activating an event handler 190 is distinct from sending (and deferred sending) sub-events to a respective hit view. In some embodiments, event recognizer 180 throws a flag associated with the recognized event, and event handler 190 associated with the flag catches the flag and performs a predefined process.

In some embodiments, event delivery instructions 188 include sub-event delivery instructions that deliver event information about a sub-event without activating an event handler. Instead, the sub-event delivery instructions deliver event information to event handlers associated with the series of sub-events or to actively involved views. Event handlers associated with the series of sub-events or with actively involved views receive the event information and perform a predetermined process.

In some embodiments, data updater 176 creates and updates data used in application 136-1. For example, data updater 176 updates the telephone number used in contacts module 137, or stores a video file used in video player module. In some embodiments, object updater 177 creates and updates objects used in application 136-1. For example, object updater 177 creates a new user-interface object or updates the position of a user-interface object. GUI updater 178 updates the GUI. For example, GUI updater 178 prepares display information and sends it to graphics module 132 for display on a touch-sensitive display.

In some embodiments, event handler(s) 190 includes or has access to data updater 176, object updater 177, and GUI updater 178. In some embodiments, data updater 176, object updater 177, and GUI updater 178 are included in a single module of a respective application 136-1 or application view 191. In other embodiments, they are included in two or more software modules.

It shall be understood that the foregoing discussion regarding event handling of user touches on touch-sensitive displays also applies to other forms of user inputs to operate multifunction devices 100 with input devices, not all of which are initiated on touch screens. For example, mouse movement and mouse button presses, optionally coordinated with single or multiple keyboard presses or holds; contact movements such as taps, drags, scrolls, etc. on touchpads; pen stylus inputs; movement of the device; oral instructions; detected eye movements; biometric inputs; and/or any combination thereof are optionally utilized as inputs corresponding to sub-events which define an event to be recognized.

FIG. 2 illustrates a portable or non-portable multifunction device 100 having a touch screen 112 in accordance with some embodiments. As stated above, multifunction device 100 is described as having the various illustrated structures (such as touch screen 112, speaker 111, accelerometer 168, microphone 113, etc.); however, it is understood that these structures optionally reside on separate devices. For example, display-related structures (e.g., display, speaker, etc.) and/or functions optionally reside on a separate display device, input-related structures (e.g., touch-sensitive surface, microphone, accelerometer, etc.) and/or functions optionally reside on a separate input device, and remaining structures and/or functions optionally reside on multifunction device 100.

The touch screen 112 optionally displays one or more graphics within user interface (UI) 200. In this embodiment, as well as others described below, a user is enabled to select one or more of the graphics by making a gesture on the graphics, for example, with one or more fingers 202 (not drawn to scale in the figure) or one or more styluses 203 (not drawn to scale in the figure). In some embodiments, selection of one or more graphics occurs when the user breaks contact with the one or more graphics. In some embodiments, the gesture optionally includes one or more taps, one or more swipes (from left to right, right to left, upward and/or downward) and/or a rolling of a finger (from right to left, left to right, upward and/or downward) that has made contact with device 100. In some implementations or circumstances, inadvertent contact with a graphic does not select the graphic. For example, a swipe gesture that sweeps over an application icon optionally does not select the corresponding application when the gesture corresponding to selection is a tap.

Device 100 optionally also includes one or more physical buttons, such as “home” or menu button 204. As previously described, menu button 204 is, optionally, used to navigate to any application 136 in a set of applications that are, optionally executed on device 100. Alternatively, in some embodiments, the menu button is implemented as a soft key in a GUI displayed on touch screen 112.

In one embodiment, device 100 includes touch screen 112, menu button 204, push button 206 for powering the device on/off and locking the device, volume adjustment button(s) 208, Subscriber Identity Module (SIM) card slot 210, head set jack 212, and docking/charging external port 124. Push button 206 is, optionally, used to turn the power on/off on the device by depressing the button and holding the button in the depressed state for a predefined time interval; to lock the device by depressing the button and releasing the button before the predefined time interval has elapsed; and/or to unlock the device or initiate an unlock process. In an alternative embodiment, device 100 also accepts verbal input for activation or deactivation of some functions through microphone 113. Device 100 also, optionally, includes one or more contact intensity sensors 165 for detecting intensity of contacts on touch screen 112 and/or one or more tactile output generators 167 for generating tactile outputs for a user of device 100.

FIG. 3A is a block diagram of an exemplary multifunction device with a display and a touch-sensitive surface in accordance with some embodiments. Device 300 need not include the display and the touch-sensitive surface, as described above, but rather, in some embodiments, optionally communicates with the display and the touch-sensitive surface on other devices. Additionally, device 300 need not be portable. In some embodiments, device 300 is a laptop computer, a desktop computer, a tablet computer, a multimedia player device (such as a television or a set-top box), a navigation device, an educational device (such as a child's learning toy), a gaming system, or a control device (e.g., a home or industrial controller). Device 300 typically includes one or more processing units (CPU's) 310, one or more network or other communications interfaces 360, memory 370, and one or more communication buses 320 for interconnecting these components. Communication buses 320 optionally include circuitry (sometimes called a chipset) that interconnects and controls communications between system components. Device 300 includes input/output (I/O) interface 330 comprising display 340, which is typically a touch screen display. I/O interface 330 also optionally includes a keyboard and/or mouse (or other pointing device) 350 and touchpad 355, tactile output generator 357 for generating tactile outputs on device 300 (e.g., similar to tactile output generator(s) 167 described above with reference to FIG. 1A), sensors 359 (e.g., optical, acceleration, proximity, touch-sensitive, and/or contact intensity sensors similar to contact intensity sensor(s) 165 described above with reference to FIG. 1A). Memory 370 includes high-speed random access memory, such as DRAM, SRAM, DDR RAM or other random access solid state memory devices; and optionally includes non-volatile memory, such as one or more magnetic disk storage devices, optical disk storage devices, flash memory devices, or other non-volatile solid state storage devices. Memory 370 optionally includes one or more storage devices remotely located from CPU(s) 310. In some embodiments, memory 370 stores programs, modules, and data structures analogous to the programs, modules, and data structures stored in memory 102 of portable or non-portable multifunction device 100 (FIG. 1A), or a subset thereof. Furthermore, memory 370 optionally stores additional programs, modules, and data structures not present in memory 102 of portable or non-portable multifunction device 100. For example, memory 370 of device 300 optionally stores drawing module 380, presentation module 382, word processing module 384, website creation module 386, disk authoring module 388, and/or spreadsheet module 390, while memory 102 of portable or non-portable multifunction device 100 (FIG. 1A) optionally does not store these modules.

Each of the above identified elements in FIG. 3A are, optionally, stored in one or more of the previously mentioned memory devices. Each of the above identified modules corresponds to a set of instructions for performing a function described above. The above identified modules or programs (e.g., sets of instructions) need not be implemented as separate software programs, procedures or modules, and thus various subsets of these modules are, optionally, combined or otherwise re-arranged in various embodiments. In some embodiments, memory 370 optionally stores a subset of the modules and data structures identified above. Furthermore, memory 370 optionally stores additional modules and data structures not described above.

Implementations within the scope of the present disclosure can be partially or entirely realized using a tangible computer-readable storage medium (or multiple tangible computer-readable storage media of one or more types) encoding one or more computer-readable instructions. It should be recognized that computer-readable instructions can be organized in any format, including applications, widgets, processes, software, and/or components.

Implementations within the scope of the present disclosure include a computer-readable storage medium that encodes instructions organized as an application (e.g., application 3160) that, when executed by one or more processing units, control an electronic device (e.g., device 3150) to perform the method of FIG. 3B, the method of FIG. 3C, and/or one or more other processes and/or methods described herein.

It should be recognized that application 3160 (shown in FIG. 3D) can be any suitable type of application, including, for example, one or more of: a browser application, an application that functions as an execution environment for plug-ins, widgets or other applications, a fitness application, a health application, a digital payments application, a media application, a social network application, a messaging application, and/or a maps application. In some embodiments, application 3160 is an application that is pre-installed on device 3150 at purchase (e.g., a first-party application). In some embodiments, application 3160 is an application that is provided to device 3150 via an operating system update file (e.g., a first-party application or a second-party application). In some embodiments, application 3160 is an application that is provided via an application store. In some embodiments, the application store can be an application store that is pre-installed on device 3150 at purchase (e.g., a first-party application store). In some embodiments, the application store is a third-party application store (e.g., an application store that is provided by another application store, downloaded via a network, and/or read from a storage device).

Referring to FIG. 3B and FIG. 3F, application 3160 obtains information (e.g., 3010). In some embodiments, at 3010, information is obtained from at least one hardware component of device 3150. In some embodiments, at 3010, information is obtained from at least one software module of device 3150. In some embodiments, at 3010, information is obtained from at least one hardware component external to device 3150 (e.g., a peripheral device, an accessory device, and/or a server). In some embodiments, the information obtained at 3010 includes positional information, time information, notification information, user information, environment information, electronic device state information, weather information, media information, historical information, event information, hardware information, and/or motion information. In some embodiments, in response to and/or after obtaining the information at 3010, application 3160 provides the information to a system (e.g., 3020).

In some embodiments, the system (e.g., 3110 shown in FIG. 3E) is an operating system hosted on device 3150. In some embodiments, the system (e.g., 3110 shown in FIG. 3E) is an external device (e.g., a server, a peripheral device, an accessory, and/or a personal computing device) that includes an operating system.

Referring to FIG. 3C and FIG. 3G, application 3160 obtains information (e.g., 3030). In some embodiments, the information obtained at 3030 includes positional information, time information, notification information, user information, environment information electronic device state information, weather information, media information, historical information, event information, hardware information, and/or motion information. In response to and/or after obtaining the information at 3030, application 3160 performs an operation with the information (e.g., 3040). In some embodiments, the operation performed at 3040 includes: providing a notification based on the information, sending a message based on the information, displaying the information, controlling a user interface of a fitness application based on the information, controlling a user interface of a health application based on the information, controlling a focus mode based on the information, setting a reminder based on the information, adding a calendar entry based on the information, and/or calling an API of system 3110 based on the information.

In some embodiments, one or more steps of the method of FIG. 3B and/or the method of FIG. 3C is performed in response to a trigger. In some embodiments, the trigger includes detection of an event, a notification received from system 3110, a user input, and/or a response to a call to an API provided by system 3110.

In some embodiments, the instructions of application 3160, when executed, control device 3150 to perform the method of FIG. 3B and/or the method of FIG. 3C by calling an application programming interface (API) (e.g., API 3190) provided by system 3110. In some embodiments, application 3160 performs at least a portion of the method of FIG. 3B and/or the method of FIG. 3C without calling API 3190.

In some embodiments, one or more steps of the method of FIG. 3B and/or the method of FIG. 3C includes calling an API (e.g., API 3190) using one or more parameters defined by the API. In some embodiments, the one or more parameters include a constant, a key, a data structure, an object, an object class, a variable, a data type, a pointer, an array, a list or a pointer to a function or method, and/or another way to reference a data or other item to be passed via the API.

Referring to FIG. 3D, device 3150 is illustrated. In some embodiments, device 3150 is a personal computing device, a smart phone, a smart watch, a fitness tracker, a head mounted display (HMD) device, a media device, a communal device, a speaker, a television, and/or a tablet. As illustrated in FIG. 3D, device 3150 includes application 3160 and an operating system (e.g., system 3110 shown in FIG. 3E). Application 3160 includes application implementation module 3170 and API-calling module 3180. System 3110 includes API 3190 and implementation module 3100. It should be recognized that device 3150, application 3160, and/or system 3110 can include more, fewer, and/or different components than illustrated in FIGS. 3D and 3E.

In some embodiments, application implementation module 3170 includes a set of one or more instructions corresponding to one or more operations performed by application 3160. For example, when application 3160 is a messaging application, application implementation module 3170 can include operations to receive and send messages. In some embodiments, application implementation module 3170 communicates with API-calling module 3180 to communicate with system 3110 via API 3190 (shown in FIG. 3E).

In some embodiments, API 3190 is a software module (e.g., a collection of computer-readable instructions) that provides an interface that allows a different module (e.g., API-calling module 3180) to access and/or use one or more functions, methods, procedures, data structures, classes, and/or other services provided by implementation module 3100 of system 3110. For example, API-calling module 3180 can access a feature of implementation module 3100 through one or more API calls or invocations (e.g., embodied by a function or a method call) exposed by API 3190 (e.g., a software and/or hardware module that can receive API calls, respond to API calls, and/or send API calls) and can pass data and/or control information using one or more parameters via the API calls or invocations. In some embodiments, API 3190 allows application 3160 to use a service provided by a Software Development Kit (SDK) library. In some embodiments, application 3160 incorporates a call to a function or method provided by the SDK library and provided by API 3190 or uses data types or objects defined in the SDK library and provided by API 3190. In some embodiments, API-calling module 3180 makes an API call via API 3190 to access and use a feature of implementation module 3100 that is specified by API 3190. In such embodiments, implementation module 3100 can return a value via API 3190 to API-calling module 3180 in response to the API call. The value can report to application 3160 the capabilities or state of a hardware component of device 3150, including those related to aspects such as input capabilities and state, output capabilities and state, processing capability, power state, storage capacity and state, and/or communications capability. In some embodiments, API 3190 is implemented in part by firmware, microcode, or other low level logic that executes in part on the hardware component.

In some embodiments, API 3190 allows a developer of API-calling module 3180 (which can be a third-party developer) to leverage a feature provided by implementation module 3100. In such embodiments, there can be one or more API-calling modules (e.g., including API-calling module 3180) that communicate with implementation module 3100. In some embodiments, API 3190 allows multiple API-calling modules written in different programming languages to communicate with implementation module 3100 (e.g., API 3190 can include features for translating calls and returns between implementation module 3100 and API-calling module 3180) while API 3190 is implemented in terms of a specific programming language. In some embodiments, API-calling module 3180 calls APIs from different providers such as a set of APIs from an OS provider, another set of APIs from a plug-in provider, and/or another set of APIs from another provider (e.g., the provider of a software library) or creator of the another set of APIs.

Examples of API 3190 can include one or more of: a pairing API (e.g., for establishing secure connection, e.g., with an accessory), a device detection API (e.g., for locating nearby devices, e.g., media devices and/or smartphone), a payment API, a UIKit API (e.g., for generating user interfaces), a location detection API, a locator API, a maps API, a health sensor API, a sensor API, a messaging API, a push notification API, a streaming API, a collaboration API, a video conferencing API, an application store API, an advertising services API, a web browser API (e.g., WebKit API), a vehicle API, a networking API, a WiFi API, a Bluetooth API, an NFC API, a UWB API, a fitness API, a smart home API, contact transfer API, photos API, camera API, and/or image processing API. In some embodiments, the sensor API is an API for accessing data associated with a sensor of device 3150. For example, the sensor API can provide access to raw sensor data. For another example, the sensor API can provide data derived (and/or generated) from the raw sensor data. In some embodiments, the sensor data includes temperature data, image data, video data, audio data, heart rate data, IMU (inertial measurement unit) data, lidar data, location data, GPS data, and/or camera data. In some embodiments, the sensor includes one or more of an accelerometer, temperature sensor, infrared sensor, optical sensor, heartrate sensor, barometer, gyroscope, proximity sensor, temperature sensor, and/or biometric sensor.

In some embodiments, implementation module 3100 is a system (e.g., operating system and/or server system) software module (e.g., a collection of computer-readable instructions) that is constructed to perform an operation in response to receiving an API call via API 3190. In some embodiments, implementation module 3100 is constructed to provide an API response (via API 3190) as a result of processing an API call. By way of example, implementation module 3100 and API-calling module 3180 can each be any one of an operating system, a library, a device driver, an API, an application program, or other module. It should be understood that implementation module 3100 and API-calling module 3180 can be the same or different type of module from each other. In some embodiments, implementation module 3100 is embodied at least in part in firmware, microcode, or hardware logic.

In some embodiments, implementation module 3100 returns a value through API 3190 in response to an API call from API-calling module 3180. While API 3190 defines the syntax and result of an API call (e.g., how to invoke the API call and what the API call does), API 3190 might not reveal how implementation module 3100 accomplishes the function specified by the API call. Various API calls are transferred via the one or more application programming interfaces between API-calling module 3180 and implementation module 3100. Transferring the API calls can include issuing, initiating, invoking, calling, receiving, returning, and/or responding to the function calls or messages. In other words, transferring can describe actions by either of API-calling module 3180 or implementation module 3100. In some embodiments, a function call or other invocation of API 3190 sends and/or receives one or more parameters through a parameter list or other structure.

In some embodiments, implementation module 3100 provides more than one API, each providing a different view of or with different aspects of functionality implemented by implementation module 3100. For example, one API of implementation module 3100 can provide a first set of functions and can be exposed to third-party developers, and another API of implementation module 3100 can be hidden (e.g., not exposed) and provide a subset of the first set of functions and also provide another set of functions, such as testing or debugging functions which are not in the first set of functions. In some embodiments, implementation module 3100 calls one or more other components via an underlying API and thus is both an API-calling module and an implementation module. It should be recognized that implementation module 3100 can include additional functions, methods, classes, data structures, and/or other features that are not specified through API 3190 and are not available to API-calling module 3180. It should also be recognized that API-calling module 3180 can be on the same system as implementation module 3100 or can be located remotely and access implementation module 3100 using API 3190 over a network. In some embodiments, implementation module 3100, API 3190, and/or API-calling module 3180 is stored in a machine-readable medium, which includes any mechanism for storing information in a form readable by a machine (e.g., a computer or other data processing system). For example, a machine-readable medium can include magnetic disks, optical disks, random access memory; read only memory, and/or flash memory devices.

An application programming interface (API) is an interface between a first software process and a second software process that specifies a format for communication between the first software process and the second software process. Limited APIs (e.g., private APIs or partner APIs) are APIs that are accessible to a limited set of software processes (e.g., only software processes within an operating system or only software processes that are approved to access the limited APIs). Public APIs that are accessible to a wider set of software processes. Some APIs enable software processes to communicate about or set a state of one or more input devices (e.g., one or more touch sensors, proximity sensors, visual sensors, motion/orientation sensors, pressure sensors, intensity sensors, sound sensors, wireless proximity sensors, biometric sensors, buttons, switches, rotatable elements, and/or external controllers). Some APIs enable software processes to communicate about and/or set a state of one or more output generation components (e.g., one or more audio output generation components, one or more display generation components, and/or one or more tactile output generation components). Some APIs enable particular capabilities (e.g., scrolling, handwriting, text entry, image editing, and/or image creation) to be accessed, performed, and/or used by a software process (e.g., generating outputs for use by a software process based on input from the software process). Some APIs enable content from a software process to be inserted into a template and displayed in a user interface that has a layout and/or behaviors that are specified by the template.

Many software platforms include a set of frameworks that provides the core objects and core behaviors that a software developer needs to build software applications that can be used on the software platform. Software developers use these objects to display content onscreen, to interact with that content, and to manage interactions with the software platform. Software applications rely on the set of frameworks for their basic behavior, and the set of frameworks provides many ways for the software developer to customize the behavior of the application to match the specific needs of the software application. Many of these core objects and core behaviors are accessed via an API. An API will typically specify a format for communication between software processes, including specifying and grouping available variables, functions, and protocols. An API call (sometimes referred to as an API request) will typically be sent from a sending software process to a receiving software process as a way to accomplish one or more of the following: the sending software process requesting information from the receiving software process (e.g., for the sending software process to take action on), the sending software process providing information to the receiving software process (e.g., for the receiving software process to take action on), the sending software process requesting action by the receiving software process, or the sending software process providing information to the receiving software process about action taken by the sending software process. Interaction with a device (e.g., using a user interface) will in some circumstances include the transfer and/or receipt of one or more API calls (e.g., multiple API calls) between multiple different software processes (e.g., different portions of an operating system, an application and an operating system, or different applications) via one or more APIs (e.g., via multiple different APIs). For example, when an input is detected the direct sensor data is frequently processed into one or more input events that are provided (e.g., via an API) to a receiving software process that makes some determination based on the input events, and then sends (e.g., via an API) information to a software process to perform an operation (e.g., change a device state and/or user interface) based on the determination. While a determination and an operation performed in response could be made by the same software process, alternatively the determination could be made in a first software process and relayed (e.g., via an API) to a second software process, that is different from the first software process, that causes the operation to be performed by the second software process. Alternatively, the second software process could relay instructions (e.g., via an API) to a third software process that is different from the first software process and/or the second software process to perform the operation. It should be understood that some or all user interactions with a computer system could involve one or more API calls within a step of interacting with the computer system (e.g., between different software components of the computer system or between a software component of the computer system and a software component of one or more remote computer systems). It should be understood that some or all user interactions with a computer system could involve one or more API calls between steps of interacting with the computer system (e.g., between different software components of the computer system or between a software component of the computer system and a software component of one or more remote computer systems).

In some embodiments, the application can be any suitable type of application, including, for example, one or more of: a browser application, an application that functions as an execution environment for plug-ins, widgets or other applications, a fitness application, a health application, a digital payments application, a media application, a social network application, a messaging application, and/or a maps application.

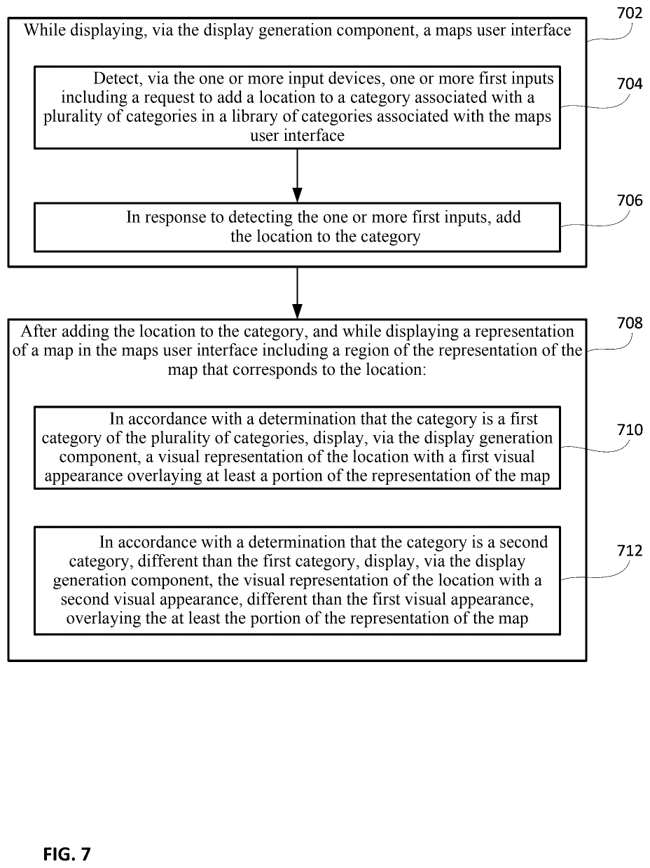

In some embodiments, the application is an application that is pre-installed on the first computer system at purchase (e.g., a first-party application). In some embodiments, the application is an application that is provided to the first computer system via an operating system update file (e.g., a first-party application). In some embodiments, the application is an application that is provided via an application store. In some embodiments, the application store is pre-installed on the first computer system at purchase (e.g., a first-party application store) and allows download of one or more applications. In some embodiments, the application store is a third-party application store (e.g., an application store that is provided by another device, downloaded via a network, and/or read from a storage device). In some embodiments, the application is a third-party application (e.g., an app that is provided by an application store, downloaded via a network, and/or read from a storage device). In some embodiments, the application controls the first computer system to perform method 700 (FIG. 7) by calling an application programming interface (API) provided by the system process using one or more parameters.

In some embodiments, exemplary APIs provided by the system process include one or more of: a pairing API (e.g., for establishing secure connection, e.g., with an accessory), a device detection API (e.g., for locating nearby devices, e.g., media devices and/or smartphone), a payment API, a UIKit API (e.g., for generating user interfaces), a location detection API, a locator API, a maps API, a health sensor API, a sensor API, a messaging API, a push notification API, a streaming API, a collaboration API, a video conferencing API, an application store API, an advertising services API, a web browser API (e.g., WebKit API), a vehicle API, a networking API, a WiFi API, a Bluetooth API, an NFC API, a UWB API, a fitness API, a smart home API, contact transfer API, a photos API, a camera API, and/or an image processing API.

In some embodiments, at least one API is a software module (e.g., a collection of computer-readable instructions) that provides an interface that allows a different module (e.g., API-calling module) to access and use one or more functions, methods, procedures, data structures, classes, and/or other services provided by an implementation module of the system process. The API can define one or more parameters that are passed between the API-calling module and the implementation module. In some embodiments, API 3190 defines a first API call that can be provided by API-calling module 3180. The implementation module is a system software module (e.g., a collection of computer-readable instructions) that is constructed to perform an operation in response to receiving an API call via the API. In some embodiments, the implementation module is constructed to provide an API response (via the API) as a result of processing an API call. In some embodiments, the implementation module is included in the device (e.g., 3150) that runs the application. In some embodiments, the implementation module is included in an electronic device that is separate from the device that runs the application.

Attention is now directed towards embodiments of user interfaces that are, optionally, implemented on, for example, portable multifunction device 100.

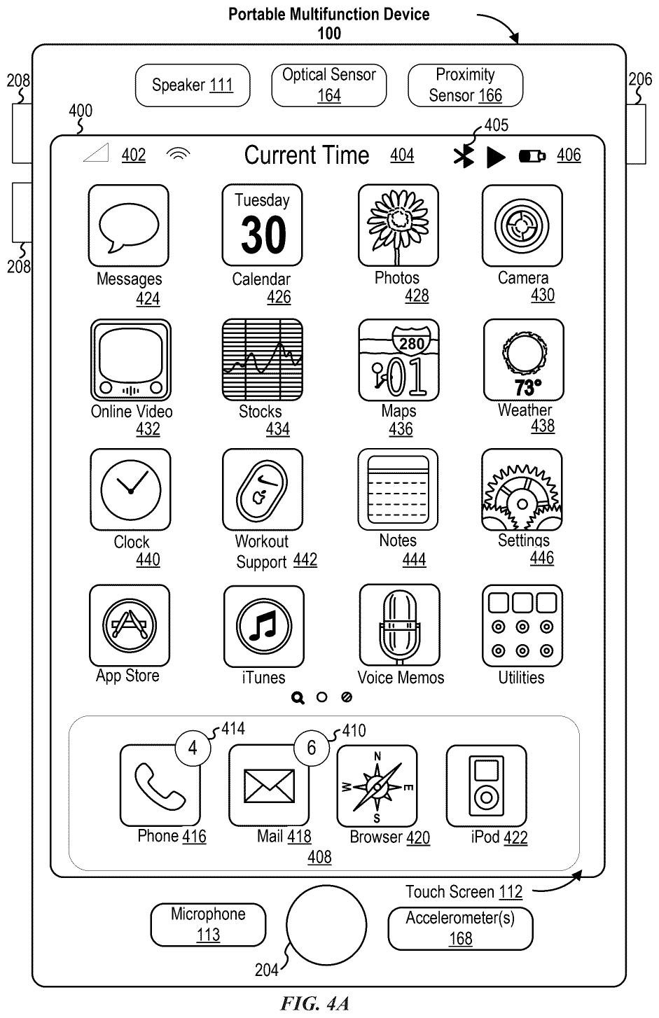

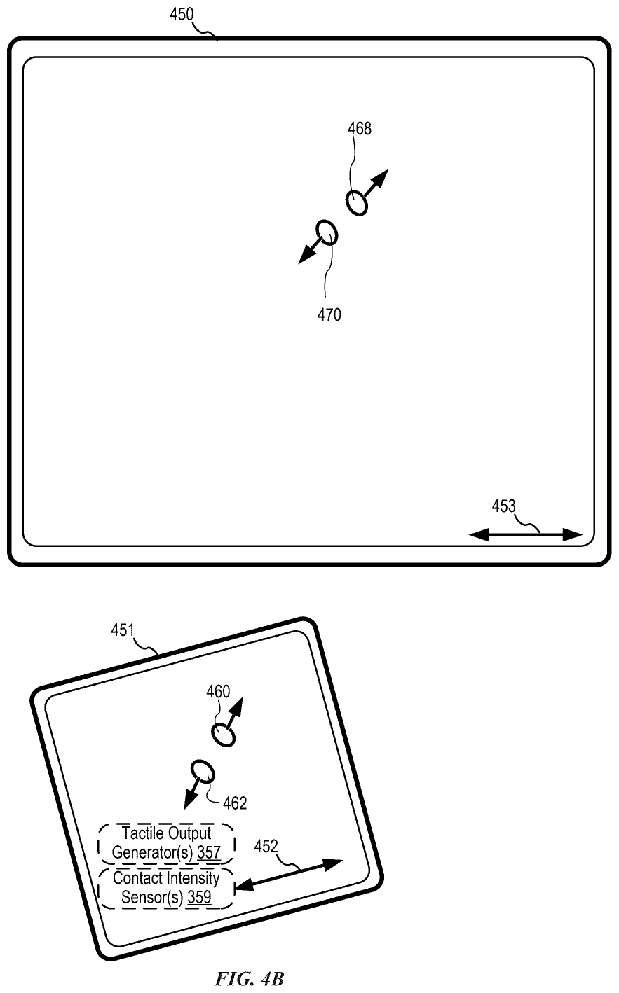

FIG. 4A illustrates an exemplary user interface for a menu of applications on portable multifunction device 100 in accordance with some embodiments. Similar user interfaces are, optionally, implemented on device 300. In some embodiments, user interface 400 includes the following elements, or a subset or superset thereof:
Signal strength indicator(s) 402 for wireless communication(s), such as cellular and Wi-Fi signals;
Time 404;
Bluetooth indicator 405;
Battery status indicator 406;
Tray 408 with icons for frequently used applications, such as:
   Icon 416 for telephone module 138, labeled “Phone,” which optionally includes an indicator 414 of the number of missed calls or voicemail messages;
   Icon 418 for e-mail client module 140, labeled “Mail,” which optionally includes an indicator 410 of the number of unread e-mails;
   Icon 420 for browser module 147, labeled “Browser;” and
   Icon 422 for video and music player module 152, also referred to as iPod (trademark of Apple Inc.) module 152, labeled “iPod;” and
Icons for other applications, such as:
   Icon 424 for IM module 141, labeled “Messages;”
   Icon 426 for calendar module 148, labeled “Calendar;”
   Icon 428 for image management module 144, labeled “Photos;”
   Icon 430 for camera module 143, labeled “Camera;”
   Icon 432 for online video module 155, labeled “Online Video;”
   Icon 434 for stocks widget 149-2, labeled “Stocks;”
   Icon 436 for map module 154, labeled “Maps;”
   Icon 438 for weather widget 149-1, labeled “Weather;”
   Icon 440 for alarm clock widget 149-4, labeled “Clock;”
   Icon 442 for workout support module 142, labeled “Workout Support;”
   Icon 444 for notes module 153, labeled “Notes;” and
   Icon 446 for a settings application or module, labeled “Settings,” which provides access to settings for device 100 and its various applications 136.

It should be noted that the icon labels illustrated in FIG. 4A are merely exemplary. For example, icon 422 for video and music player module 152 is labeled “Music” or “Music Player.” Other labels are, optionally, used for various application icons. In some embodiments, a label for a respective application icon includes a name of an application corresponding to the respective application icon. In some embodiments, a label for a particular application icon is distinct from a name of an application corresponding to the particular application icon.

FIG. 4B illustrates an exemplary user interface on a device (e.g., device 300, FIG. 3A) with a touch-sensitive surface 451 (e.g., a tablet or touchpad 355, FIG. 3A) that is separate from the display 450 (e.g., touch screen display 112). Device 300 also, optionally, includes one or more contact intensity sensors (e.g., one or more of sensors 359) for detecting intensity of contacts on touch-sensitive surface 451 and/or one or more tactile output generators 357 for generating tactile outputs for a user of device 300.

Although some of the examples that follow will be given with reference to inputs on touch screen display 112 (where the touch-sensitive surface and the display are combined), in some embodiments, the device detects inputs on a touch-sensitive surface that is separate from the display, as shown in FIG. 4B. In some embodiments, the touch-sensitive surface (e.g., 451 in FIG. 4B) has a primary axis (e.g., 452 in FIG. 4B) that corresponds to a primary axis (e.g., 453 in FIG. 4B) on the display (e.g., 450). In accordance with these embodiments, the device detects contacts (e.g., 460 and 462 in FIG. 4B) with the touch-sensitive surface 451 at locations that correspond to respective locations on the display (e.g., in FIG. 4B, 460 corresponds to 468 and 462 corresponds to 470). In this way, user inputs (e.g., contacts 460 and 462, and movements thereof) detected by the device on the touch-sensitive surface (e.g., 451 in FIG. 4B) are used by the device to manipulate the user interface on the display (e.g., 450 in FIG. 4B) of the multifunction device when the touch-sensitive surface is separate from the display. It should be understood that similar methods are, optionally, used for other user interfaces described herein.

Additionally, while the following examples are given primarily with reference to finger inputs (e.g., finger contacts, finger tap gestures, finger swipe gestures), it should be understood that, in some embodiments, one or more of the finger inputs are replaced with input from another input device (e.g., a mouse-based input or stylus input). For example, a swipe gesture is, optionally, replaced with a mouse click (e.g., instead of a contact) followed by movement of the cursor along the path of the swipe (e.g., instead of movement of the contact). As another example, a tap gesture is, optionally, replaced with a mouse click while the cursor is located over the location of the tap gesture (e.g., instead of detection of the contact followed by ceasing to detect the contact). Similarly, when multiple user inputs are simultaneously detected, it should be understood that multiple computer mice are, optionally, used simultaneously, or a mouse and finger contacts are, optionally, used simultaneously.

Additionally, while the following examples are given primarily with reference to finger inputs (e.g., finger contacts, finger tap gestures, finger swipe gestures), it should be understood that, in some embodiments, one or more of the finger inputs are replaced with input from another input device (e.g., a mouse based input or stylus input). For example, a swipe gesture is, optionally, replaced with a mouse click (e.g., instead of a contact) followed by movement of the cursor along the path of the swipe (e.g., instead of movement of the contact). As another example, a tap gesture is, optionally, replaced with a mouse click while the cursor is located over the location of the tap gesture (e.g., instead of detection of the contact followed by ceasing to detect the contact). Similarly, when multiple user inputs are simultaneously detected, it should be understood that multiple computer mice are, optionally, used simultaneously, or a mouse and finger contacts are, optionally, used simultaneously.

As used herein, the term “focus selector” refers to an input element that indicates a current part of a user interface with which a user is interacting. In some implementations that include a cursor or other location marker, the cursor acts as a “focus selector,” so that when an input (e.g., a press input) is detected on a touch-sensitive surface (e.g., touchpad 355 in FIG. 3A or touch-sensitive surface 451 in FIG. 4B) while the cursor is over a particular user interface element (e.g., a button, window, slider or other user interface element), the particular user interface element is adjusted in accordance with the detected input. In some implementations that include a touch-screen display (e.g., touch-sensitive display system 112 in FIG. 1A) that enables direct interaction with user interface elements on the touch-screen display, a detected contact on the touch-screen acts as a “focus selector,” so that when an input (e.g., a press input by the contact) is detected on the touch-screen display at a location of a particular user interface element (e.g., a button, window, slider or other user interface element), the particular user interface element is adjusted in accordance with the detected input. In some implementations focus is moved from one region of a user interface to another region of the user interface without corresponding movement of a cursor or movement of a contact on a touch-screen display (e.g., by using a tab key or arrow keys to move focus from one button to another button); in these implementations, the focus selector moves in accordance with movement of focus between different regions of the user interface. Without regard to the specific form taken by the focus selector, the focus selector is generally the user interface element (or contact on a touch-screen display) that is controlled by the user so as to communicate the user's intended interaction with the user interface (e.g., by indicating, to the device, the element of the user interface with which the user is intending to interact). For example, the location of a focus selector (e.g., a cursor, a contact or a selection box) over a respective button while a press input is detected on the touch-sensitive surface (e.g., a touchpad or touch screen) will indicate that the user is intending to activate the respective button (as opposed to other user interface elements shown on a display of the device).

As used in the specification and claims, the term “characteristic intensity” of a contact refers to a characteristic of the contact based on one or more intensities of the contact. In some embodiments, the characteristic intensity is based on multiple intensity samples. The characteristic intensity is, optionally, based on a predefined number of intensity samples, or a set of intensity samples collected during a predetermined time period (e.g., 0.05, 0.1, 0.2, 0.5, 1, 2, 5, 10 seconds) relative to a predefined event (e.g., after detecting the contact, prior to detecting liftoff of the contact, before or after detecting a start of movement of the contact, prior to detecting an end of the contact, before or after detecting an increase in intensity of the contact, and/or before or after detecting a decrease in intensity of the contact). A characteristic intensity of a contact is, optionally, based on one or more of: a maximum value of the intensities of the contact, a mean value of the intensities of the contact, an average value of the intensities of the contact, a top 10 percentile value of the intensities of the contact, a value at the half maximum of the intensities of the contact, a value at the 90 percent maximum of the intensities of the contact, or the like. In some embodiments, the duration of the contact is used in determining the characteristic intensity (e.g., when the characteristic intensity is an average of the intensity of the contact over time). In some embodiments, the characteristic intensity is compared to a set of one or more intensity thresholds to determine whether an operation has been performed by a user. For example, the set of one or more intensity thresholds optionally includes a first intensity threshold and a second intensity threshold. In this example, a contact with a characteristic intensity that does not exceed the first threshold results in a first operation, a contact with a characteristic intensity that exceeds the first intensity threshold and does not exceed the second intensity threshold results in a second operation, and a contact with a characteristic intensity that exceeds the second threshold results in a third operation. In some embodiments, a comparison between the characteristic intensity and one or more thresholds is used to determine whether or not to perform one or more operations (e.g., whether to perform a respective operation or forgo performing the respective operation), rather than being used to determine whether to perform a first operation or a second operation.

In some embodiments described herein, one or more operations are performed in response to detecting a gesture that includes a respective press input or in response to detecting the respective press input performed with a respective contact (or a plurality of contacts), where the respective press input is detected based at least in part on detecting an increase in intensity of the contact (or plurality of contacts) above a press-input intensity threshold. In some embodiments, the respective operation is performed in response to detecting the increase in intensity of the respective contact above the press-input intensity threshold (e.g., a “down stroke” of the respective press input). In some embodiments, the press input includes an increase in intensity of the respective contact above the press-input intensity threshold and a subsequent decrease in intensity of the contact below the press-input intensity threshold, and the respective operation is performed in response to detecting the subsequent decrease in intensity of the respective contact below the press-input threshold (e.g., an “up stroke” of the respective press input).

In some embodiments, the device employs intensity hysteresis to avoid accidental inputs sometimes termed “jitter,” where the device defines or selects a hysteresis intensity threshold with a predefined relationship to the press-input intensity threshold (e.g., the hysteresis intensity threshold is X intensity units lower than the press-input intensity threshold or the hysteresis intensity threshold is 75%, 90% or some reasonable proportion of the press-input intensity threshold). Thus, in some embodiments, the press input includes an increase in intensity of the respective contact above the press-input intensity threshold and a subsequent decrease in intensity of the contact below the hysteresis intensity threshold that corresponds to the press-input intensity threshold, and the respective operation is performed in response to detecting the subsequent decrease in intensity of the respective contact below the hysteresis intensity threshold (e.g., an “up stroke” of the respective press input). Similarly, in some embodiments, the press input is detected only when the device detects an increase in intensity of the contact from an intensity at or below the hysteresis intensity threshold to an intensity at or above the press-input intensity threshold and, optionally, a subsequent decrease in intensity of the contact to an intensity at or below the hysteresis intensity, and the respective operation is performed in response to detecting the press input (e.g., the increase in intensity of the contact or the decrease in intensity of the contact, depending on the circumstances).

For ease of explanation, the description of operations performed in response to a press input associated with a press-input intensity threshold or in response to a gesture including the press input are, optionally, triggered in response to detecting either: an increase in intensity of a contact above the press-input intensity threshold, an increase in intensity of a contact from an intensity below the hysteresis intensity threshold to an intensity above the press-input intensity threshold, a decrease in intensity of the contact below the press-input intensity threshold, and/or a decrease in intensity of the contact below the hysteresis intensity threshold corresponding to the press-input intensity threshold. Additionally, in examples where an operation is described as being performed in response to detecting a decrease in intensity of a contact below the press-input intensity threshold, the operation is, optionally, performed in response to detecting a decrease in intensity of the contact below a hysteresis intensity threshold corresponding to, and lower than, the press-input intensity threshold.

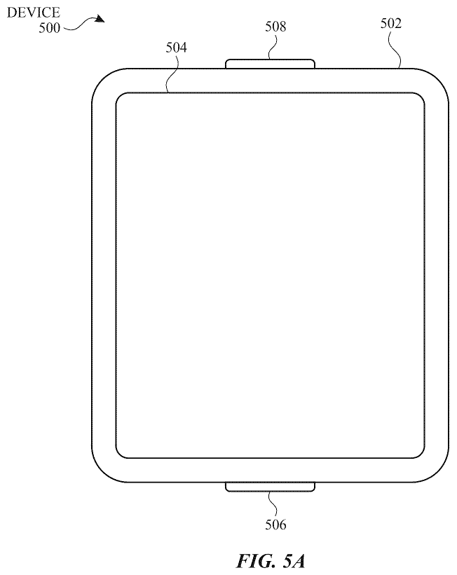

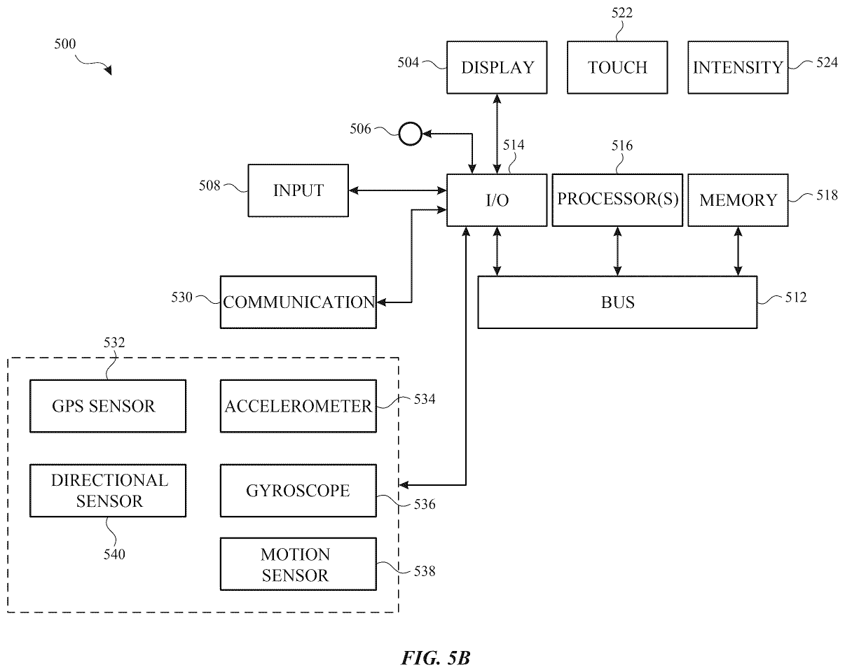

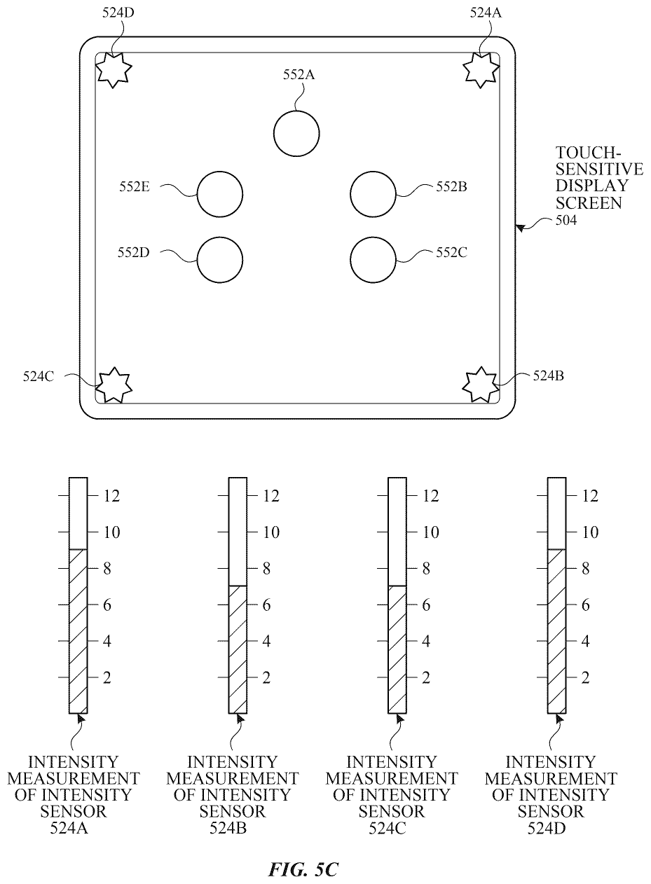

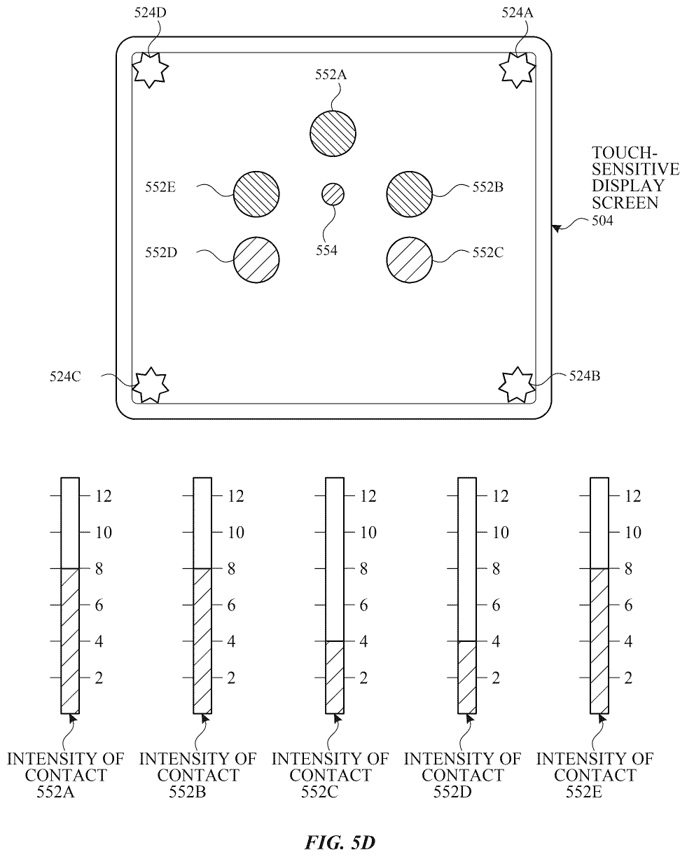

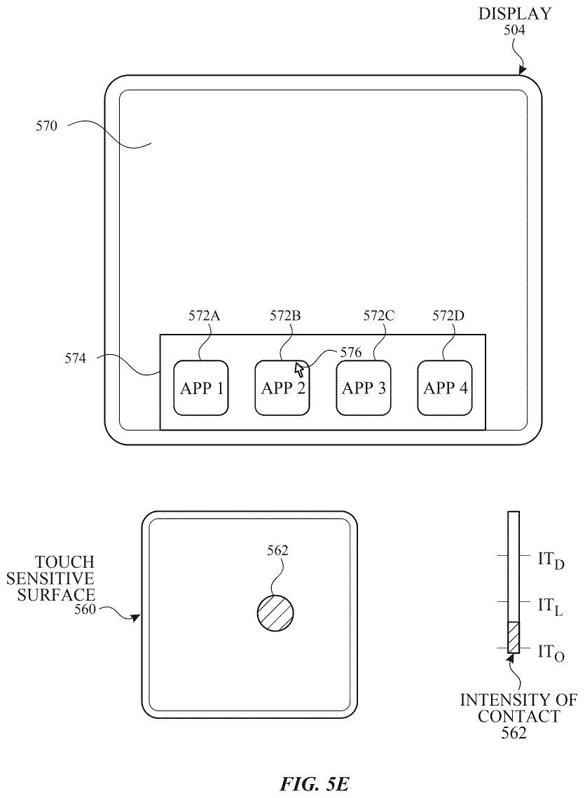

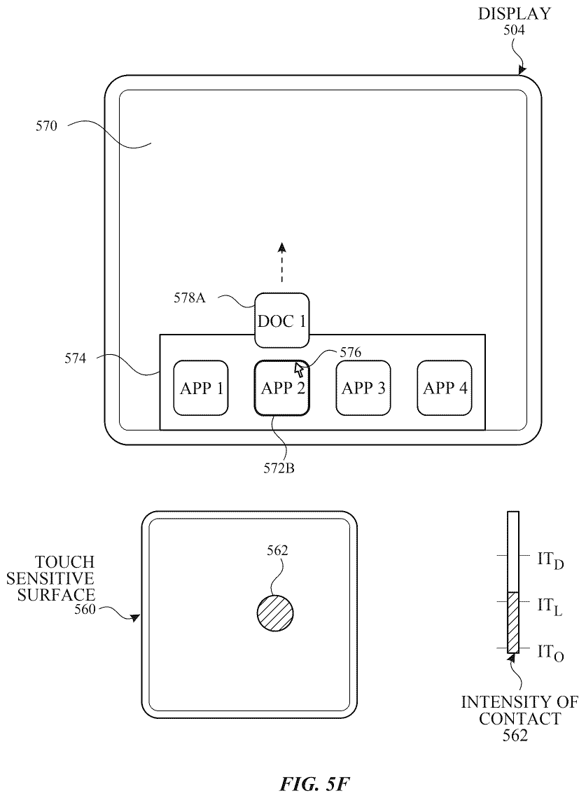

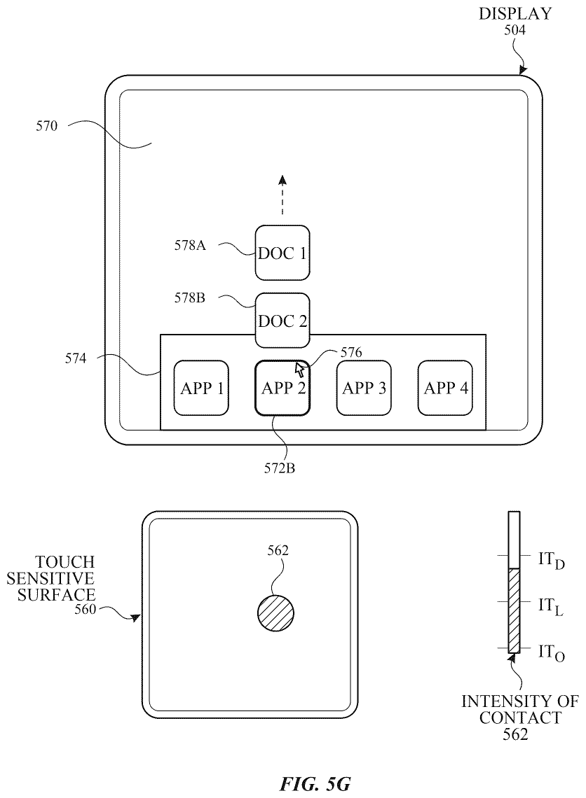

FIG. 5A illustrates a block diagram of an exemplary architecture for the device 500 according to some embodiments of the disclosure. In the embodiment of FIG. 5A, media or other content is optionally received by device 500 via network interface 502, which is optionally a wireless or wired connection. The one or more processors 516 optionally execute any number of programs stored in memory 506 or storage, which optionally includes instructions to perform one or more of the methods and/or processes described herein (e.g., method 700). A computer-readable storage medium can be any medium that can tangibly contain or store computer-executable instructions for use by or in connection with the instruction execution system, apparatus, or device. In some examples, the storage medium is a transitory computer-readable storage medium. In some examples, the storage medium is a non-transitory computer-readable storage medium. The non-transitory computer-readable storage medium can include, but is not limited to, magnetic, optical, and/or semiconductor storages. Examples of such storage include magnetic disks, optical discs based on CD, DVD, or Blu-ray technologies, as well as persistent solid-state memory such as flash, solid-state drives, and the like. Personal electronic device 500 is not limited to the components and configuration of FIGS. 5, but can include other or additional components in multiple configurations.

In addition, in methods described herein where one or more steps are contingent upon one or more conditions having been met, it should be understood that the described method can be repeated in multiple repetitions so that over the course of the repetitions all of the conditions upon which steps in the method are contingent have been met in different repetitions of the method. For example, if a method requires performing a first step if a condition is satisfied, and a second step if the condition is not satisfied, then a person of ordinary skill would appreciate that the claimed steps are repeated until the condition has been both satisfied and not satisfied, in no particular order. Thus, a method described with one or more steps that are contingent upon one or more conditions having been met could be rewritten as a method that is repeated until each of the conditions described in the method has been met. This, however, is not required of system or computer readable medium claims where the system or computer readable medium contains instructions for performing the contingent operations based on the satisfaction of the corresponding one or more conditions and thus is capable of determining whether the contingency has or has not been satisfied without explicitly repeating steps of a method until all of the conditions upon which steps in the method are contingent have been met. A person having ordinary skill in the art would also understand that, similar to a method with contingent steps, a system or computer readable storage medium can repeat the steps of a method as many times as are needed to ensure that all of the contingent steps have been performed.

As used here, the term “affordance” refers to a user-interactive graphical user interface object that is, optionally, displayed on the display screen of devices 100, 300, and/or 500 (FIGS. 1A, 3, and 5A-5B). For example, an image (e.g., icon), a button, and text (e.g., hyperlink) each optionally constitute an affordance.

As used herein, the term “focus selector” refers to an input element that indicates a current part of a user interface with which a user is interacting. In some implementations that include a cursor or other location marker, the cursor acts as a “focus selector” so that when an input (e.g., a press input) is detected on a touch-sensitive surface (e.g., touchpad 355 in FIG. 3A or touch-sensitive surface 451 in FIG. 4B) while the cursor is over a particular user interface element (e.g., a button, window, slider, or other user interface element), the particular user interface element is adjusted in accordance with the detected input. In some implementations that include a touch screen display (e.g., touch-sensitive display system 112 in FIG. 1A or touch screen 112 in FIG. 4A) that enables direct interaction with user interface elements on the touch screen display, a detected contact on the touch screen acts as a “focus selector” so that when an input (e.g., a press input by the contact) is detected on the touch screen display at a location of a particular user interface element (e.g., a button, window, slider, or other user interface element), the particular user interface element is adjusted in accordance with the detected input. In some implementations, focus is moved from one region of a user interface to another region of the user interface without corresponding movement of a cursor or movement of a contact on a touch screen display (e.g., by using a tab key or arrow keys to move focus from one button to another button); in these implementations, the focus selector moves in accordance with movement of focus between different regions of the user interface. Without regard to the specific form taken by the focus selector, the focus selector is generally the user interface element (or contact on a touch screen display) that is controlled by the user so as to communicate the user's intended interaction with the user interface (e.g., by indicating, to the device, the element of the user interface with which the user is intending to interact). For example, the location of a focus selector (e.g., a cursor, a contact, or a selection box) over a respective button while a press input is detected on the touch-sensitive surface (e.g., a touchpad or touch screen) will indicate that the user is intending to activate the respective button (as opposed to other user interface elements shown on a display of the device).

As used in the specification and claims, the term “characteristic intensity” of a contact refers to a characteristic of the contact based on one or more intensities of the contact. In some embodiments, the characteristic intensity is based on multiple intensity samples. The characteristic intensity is, optionally, based on a predefined number of intensity samples, or a set of intensity samples collected during a predetermined time period (e.g., 0.05, 0.1, 0.2, 0.5, 1, 2, 5, 10 seconds) relative to a predefined event (e.g., after detecting the contact, prior to detecting liftoff of the contact, before or after detecting a start of movement of the contact, prior to detecting an end of the contact, before or after detecting an increase in intensity of the contact, and/or before or after detecting a decrease in intensity of the contact). A characteristic intensity of a contact is, optionally, based on one or more of: a maximum value of the intensities of the contact, a mean value of the intensities of the contact, an average value of the intensities of the contact, a top 10 percentile value of the intensities of the contact, a value at the half maximum of the intensities of the contact, a value at the 90 percent maximum of the intensities of the contact, or the like. In some embodiments, the duration of the contact is used in determining the characteristic intensity (e.g., when the characteristic intensity is an average of the intensity of the contact over time). In some embodiments, the characteristic intensity is compared to a set of one or more intensity thresholds to determine whether an operation has been performed by a user. For example, the set of one or more intensity thresholds optionally includes a first intensity threshold and a second intensity threshold. In this example, a contact with a characteristic intensity that does not exceed the first threshold results in a first operation, a contact with a characteristic intensity that exceeds the first intensity threshold and does not exceed the second intensity threshold results in a second operation, and a contact with a characteristic intensity that exceeds the second threshold results in a third operation. In some embodiments, a comparison between the characteristic intensity and one or more thresholds is used to determine whether or not to perform one or more operations (e.g., whether to perform a respective operation or forgo performing the respective operation), rather than being used to determine whether to perform a first operation or a second operation.

FIG. 5C illustrates detecting a plurality of contacts 552A-552E on touch-sensitive display screen 504 with a plurality of intensity sensors 524A-524D. FIG. 5C additionally includes intensity diagrams that show the current intensity measurements of the intensity sensors 524A-524D relative to units of intensity. In this example, the intensity measurements of intensity sensors 524A and 524D are each 9 units of intensity, and the intensity measurements of intensity sensors 524B and 524C are each 7 units of intensity. In some implementations, an aggregate intensity is the sum of the intensity measurements of the plurality of intensity sensors 524A-524D, which in this example is 32 intensity units. In some embodiments, each contact is assigned a respective intensity that is a portion of the aggregate intensity. FIG. 5D illustrates assigning the aggregate intensity to contacts 552A-552E based on their distance from the center of force 554. In this example, each of contacts 552A, 552B, and 552E are assigned an intensity of contact of 8 intensity units of the aggregate intensity, and each of contacts 552C and 552D are assigned an intensity of contact of 4 intensity units of the aggregate intensity. More generally, in some implementations, each contact j is assigned a respective intensity Ij that is a portion of the aggregate intensity, A, in accordance with a predefined mathematical function, Ij=A·(Dj/ΣDi), where Dj is the distance of the respective contact j to the center of force, and ΣDi is the sum of the distances of all the respective contacts (e.g., i=1 to last) to the center of force. The operations described with reference to FIGS. 5C-5D can be performed using an electronic device similar or identical to device 100, 300, or 500. In some embodiments, a characteristic intensity of a contact is based on one or more intensities of the contact. In some embodiments, the intensity sensors are used to determine a single characteristic intensity (e.g., a single characteristic intensity of a single contact). It should be noted that the intensity diagrams are not part of a displayed user interface, but are included in FIGS. 5C-5D to aid the reader.

In some embodiments, a portion of a gesture is identified for purposes of determining a characteristic intensity. For example, a touch-sensitive surface optionally receives a continuous swipe contact transitioning from a start location and reaching an end location, at which point the intensity of the contact increases. In this example, the characteristic intensity of the contact at the end location is, optionally, based on only a portion of the continuous swipe contact, and not the entire swipe contact (e.g., only the portion of the swipe contact at the end location). In some embodiments, a smoothing algorithm is, optionally, applied to the intensities of the swipe contact prior to determining the characteristic intensity of the contact. For example, the smoothing algorithm optionally includes one or more of: an unweighted sliding-average smoothing algorithm, a triangular smoothing algorithm, a median filter smoothing algorithm, and/or an exponential smoothing algorithm. In some circumstances, these smoothing algorithms eliminate narrow spikes or dips in the intensities of the swipe contact for purposes of determining a characteristic intensity.

The intensity of a contact on the touch-sensitive surface is, optionally, characterized relative to one or more intensity thresholds, such as a contact-detection intensity threshold, a light press intensity threshold, a deep press intensity threshold, and/or one or more other intensity thresholds. In some embodiments, the light press intensity threshold corresponds to an intensity at which the device will perform operations typically associated with clicking a button of a physical mouse or a trackpad. In some embodiments, the deep press intensity threshold corresponds to an intensity at which the device will perform operations that are different from operations typically associated with clicking a button of a physical mouse or a trackpad. In some embodiments, when a contact is detected with a characteristic intensity below the light press intensity threshold (e.g., and above a nominal contact-detection intensity threshold below which the contact is no longer detected), the device will move a focus selector in accordance with movement of the contact on the touch-sensitive surface without performing an operation associated with the light press intensity threshold or the deep press intensity threshold. Generally, unless otherwise stated, these intensity thresholds are consistent between different sets of user interface figures.

An increase of characteristic intensity of the contact from an intensity below the light press intensity threshold to an intensity between the light press intensity threshold and the deep press intensity threshold is sometimes referred to as a “light press” input. An increase of characteristic intensity of the contact from an intensity below the deep press intensity threshold to an intensity above the deep press intensity threshold is sometimes referred to as a “deep press” input. An increase of characteristic intensity of the contact from an intensity below the contact-detection intensity threshold to an intensity between the contact-detection intensity threshold and the light press intensity threshold is sometimes referred to as detecting the contact on the touch-surface. A decrease of characteristic intensity of the contact from an intensity above the contact-detection intensity threshold to an intensity below the contact-detection intensity threshold is sometimes referred to as detecting liftoff of the contact from the touch-surface. In some embodiments, the contact-detection intensity threshold is zero. In some embodiments, the contact-detection intensity threshold is greater than zero.

In some embodiments described herein, one or more operations are performed in response to detecting a gesture that includes a respective press input or in response to detecting the respective press input performed with a respective contact (or a plurality of contacts), where the respective press input is detected based at least in part on detecting an increase in intensity of the contact (or plurality of contacts) above a press-input intensity threshold. In some embodiments, the respective operation is performed in response to detecting the increase in intensity of the respective contact above the press-input intensity threshold (e.g., a “down stroke” of the respective press input). In some embodiments, the press input includes an increase in intensity of the respective contact above the press-input intensity threshold and a subsequent decrease in intensity of the contact below the press-input intensity threshold, and the respective operation is performed in response to detecting the subsequent decrease in intensity of the respective contact below the press-input threshold (e.g., an “up stroke” of the respective press input).

FIGS. 5E-5H illustrate detection of a gesture that includes a press input that corresponds to an increase in intensity of a contact 562 from an intensity below a light press intensity threshold (e.g., “IT_{L}”) in FIG. 5E, to an intensity above a deep press intensity threshold (e.g., “IT_{D}”) in FIG. 5H. The gesture performed with contact 562 is detected on touch-sensitive surface 560 while cursor 576 is displayed over application icon 572B corresponding to App 2, on a displayed user interface 570 that includes application icons 572A-572D displayed in predefined region 574. In some embodiments, the gesture is detected on touch-sensitive display 504. The intensity sensors detect the intensity of contacts on touch-sensitive surface 560. The device determines that the intensity of contact 562 peaked above the deep press intensity threshold (e.g., “IT_{D}”). Contact 562 is maintained on touch-sensitive surface 560. In response to the detection of the gesture, and in accordance with contact 562 having an intensity that goes above the deep press intensity threshold (e.g., “IT_{D}”) during the gesture, reduced-scale representations 578A-578C (e.g., thumbnails) of recently opened documents for App 2 are displayed, as shown in FIGS. 5F-5H. In some embodiments, the intensity, which is compared to the one or more intensity thresholds, is the characteristic intensity of a contact. It should be noted that the intensity diagram for contact 562 is not part of a displayed user interface, but is included in FIGS. 5E-5H to aid the reader.

In some embodiments, the display of representations 578A-578C includes an animation. For example, representation 578A is initially displayed in proximity of application icon 572B, as shown in FIG. 5F. As the animation proceeds, representation 578A moves upward and representation 578B is displayed in proximity of application icon 572B, as shown in FIG. 5G. Then, representations 578A moves upward, 578B moves upward toward representation 578A, and representation 578C is displayed in proximity of application icon 572B, as shown in FIG. 5H. Representations 578A-578C form an array above icon 572B. In some embodiments, the animation progresses in accordance with an intensity of contact 562, as shown in FIGS. 5F-5G, where the representations 578A-578C appear and move upwards as the intensity of contact 562 increases toward the deep press intensity threshold (e.g., “IT_{D}”). In some embodiments, the intensity, on which the progress of the animation is based, is the characteristic intensity of the contact. The operations described with reference to FIGS. 5E-5H can be performed using an electronic device similar or identical to device 100, 300, or 500.

In some embodiments, the device employs intensity hysteresis to avoid accidental inputs sometimes termed “jitter,” where the device defines or selects a hysteresis intensity threshold with a predefined relationship to the press-input intensity threshold (e.g., the hysteresis intensity threshold is X intensity units lower than the press-input intensity threshold or the hysteresis intensity threshold is 75%, 90%, or some reasonable proportion of the press-input intensity threshold). Thus, in some embodiments, the press input includes an increase in intensity of the respective contact above the press-input intensity threshold and a subsequent decrease in intensity of the contact below the hysteresis intensity threshold that corresponds to the press-input intensity threshold, and the respective operation is performed in response to detecting the subsequent decrease in intensity of the respective contact below the hysteresis intensity threshold (e.g., an “up stroke” of the respective press input). Similarly, in some embodiments, the press input is detected only when the device detects an increase in intensity of the contact from an intensity at or below the hysteresis intensity threshold to an intensity at or above the press-input intensity threshold and, optionally, a subsequent decrease in intensity of the contact to an intensity at or below the hysteresis intensity, and the respective operation is performed in response to detecting the press input (e.g., the increase in intensity of the contact or the decrease in intensity of the contact, depending on the circumstances).

For ease of explanation, the descriptions of operations performed in response to a press input associated with a press-input intensity threshold or in response to a gesture including the press input are, optionally, triggered in response to detecting either: an increase in intensity of a contact above the press-input intensity threshold, an increase in intensity of a contact from an intensity below the hysteresis intensity threshold to an intensity above the press-input intensity threshold, a decrease in intensity of the contact below the press-input intensity threshold, and/or a decrease in intensity of the contact below the hysteresis intensity threshold corresponding to the press-input intensity threshold. Additionally, in examples where an operation is described as being performed in response to detecting a decrease in intensity of a contact below the press-input intensity threshold, the operation is, optionally, performed in response to detecting a decrease in intensity of the contact below a hysteresis intensity threshold corresponding to, and lower than, the press-input intensity threshold.

As used herein, an “installed application” refers to a software application that has been downloaded onto an electronic device (e.g., devices 100, 300, and/or 500) and is ready to be launched (e.g., become opened) on the device. In some embodiments, a downloaded application becomes an installed application by way of an installation program that extracts program portions from a downloaded package and integrates the extracted portions with the operating system of the computer system.

As used herein, the terms “open application” or “executing application” refer to a software application with retained state information (e.g., as part of device/global internal state 157 and/or application internal state 192). An open or executing application is, optionally, any one of the following types of applications:
an active application, which is currently displayed on a display screen of the device that the application is being used on;
a background application (or background processes), which is not currently displayed, but one or more processes for the application are being processed by one or more processors; and
a suspended or hibernated application, which is not running, but has state information that is stored in memory (volatile and non-volatile, respectively) and that can be used to resume execution of the application.

As used herein, the term “closed application” refers to software applications without retained state information (e.g., state information for closed applications is not stored in a memory of the device). Accordingly, closing an application includes stopping and/or removing application processes for the application and removing state information for the application from the memory of the device. Generally, opening a second application while in a first application does not close the first application. When the second application is displayed and the first application ceases to be displayed, the first application becomes a background application.

Attention is now directed towards embodiments of user interfaces (“UI”) and associated processes that are implemented on an electronic device, such as device 100, device 300, or device 500.

Users interact with electronic devices in many different manners. In some embodiments, an electronic device is in communication with one or more input devices, a display generation component, and wireless circuitry. In some embodiments, the electronic device presents a user interface associated with a mapping application, at times referred to herein as a maps application. The embodiments described below provide ways in which an electronic device displays representations of locations included in the user interface for the maps application. Displaying different visual appearances and/or representations of locations reduces user input otherwise required to gain an understanding about the locations. It is understood that people use devices. When a person uses a device, that person is optionally referred to as a user of the device.

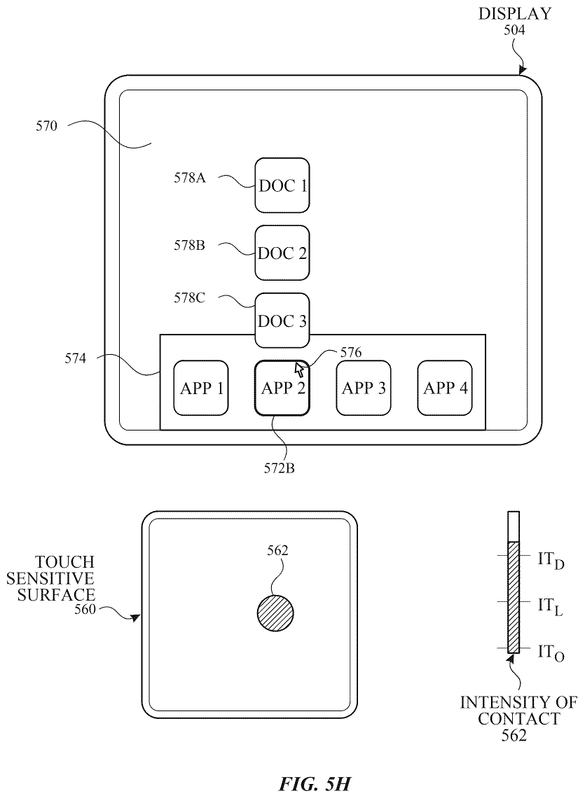

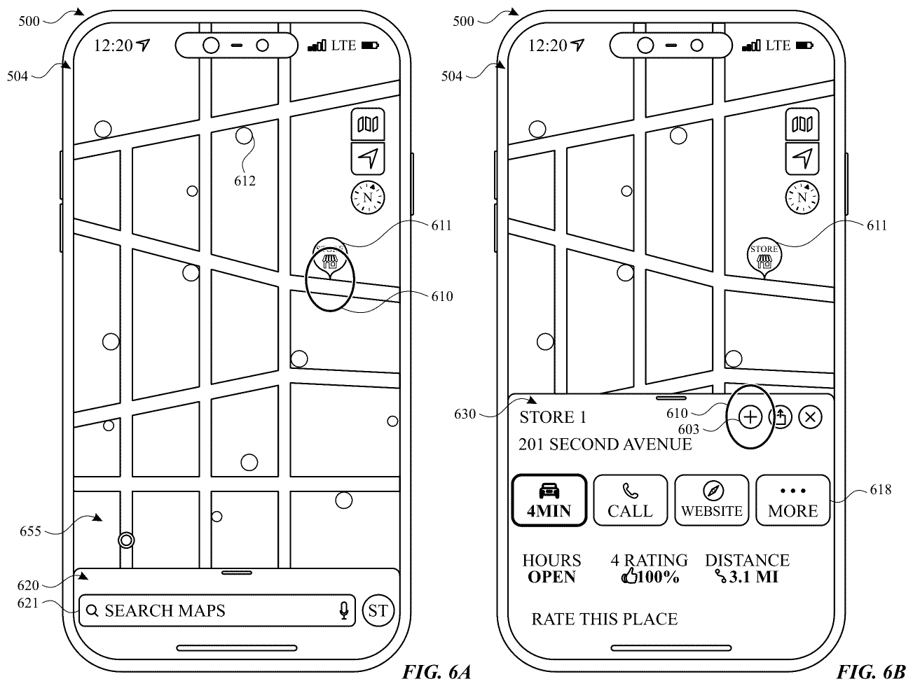

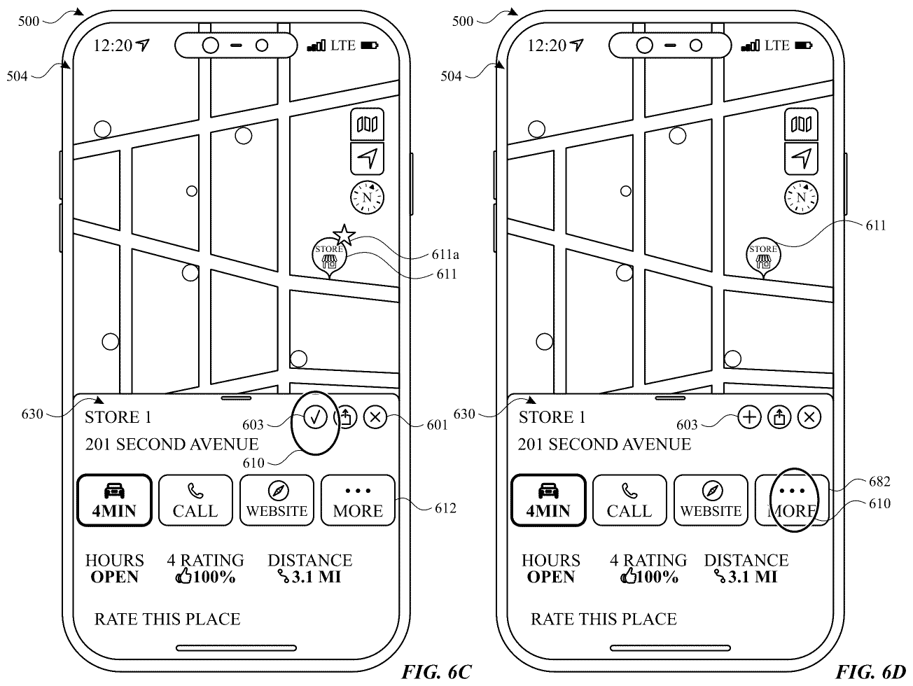

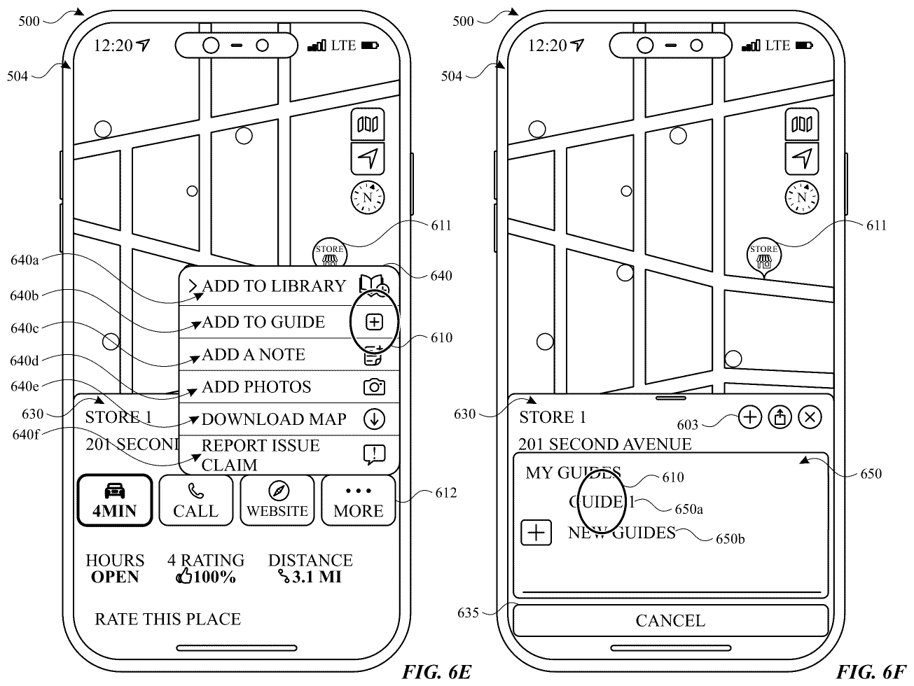

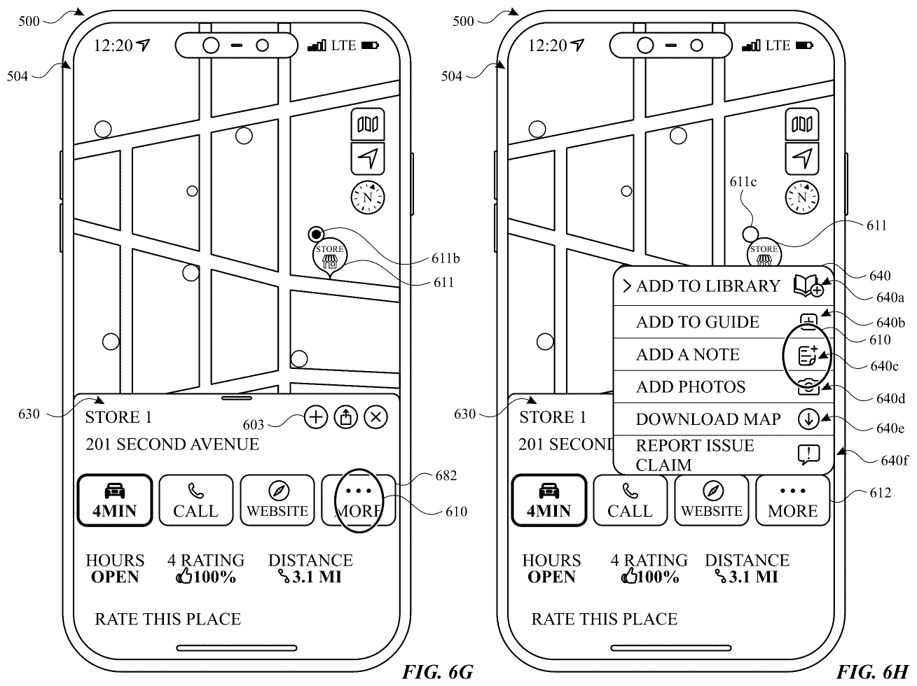

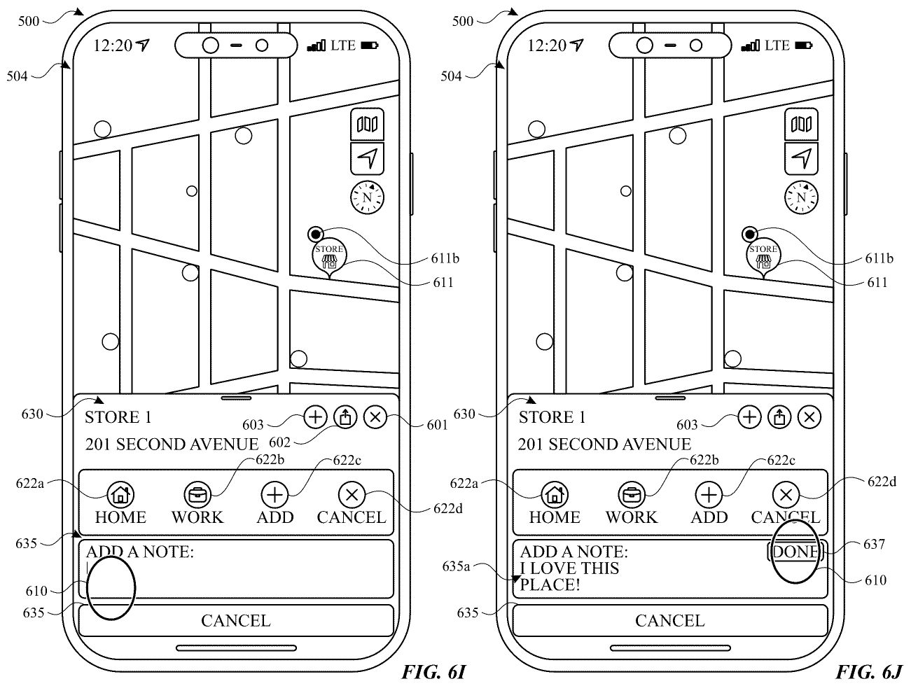

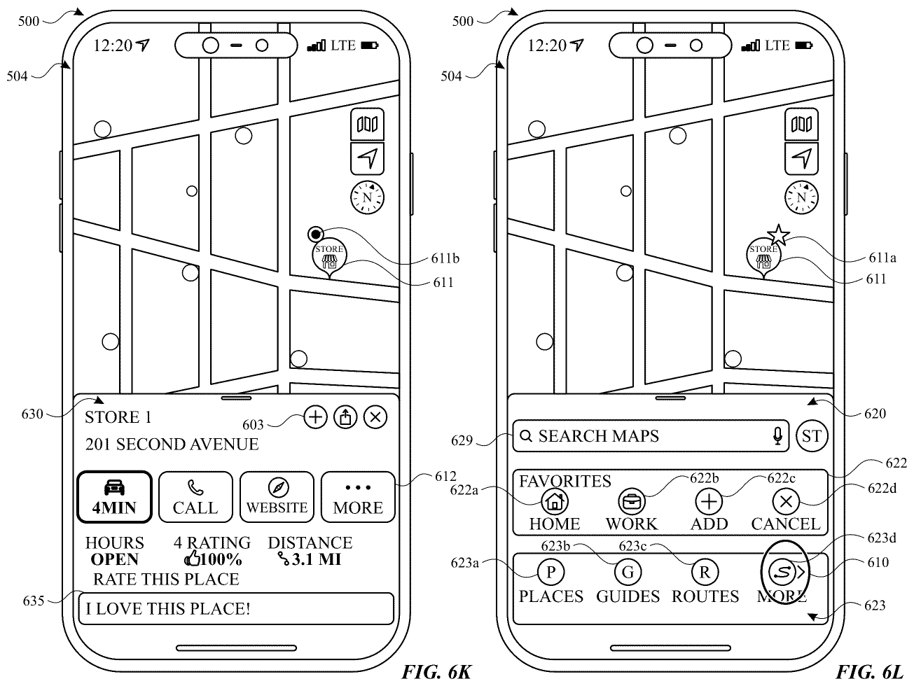

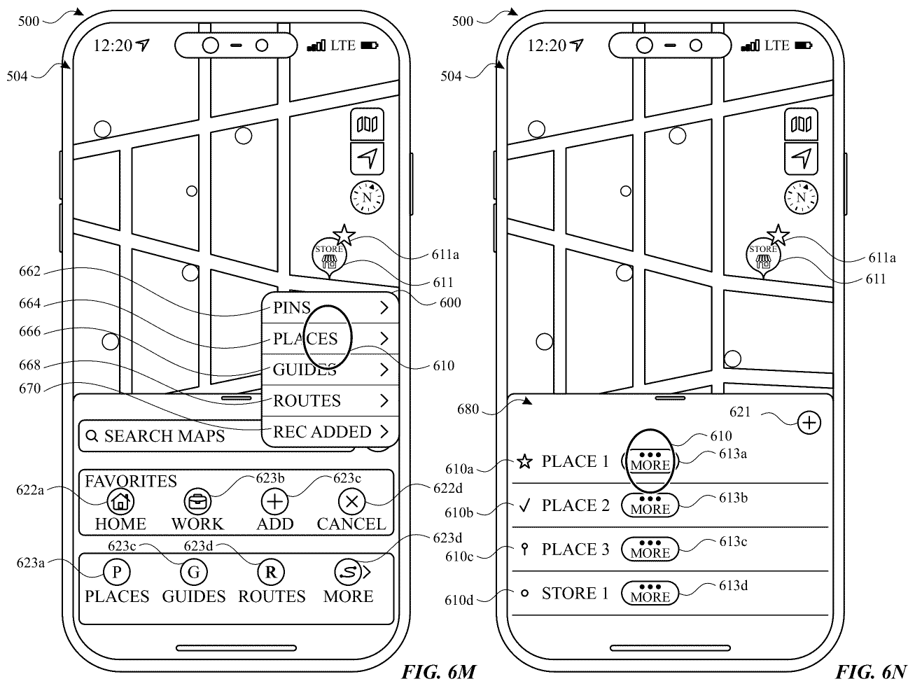

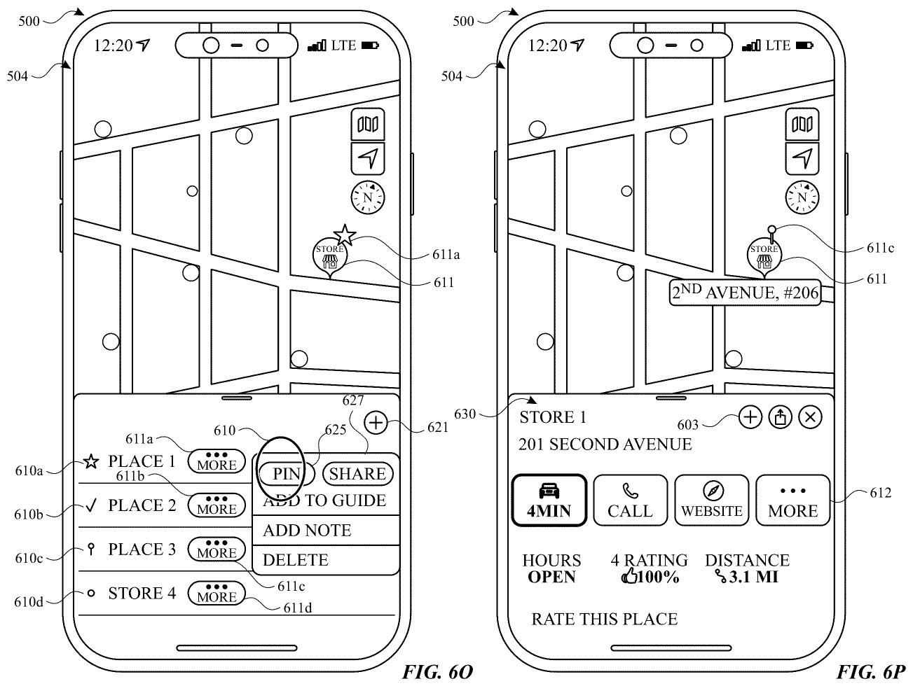

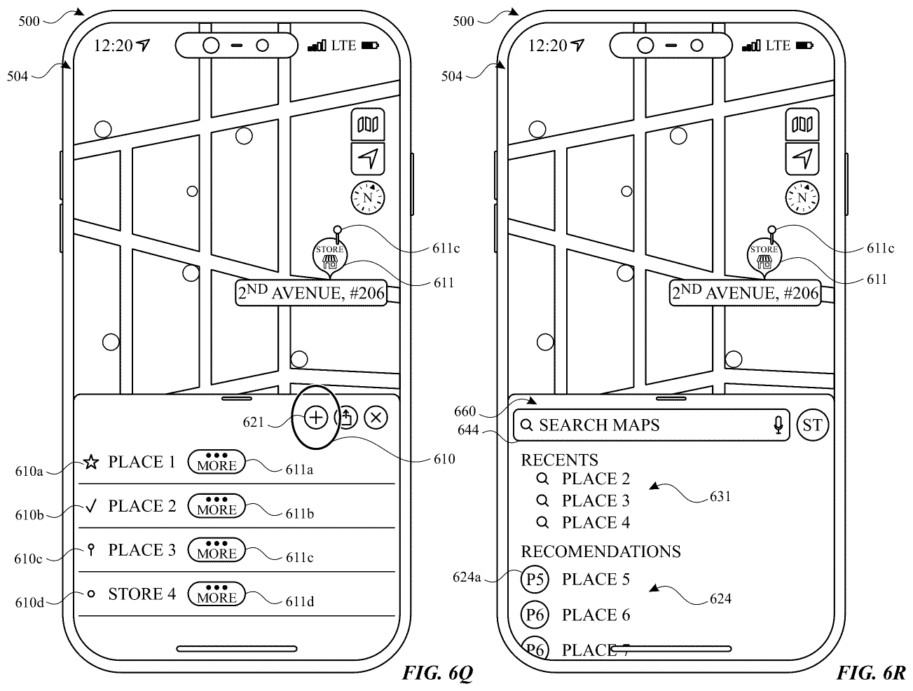

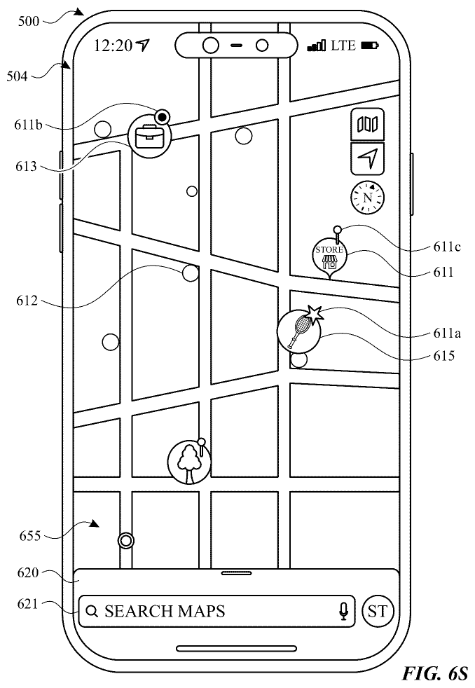

FIGS. 6A-6S illustrate exemplary ways in which an electronic device displays representations of location and/or collections of locations. The embodiments in these figures are used to illustrate the processes described below, including the processes described with reference to FIG. 7. Although FIGS. 6A through 6S illustrate various examples of ways an electronic device is able to perform the processes described below with respect to FIG. 7, it should be understood that these examples are not meant to be limiting, and the electronic device is able to perform one or more processes described below with reference to FIG. 7 in ways not expressly described with reference to FIGS. 6A through 6S.

FIG. 6A illustrates embodiments related to a user interface for a mapping application. FIG. 6A illustrates an electronic device 500 that is in communication with a display generation component 504 (e.g., a touchscreen). In some embodiments, the electronic device 500 is a mobile device, such as a smartphone, tablet, or wearable device. In some embodiments, display generation component 504 is a touchscreen, a non-touch sensitive display, and/or a projected display in which images are cast into a physical environment of a user of the electronic device 500.

In FIG. 6A, electronic device 500 displays a user interface, which optionally corresponds to a user interface for a mapping application—at times referred to herein as a “maps” application. For example, electronic device 500 displays a representation of a map—at times referred to herein as a map for brevity—which includes representations of streets, location, geographic features, landmarks, and the like. In some embodiments, electronic device 500 displays one or more icons, shapes, and/or additional or alternative information overlaying the map to indicate the presence and relative location of one or more points of interest. For example, location 612 corresponds to a first location displayed with a particular visual appearance in FIG. 6A.

In some embodiments, the visual appearance of a location corresponds to a default visual appearance in accordance with a determination that the corresponding location is not yet associated with a library of locations managed by electronic device 500. For example, electronic device 500 in FIG. 6A displays location 612 with the default visual appearance corresponding to a circle with a first scale relative to the displayed user interface. As described further below and/or with reference to method 700, location 612 is not yet added to a category of a plurality of categories that comprise a library managed by electronic device 500, and is accordingly displayed with the default visual appearance.

In some embodiments, electronic device 500 displays a representation of a location of electronic device 500 and/or a user of electronic device 500 relative to the map. For example, visual indication 655—corresponding to a series of concentric circles having different radii-which indicate that the user is at a location relative to the map, sharing a general geographic environment with location 612. In FIG. 6A, electronic device 500 also displays card 620, corresponding to a user interface associated with displaying or alternative information associated with the map and/or with locations represented in the map. In some embodiments, card 620 includes one or more selectable options, such as selectable option 621, which when selected, causes electronic device 500 to initiate an operation to search for location in accordance with user input (e.g., text, dictation, simulated handwriting, and/or some combination thereof) directed to selectable option 621.

In FIG. 6A, electronic device displays a location 611 with a default visual appearance for locations that are not yet added to a category and/or a library of categories associated with the maps application. For example, electronic device 500 displays location 611 as illustrated in FIG. 6A in response to detecting an input, such as a contact on a touchscreen that optionally corresponds to display generation component 504. In FIG. 6A, electronic device 500 detects a subsequent input 610 while displaying location 611 with the default visual appearance. As described with reference to method 700, input 610 is a contact on a touchscreen directed to location 611, a selection with hardware peripheral such as a mouse while a cursor is directed to location 611, and/or a voice input requesting selection of location 611.

From FIG. 6A to FIG. 6B, electronic device 500 displays card 630 in response to detecting input 610 as shown in FIG. 6A. Card 630 includes information associated with the selected location 611, such as name of the location (e.g., “store 1”), an address of the location (e.g., “201 second avenue”), and additional or alternative information including operating hours of a store corresponding to the location, ratings associated with the location, and the like. In some embodiments, card 630 includes selectable options, which when selected, cause electronic device 500 to perform one or more operations related to the selected location 611. For example, electronic device 500 displays selectable option 603, which is selectable to add location 611 to a category associated with the maps application, as described with reference to method 700 and further below. In FIG. 6B, selectable option 603 is displayed with an initial visual appearance including a “+” symbol, indicating that in response to detecting selection input directed toward selectable option 603, electronic device optionally adds the location 611 to a category. Additionally, electronic device 500 displays selectable option 618, which is optionally selectable to cause electronic device 500 to display additional or alternative selectable options and/or information, that when selected, cause electronic device 500 to perform additional or alternative operations related to location 611. Turning back to selectable option 603, in FIG. 6B, electronic device 500 detects input 610 directed to selectable option 603; in response to detecting input 610, electronic device 500 optionally adds location 611 to a category such as a collection of locations that the user of electronic device 500 has indicated are “favorite” locations (and/or are locations added to a “places category” as described with reference to method 700).

From FIG. 6B to FIG. 6C, electronic device 500 adds location 611 to the category including locations that a user of electronic device 500 indicated are “favorite” locations. In FIG. 6C, electronic device 500 changes the visual appearance of location 611 to reflect inclusion of location 611 in the “favorite” category (e.g., at times, referred to herein as a “places” category that the user indicated are favorited places and/or locations). For example, from FIG. 6B to FIG. 6C, electronic device 500 initiates display of badge 611a which corresponds to star-shaped icon overlaying a corner region of the representation of location 611. Thus, electronic device 500 updates the visual appearance of location 611 from the default visual appearance described above, to an updated appearance, optionally including the badge 611a in FIG. 6C.

As described further with reference to method 700, electronic device 500 optionally updates additional or alternative aspects of the visual appearance of location 611, including, but not limited to, color, scale, display of text, level of opacity, display of an animation, and/or some combination thereof. In FIG. 6C, electronic device 500 updates display of the selectable option 603 concurrently while updating the visual appearance of location 611 (e.g., in response to the same input 610 as shown in FIG. 6B). For example, electronic device 500 updates the appearance of selectable option 603 from including a “+” symbol to including a checkmark symbol.

In some embodiments, in response to detecting input 610 as shown in FIG. 6B, electronic device 500 otherwise maintains display of other elements of the displayed user interface for the maps application, such one or more of the selectable options and/or information included in card 630. In some embodiments, electronic device 500 detects input, such as input 610 as shown in FIG. 6C, directed to selectable option while the selectable option 603 is displayed including the checkmark (e.g., is displayed with a visual appearance indicating the inclusion of location 611 in the “favorites” category).

From FIG. 6C to FIG. 6D, electronic device 500 ceases display of selectable option 603 with the updated visual appearance and reinitiates display of selectable option 603 with the initial visual appearance. For example, from FIG. 6C to FIG. 6D, electronic device 500 ceases display of the checkmark symbol, and initiates display of the “+” symbol. In some embodiments, electronic device 500 removes the location 611 from the “favorites” category in response to detecting selection input 610, as shown in FIG. 6C. In FIG. 6D, electronic device 500 detects input 610 directed to selectable option 682, which when selected, optionally causes electronic device 500 to display the plurality of selectable options associated with performing operations related to location 611 as described above.

In FIG. 6E, electronic device 500 displays menu 640 overlaying card 630. For example, in response to detecting the input 610 as shown in FIG. 6D, electronic device 500 displays menu 640. In some embodiments, electronic device 500 displays menu 640, which includes selectable option for: adding information to be associated with location 611, adding location 611 to the library of categories, adding location 611 to a “guides” category, adding a note to be associated with location 611, downloading information corresponding to the maps application, and/or submitting an issue report associated with location 611.

In some embodiments, menu 640 includes selectable option 640a, which when selected, causes electronic device 500 to add location 611 to the library (e.g., to one or more categories managed by the library, such as the favorites category). In some embodiments, menu 640 includes selectable option 640b, which when selected, causes electronic device 500 to add location 611 to a “guides” category included in the library of categories. In some embodiments, the “guides” category corresponds to individual collections of one or more locations, such as a guide for city, a guide for a country, and/or another theme or label that the user defines for the guide. In some embodiments, menu 640 includes selectable option 640c, which when selected, causes electronic device 500 to prompt a user of electronic device 500 to provide input (e.g., as described above) adding information to be displayed in the card 630, such as a text and/or voice notes, and as described further with reference to method 700. In some embodiments, menu 640 includes selectable option 640d, which when selected, causes electronic device 500 to initiate a process to select and/or upload media to be included in card 630, such as one or more photos that the user took when visiting the physical location corresponding to location 611. In some embodiments, menu 640 includes selectable option 640e, which when selected, causes electronic device 500 to download information, such as map data and/or metadata that electronic device 500 uses to display the map and/or information related to locations depicted in the map when electronic device 500 determines a communication link quality is suboptimal for wireless communication. In some embodiments, menu 640 includes selectable option 640f, which when selected, causes electronic device 500 to initiate a process to submit a report indicating an issue that relates to location 611. In FIG. 6E, electronic device 500 detects input 610 directed toward selectable option 640b, and in response, initiates a process to add the location 611 to the guides category.

From FIG. 6E to FIG. 6F, electronic device 500 displays user interface element 650 overlaying card 630. In some embodiments, user interface 650 corresponds to a user interface element that prompts a user of electronic device 500 to select a preexisting and/or a to create a new “guide” as described above. For example, in FIG. 6F, electronic device 500 displays a plurality of selectable options included in user interface elements 650, including selectable option 650a which optionally corresponds to a first guide, and including selectable option 650b, which when selected, causes electronic device 500 to initiate a process to define a new guide and/or add the location 611 to the guides category.

In some embodiments, electronic device 500 detects selection input 610 directed to selectable option 650a, and in response, adds location 611 to a corresponding guide (e.g., “guide 1”) in the guides category. Thus, location 611 is optionally added to a collection of locating included in the guide, and/or location 611 is optionally added to the broader “guides” category that includes the selected guide. In response to detecting selection of selectable option 610 in FIG. 6F, electronic device 500 updates the visual appearance of location 611 to include badge 611b. In some embodiments, in accordance with a determination that location 611 corresponds to the guides category and the favorites category, electronic device 500 displays location 611 with a hybrid visual appearance indicating inclusion of location 611 in both categories. For example, electronic device 500 optionally displays location 611 with badge 611a as shown in FIG. 6C and/or with badge 611b as shown in FIG. 6G.

In some embodiments, in accordance with a determination that location 611 corresponds to the guides category and the favorites category, electronic device 500 displays location 611 with a visual appearance indicative of the corresponding guide to which location 611 was most recently added. For example, in accordance with a determination that location 611 was most recently added to the guides category, electronic device 500 displays location 611 including badge 611b as shown in FIG. 6G (and/or forgoes display of badge 611a). In accordance with a determination that location 611 was most recently added to the favorites category, electronic device 500 displays location 611 including badge 611a as shown in FIG. 6C (and/or forgoes display of badge 611b).

In some embodiments, electronic device 500 detects selection input directed to selectable option 650b, and in response, initiates a process to add a new guide to the guides category. For example, in response to detecting such input, electronic device 500 optionally displays a prompt for text and/or dictation input to add a title to the new guide. In response to detecting the text and/or dictation input, electronic device 500 optionally displays the name of the new guide in accordance with the input, and in response to detecting selection input directed to a selectable option associated with confirming the input, optionally creates the new guide and/or adds location 611 to the new guide. In some embodiments, in response to detecting the selection input directed to the selectable option associated with confirming the input, electronic device 500 displays location 611 with badge 611b, as shown in FIG. 6G.

In FIG. 6G, electronic device 500 detects input 610 directed to selectable option 682. In response to detecting input 610 in FIG. 6G, electronic device 500 optionally displays menu 640, as shown in FIG. 6H. In some embodiments, electronic device 500 detects input 610 directed to selectable option 640c, and in response, initiates a process to add information to be displayed in card 630. For example, in FIG. 6I, electronic device 500 displays information field 635 in response to detecting input 610 in FIG. 6H. Field 635 optionally includes text prompting the user to provide input (e.g., “add a note” prompting the user to provide voice, keyboard, and/or simulated handwritten input). In FIG. 6I, electronic device 500 detects input 610 directed to field 635, and in response initiates entry of information in accordance with one or more of the aforementioned types of input. For example, from FIG. 6I to FIG. 6J, electronic device 500 detects one or more inputs directed to a virtual keyboard, and in response, inserts corresponding text 635a displayed in the field 635. In some embodiments, to add the text 635a to card 630, electronic device 500 detects input 610 directed to selectable option 637, which corresponds to a selectable option to save the user's entered information. In FIG. 6K, in response to detecting input 610 as shown in FIG. 6J, electronic device 500 displays the entered information included in field 635.

In some embodiments, the entered information is saved to and/or preserved in the card 630. In some embodiments, after ceasing display of card 630 such as in response to one or more touch inputs swiping downward on an upper edge of card 630, electronic device 500 detects a selection input directed toward location 611. In response to detecting the downward swiping input, electronic device 500 optionally displays card 630 again. In such an example, electronic device 500 optionally displays card 630 including the information included in field 635, as shown in FIG. 6K, because the selection input 610 as shown in FIG. 6J effectively saved that information to the card 630.

FIGS. 6L through 6R illustrate embodiments in which locations and/or categories are accessed from card 620 described above. For example, electronic device 500 optionally displays a user interface as shown in FIG. 6L in response to detecting input launching the maps application, such as voice input detected by electronic device 500 and/or such as touch input directed to an application icon corresponding to the maps application. In FIG. 6L, card 620 includes a plurality of selectable options. For example, card 620 includes search bar 629, which is optionally selectable to initiate search operations for locations in accordance with user input. Card 620 further includes favorites 622, which optionally includes a plurality of selectable options corresponding to locations that the user of electronic device 500 has indicated correspond to the favorites category described above. In FIG. 6L, electronic device 500 displays selectable options 622a and 622b, which respectively correspond to locations that the user has indicated are their home and work addresses and/or locations. Additionally or alternatively, electronic device 500 displays selectable option 622c, which when selected, causes electronic device 500 to add a new location to the favorites 622. In some embodiments, electronic device 500 displays a location that has been added to the favorites category, such as corresponding to location 611 as shown in FIG. 6C. In some embodiments, selectable option 622d corresponds to a selectable option, which when selected, causes electronic device 500 to forgo display of the selectable options.

In FIG. 6L, electronic device 500 displays library 623. Library 623, as described with reference to method 700, optionally includes a plurality of representation of categories, the respective categories optionally comprising one or more locations that correspond to those categories (e.g., or an empty category which does not include a location). For example, electronic device 500 displays selectable option 623a, corresponding to a “places” category which the user optionally indicated as favorited places (e.g., is similar to or the same as the favorited places described above). Additionally, library 623 optionally includes selectable option 623b, which optionally corresponds to the guides category described above, and includes selectable option 623c, which optionally corresponds to one or more routes between one or more locations that the user has saved and/or favorited. In FIG. 6L, electronic device 500 detects input 610 directed to selectable option 623d, corresponding to a selectable option which, when selected, causes electronic device 500 to initiate display of a menu corresponding the library 623.

From FIG. 6L to FIG. 6M, electronic device 500 displays menu 600 corresponding to the library 623, such as in response to detecting input 610 as shown in FIG. 6M. In FIG. 6L, location 611 has been added to the places category, as indicated by badge 611a. In some embodiments, electronic device 500 displays menu 600 which includes representation of the categories that are included in the library described above. For example, in FIG. 6M, menu 600 includes a first category 662, a second category 664, a third category 666, a fourth category 668, and a fifth category 670, respectively corresponding to locations and/or routes that the user has: “pinned” (e.g., placed a temporary location marker in response to input directed to the map, as described further below), that the user has indicated as a favorited location (e.g., “places”), that the user has added to a guide, that the user has saved as a favorited route, and/or that the user has added within a threshold amount of time (e.g., one hour, three hours, six hours, one day, two days, one week, one month, and/or the like). In response to detecting selection input directed to respective items represented in menu 600, electronic device 500 optionally initiates display of a user interface for browsing and/or interacting with the content of the selected item (e.g., the locations included in a selected category). In FIG. 6M, for example, electronic device 500 detects input 610 directed to selectable option 602, corresponding to a request to display the locations included in the places category.

In some embodiments, in response to detecting input 610 directed to selectable option 602 as shown in FIG. 6M, electronic device 500 optionally displays a user interface related to the places category and/or the favorites category, such as user interface 680 as shown in FIG. 6N. User interface 680 optionally includes at least a portion of the one or more locations that have been added to the places category. For example, electronic device 500 displays representation 610a, corresponding to location 611 that is displayed overlaying the map. In some embodiments, the representation 610a includes information that is similar to, or the same as displayed overlaying the map. For example, electronic device 500 in FIG. 6N displays a star-shaped icon included in representation 610a, which is optionally similar to or the same as badge 611a that overlays the map. Thus, electronic device 500 optionally displays a representation of the location in the user interface 680 with a visual appearance that relates to the visual appearance of the representation of the location 611 in the maps portion of the user interface. Additionally, representation 610a in FIG. 6N includes a text label that corresponds to information displayed in the location card that corresponds to location 611 (e.g., as shown in FIG. 6B, “store 1”). In FIG. 6N, electronic device 500 displays selectable option 621, which is optionally a selectable option that is selectable to initiate a search operation for locations that electronic device 500 is able to add to the places category.

In some embodiments, electronic device 500 displays representation of locations indicating that the locations have been added to a plurality of categories. In FIG. 6N, electronic device 500 displays locations 610b through 610d included in user interface 680. Locations 610b through 610d optionally correspond to additional locations that correspond to places category and additional or alternative categories. For example, location 610b includes a check mark badge indicating that a corresponding location is added to the places category and/or a guides category, a routes category, a “pinned” category as described with reference to method 700, and/or some combination thereof. Additionally or alternatively, representation includes a pushpin shaped badge, indicating that a corresponding location is added to the places category and/or a guides category, a routes category, a “pinned” category as described with reference to method 700, and/or some combination thereof. Similarly, representation 610d is displayed with a circle indicating that a corresponding location is added to the places category and/or a guides category, a routes category, a “pinned” category as described with reference to method 700, and/or some combination thereof. In FIG. 6M, electronic device 500 displays selectable options 613a through 613d, which when selected, causes electronic device 500 to display information and/or selectable operations associated with the corresponding location, such as a selection input 610 directed to 613a.

In FIG. 6O, electronic device 500 displays menu 627 including selectable option 625 in response to detecting the selection input 610 as shown in FIG. 6N, and including additional or alternative selectable options to send the location corresponding to representation 610a to other devices, to add the location to the guides category, to add a note (similar to or the same as described above) related to the location, and/or to remove the location from the places category. In some embodiments, menu 627 includes one or more selectable options that are respectively selectable to cause electronic device 500 to perform operations related to a corresponding location (e.g., location 611 corresponding to representation 610a in FIG. 6O). For example, selectable option 625 is optionally selectable to cause electronic device 500 to add the location corresponding to representation 610a to the pinned category, described with reference to method 700. In FIG. 6O, electronic device 500 detects input 610 directed to selectable option 625.

From FIG. 6O to FIG. 6P, electronic device 500 initiates display of the card 630 corresponding to location 611, similar to or the same as described above. In some embodiments, in response to detecting input such as input 610 as shown in FIG. 6O adding the location 611 to the pinned category, electronic device 500 displays location 611 with a visual appearance different from one or more of the above-described visual appearances. For example, electronic device 500 in FIG. 6P displays location 611 with badge 611c, corresponding to a rounded pushpin graphic and/or icon, indicating that the location 611 has been “pinned” (e.g., at least temporarily marked on the map and/or at least temporarily added to the pinned category). In FIG. 6P, electronic device 500 displays card 630 including a name of the location (e.g., in accordance with a determination that a point of interest such as a store corresponds to the location). In some embodiments, electronic device 500 displays card 630 including information indicating an address, and/or geographic location information. Additionally, in the maps portion of the user interface in FIG. 6P, electronic device 500 displays at least a portion or all of the address of the location (e.g., underneath location 611 in FIG. 6P).

FIG. 6Q illustrates an embodiment in which electronic device 500 initiates a search for locations to add to a category. For example, in FIG. 6Q, electronic device 500 displays a user interface associated with the places category, similarly to or in a same manner as described above with reference to FIG. 6N. In some embodiments, electronic device 500 detects selection input 610 directed to selectable option 621. In response to detecting input 610 as shown in FIG. 6N, electronic device 500 initiates display of user interface 660, corresponding to a search user interface for locations that electronic device 500 is able to add to the places category.

In some embodiments, user interface 660 includes a search bar 644. In some embodiments, in response to detecting input such as a selection input directed to search bar 644, electronic device 500 initiates a process to search for locations in accordance with user input. For example, after detecting the input directed to search bar 644, electronic device 500 detects one or more inputs directed to a virtual keyboard displayed by electronic device 500, via one or more microphones, and/or via simulated handwriting with a fingertip or a stylus. The one or more inputs optionally include a request to enter text that is directed to the search bar in the search bar 644. In some embodiments, in response to detecting the one or more inputs, electronic device 500 populates user interface 660 with representation of one or more locations which, when selected, causes electronic device 500 to add the locations selected from those displayed in the user interface 660 to the places category. In some embodiments, user interface 660 includes one or more locations 624, such as location 624a corresponding to a first recommended location.

In some embodiments, electronic device 500 displays a plurality of representations of locations that were recently searched for, interacted with, and/or received from another device. For example, in FIG. 6R, electronic device 500 displays a plurality of locations 631 (e.g., “place 2,” “place 3,” place 4″). Additionally, electronic device 500 in FIG. 6R displays recommended locations 624. Locations 624 optionally include locations that the user has recently visited, locations that are popular with users of other electronic devices sharing one or more characteristics (e.g., travel patterns, geographic region, and/or age) with a user associated with the electronic device 500, such as a user account. For example, location 624a is optionally displayed in FIG. 6R in accordance with a determination that the user is currently located in the city that the location 624a is located within.

FIG. 6S illustrates embodiments in which electronic device 500 displays a plurality of representation of locations, respectively with visual appearances in a manner similar to or the same as described with reference to FIGS. 6A through 6R. For example, in FIG. 6S, electronic device 500 concurrently displays location 611 with a first visual appearance including first badge 611c, second location 615 with a second visual appearance including a second badge 611a, third location 613 with a third visual appearance including a third badge 611b, and/or fourth location 612 with a fourth visual appearance not including a badge, indicating the association between respective locations and one or more categories included in the library managed by electronic device 500. In FIG. 6S, electronic device 500 displays additional or alternative visual elements similar to or the same as described with reference to FIGS. 6A through 6R.

Some of the embodiments described above with reference to FIGS. 6A through 6Q include interactions and/or operations directed to adding locations to the places category. It is understood that similar or the same interactions and/or operations are optionally performed by electronic device 500, such as displaying a card user interface corresponding to a guides category and/or a pinned category, and/or browsing, adding, and/or removing locations from the guides and/or pinned category, in a manner similar to or the same as described with reference to the places category.

FIG. 7 illustrates a flow diagram illustrating a method in which an electronic device displays a representation of a location in a mapping user interface in accordance with some embodiments of the disclosure. The method 700 is optionally performed at an electronic device and/or electronic devices such as device 100, device 300, or device 500 as described above with reference to FIGS. 1A-1B, 2-3, 4A-4B and 5A-5H. Some operations in method 700 are, optionally combined and/or order of some operations is, optionally, changed.

In some embodiments, a method 700 is performed at an electronic device in communication with one or more input devices and a display generation component, such as electronic device 500 in communication with display generation component 504 as shown in FIG. 6A. For example, the electronic device is optionally a mobile device (e.g., a tablet, a smartphone, a media player, or a wearable device), or a computer or other electronic device. In some embodiments, the display generation component is a display integrated with the electronic device (optionally a touch screen display), external display such as a monitor, projector, television, or a hardware component (optionally integrated or external) for projecting a user interface or causing a user interface to be visible to one or more users, etc. In some embodiments, the one or more input devices include an electronic device or component capable of receiving a user input (e.g., capturing a user input, and/or detecting a user input) and transmitting information associated with the user input to the electronic device. Examples of input devices include a touch screen, mouse (e.g., external), trackpad (optionally integrated or external), touchpad (optionally integrated or external), remote control device (e.g., external), another mobile device (e.g., separate from the electronic device), a handheld device (e.g., external), a controller (e.g., external), a camera, a depth sensor, an eye tracking device, and/or a motion sensor (e.g., a hand tracking device, a hand motion sensor), and/or microphone for capturing voice commands or other audio input. In some embodiments, the electronic device is in communication with a hand tracking device (e.g., one or more cameras, depth sensors, proximity sensors, touch sensors (e.g., a touch screen, trackpad)). In some embodiments, the hand tracking device is a wearable device, such as a smart glove. In some embodiments, the hand tracking device is a handheld input device, such as a remote control or stylus.

In some embodiments, while displaying, via the display generation component, a maps user interface (702), the electronic device detects (704), via the one or more input devices, one or more first inputs including a request to add a location to a category associated with a plurality of categories in a library of categories associated with the maps user interface, such as input 610 as shown in FIG. 6B, such as input 610 as shown in FIG. 6E, and/or such as input 610 as shown in FIG. 6O. In some embodiments, the electronic device displays the maps user interface via the display generation component in response to detecting a user input directed to a representation of a maps application displayed on the electronic device. In some embodiments, the maps application is an application stored in memory of the electronic device and/or associated with a user account logged in to the electronic device. In some embodiments, the maps application stored in the memory of the device is configured to cause display a plurality of visual representations of maps as discussed in further detail below. In this example, the electronic device optionally selects some or all of a map to display in the maps user interface, such as a representation of a portion of a map that includes a representation of the user's location. In some embodiments, the representation of the map includes a plurality representations of landmarks as discussed in further detail below with reference to a physical region of a maps element. In this example, the representation of the map optionally includes information (e.g., text box, icon, symbols) related to the plurality of landmarks. In some embodiments, a maps user interface is displayed via the display generation component of a portable communications device, such as a mobile telephone.

In some embodiments, the maps user interface is a user interface of an application other than the map application, such as a travel guide application. In some embodiments, the travel guide application assists a user of the electronic device attempting to plan, gather information, and/or record their travels (e.g., displaying information about restaurants events and/or heritage sites at a desired destination). In some embodiments, the maps user interface includes a first user interface element that, when selected, causes the electronic device to display a second user interface element as described herein. In some embodiments, the first user interface element is associated with a search operation. In some embodiments, the maps user interface incudes a maps element representing a physical region (e.g., the maps element corresponding to a representation of a map). In some embodiments, the maps element includes a representation of a two-dimensional map representing a first physical region. In some embodiments, the physical region is a neighborhood, town, city, state, country, continent, or other geographic area. In some embodiments, the physical region includes an area centered on the location of the electronic device that is based on location data (e.g., GPS data) obtained by the electronic device without requiring user input specifying the location of the electronic device.

In some embodiments, in response to detecting the user input directed to the maps user interface, the physical region represented when initiating the maps user interface is an area centered on a location previously selected by the user and/or a previous location of the electronic device. In some embodiments, the physical region is an area is selected and/or identified by the user via the map user. In some embodiments, the location of the electronic device is displayed as an icon in the map user interface (e.g., location indicator). For example, the electronic device optionally displays the icon with information corresponding to the location of the electronic device, such as an identifier of the location (e.g., name, title, and/or label optionally designated by the user). In some embodiments, the maps element includes a representation of a three-dimensional topographical map of the physical area. For example, a representation of a three-dimensional topographical map of a city optionally includes three-dimensional representations of buildings, streets, and/or other landmarks.

In some embodiments, the maps element includes a visual indication (e.g., a flag, pin, and/or other visual indication) displayed at a respective location that corresponds to an address, landmark, and/or coordinates and/or a selected location discussed in further detail below (e.g., One Apple Park Way, Cupertino, California, White House, a location along a three-dimensional coordinate system possessing a latitude, a longitude, and an elevation). In some embodiments, the maps element is a simulated three-dimension object that is oriented along a surface in the three-dimensional environment and/or is displayed offset from a horizontal plane that is parallel to a floor of the three-dimensional environment. In some embodiments, the first user interface element (e.g., associated with the search operation) is a virtual object that the electronic device displays with a viewing surface (e.g., a surface of the virtual object including content that the user is likely to view and/or interact with) oriented perpendicular to the horizontal plane. In some embodiments, the electronic device changes the display of the maps element (e.g., rotate, re-size, and/or tilt) and/or renders a respective portion of the maps element with a scale relative to the user interface for the maps application to focus on an area and/or location of the representation map in response to detecting a user input (e.g., a press, pinch, and/or a spreading of contacts on a surface such as a trackpad and/or touch screen) directed to the respective portion of the navigation user interface. For example, the user optionally directs a user input such as a pinch gesture, to the respective portion of the navigation user element and, in response, the electronic device optionally zooms in on the first physical area.

In some embodiments, the one or more first inputs include a selection input, such as touch on a touchscreen directed to a selectable option displayed via the touchscreen that includes a button, an icon, one or more images and/or animations, text, and/or some combination thereof. In some embodiments, the location is or corresponds to a restaurant, a store, a stadium, an intersection, or a particular latitude/longitude).

In some embodiments, the electronic device adds the location to a category of a plurality of categories in a library of categories associated with the maps user interface in response to detecting one or more of the above-described inputs (e.g., the selection input). In some embodiments, the plurality of categories includes the category prior to the electronic device detecting the one or more first inputs. In some embodiments, the category (e.g., the category of the plurality of categories corresponding to the request to add the location) is a new category of the plurality of categories in the library of categories created by the electronic device prior to and/or in response to detecting the one or more first inputs. For example, while the electronic device displays the maps user interface, the electronic device optionally detects an input directed at a subsection of the maps user interface corresponding to the creation of a new category. In this example, the electronic device optionally detects an additional input, prior to the one or more first inputs, and in response, the electronic device optionally creates and optionally displays the new category in response to a different selection input than the selection input previously described. In some embodiments, the one or more first inputs include a selection input as described further herein directed to a selectable option such as an icon, a virtual or hardware button, a picture, and/or text.

In some embodiments, the selectable option is included in an interactable “card” as described further herein. In some embodiments, the card is a user interface corresponding to the location, such as a card that includes information describing the location such as a name associated with location, media corresponding to the location, hours of operation of an establishment at the location, and/or an address of the location. In some embodiments, the card includes information corresponding to a library of categories, as described further herein. For example, the card optionally includes a listing of locations added to a category such as the category, including locations that have been indicated as “Favorited” by the user of the electronic device, locations included in “Guides” bookmarked by the user, locations “Pinned” by the user, and/or locations included in additional or alternative categories.

In some embodiments, a representation of the location is displayed including a representation of a pin, icon, or label, overlaid onto a representation of the physical area within the maps element corresponding to the selected location (e.g., overlaying portion of a representation of a map where the location is located). For example, the electronic device optionally displays an icon indicative of a location related to the Alcatraz Federal Penitentiary at a respective location within the maps element corresponding to the physical location (e.g., Alcatraz island in the San Francisco Bay) of the Alcatraz Federal Penitentiary.

In some embodiments, the electronic device receives user input directed to the location icon, and in response to detecting the user input, the electronic device increases the size (e.g., displays an expanded version) of the representation of the location relative to the maps user interface and displays content related to the respective location (e.g., photos, videos, content, text, and/or models of the respective location). In some embodiments, the one or more first inputs comprise a long press on the location within navigation user interface, which includes detecting touch directed to a touchscreen for a period of time greater than a threshold period of time (e.g., 0.1, 0.15, 0.25, 0.5, 1, 1.25, 1.5, or 2 seconds). In some embodiments, the electronic device highlights the selected representation of the location in response to detecting the long press, making it visually distinct from surrounding features of the navigation user interface.

In some embodiments, in response to detecting the long press, the electronic device displays an interactable card containing relevant information and/or a list of affordances associated with the selected location. In some embodiments, the interactable card is displayed as overlaying at least a portion of the maps user interface, such as overlaying some or all of the maps element. For example, the interactable card optionally include details such as the name, address, reviews, ratings, and photos related to the selected location. In some embodiments, the list of affordances associated with the interactable card includes a first affordance to add the location to the category. In some embodiments, the category is a grouping of related places and/or places (e.g., locations) that all share one or more common characteristics (e.g., metadata). For example, the category optionally corresponds to a Guides category, where each location in the category is associated with a same region (e.g., Downtown Los Angeles, Statue of Liberty, and/or Michigan).

In some embodiments, the category belongs to a list of categories that are included in a library of categories. In some embodiments, the library of categories is represented in the interactable card, such as by displaying a list of the categories. For example, the electronic device optionally displays an icon denoting the one or more common characteristic of the places within the category. In some embodiments, the maps user interface is associated with the categories at least by virtue of a connection between the electronic device and a cloud-based service such as iCloud. In this example, the electronic device facilitates synchronization of location data across different platforms and devices using the cloud-based service. In some embodiments, when a user logs into a user account, their phone (e.g., the electronic device) and/or maps application gain access to a shared location library including categorized information about various places, such as restaurants, landmarks, or favorite destinations such as the locations described above. In some embodiments, the electronic device utilizes the information stored in the library to visually differentiate representations of items on the maps user interface as discussed in further detail below.

In some embodiments, the library is updated based on the contents of the shared location library associated with the user's account. In some embodiments, the plurality of categories in the library of categories is displayed as cascading (e.g., arranging, by optionally overlaying multiple application windows with offsets, creating a visual staircase effect) displays of cards that respectively have one or more visual characteristics of the card discussed above. For example, in response to detecting the one or more first inputs, a card with the category, including a plurality of rows of places in the category, is optionally displayed partially overlaying the above card. In some embodiments, the plurality of categories in the library of categories is represented as rows, each row corresponding to a distinct category of locations (e.g., the category). In some embodiments, the plurality of categories in the library of categories is represented as a combination of rows and columns overlaying and/or included in the card. In some embodiments, in response to detecting the one or more first inputs, the electronic device forgoes display of a representation of a map (e.g., cease displaying the representation of the map). In some embodiments, as the maps user interface disappears, a bottom portion of the maps user interface expands relative to the maps user interface to display the library.

In some embodiments, while displaying, via the display generation component, the maps user interface (702), in response to detecting the one or more first inputs, the electronic device adds (706) the location to the category, such as indicated by badge 611a as shown in FIG. 6C. In some embodiments, the representation of the location is displayed with one or more visual characteristics including a first degree of visual prominence described in further detail below. In some embodiments, the one or more visual characteristics include a displayed size of the representation of the location relative to the user interface of the electronic device. In some embodiments, the displayed size of the representation of the location is displayed with a height and/or a width larger than a representation of a location that is not selected to be added to the category. In some embodiments, the first degree of visual prominence includes a first level of brightness (e.g., a predetermined brightness). For example, the representation of the location is optionally displayed with a level of brightness greater than or equal to the brightness of portions of the user interface of the electronic device corresponding to the maps element. In some embodiments, the electronic device alters the representation of the location from the first degree of visual prominence to a second degree of visual prominence in response to detecting input(s) from the user adding the location to the category. For example, the user optionally selects the representation of the location and, in response to detecting selection of the representation of the location, the electronic device optionally updates the level of visual prominence of the representation of the location. In this example, the electronic device optionally updates the representation of the location to be displayed with the second degree of visual prominence. In some embodiments, the first degree of visual prominence corresponds to a smaller displayed size of the representation of the location than the second degree of visual prominence (e.g., larger displayed size of the representation of the location as compared to the first degree of visual prominence). In some embodiments, the electronic device displays a confirmation window (e.g., a two-dimensional pop-up panel including text related to confirming the request to add the location to the category), configured to receive a user input. In some embodiments, the confirmation window is displayed response to detecting a respective input of the one or more first inputs. In some embodiments, the electronic device detects a second input (e.g., included in the one or more first inputs) directed to the confirmation window such as selection of a button that is selectable to add the location to the category. In this example, the user optionally directs the second input to the confirmation window and, in response, the electronic device optionally ceases the display of the confirmation window and adds the location to the category. In some embodiments, the electronic device ceases the display of the confirmation window and adds the location to the category simultaneously or successively. In some embodiments, once the location has been added to the category, the electronic device updates one of the one or more visual characteristics of the representation of the location on the maps element. In some embodiments, the display of the library is ceased after adding the location to the category. In some embodiments, the cessation of the library reveals the maps element underlaying the display of the library.

In some embodiments, after adding the location to the category, and while displaying a representation of a map in the maps user interface including a region of the representation of the map that corresponds to the location (708), such as the map included in the user interface displayed by electronic device 500 as shown in FIG. 6C, in accordance with a determination that the category is a first category of the plurality of categories, such as the category associated with badge 611a as shown in FIG. 6C, the electronic device displays (710), via the display generation component, a visual representation of the location with a first visual appearance overlaying at least a portion of the representation of the map, such as location 611 including badge 611a as shown in FIG. 6C. In some embodiments, the maps user interface incudes the maps element previously described, such as a representation of a map centered around a representation of the selected location. In some embodiments, in response to selecting the representation of the location, the electronic device displays a card (e.g., a user interface including one or more characteristics of the card discussed above) associated with the location, including contextual information related to the selected location, discussed in further detail below. In some embodiments, the electronic device displays the representation of the location overlaying at least a portion of a subsection (e.g., region of the representation of the map that includes a representation of the selected location) of the representation of the map centered around the representation of the selected location. In some embodiments, the representation of the map centered around the representation of the selected location includes a plurality of representations of a plurality of locations not selected. For example, the selected location optionally corresponds to an office in a downtown region, where in this example, the plurality of representations of the plurality of locations correspond to other offices, landmarks, streets and/or restaurants not selected by the user. In some embodiments, in response to the selection of a second representation of a second location, different than the representation of the selected location above, the electronic devices displays a second representation of the map centered around the second representation of the second selected location. In some embodiments, the representation of the location is displayed on the representation of the map in different locations depending on where the location is on the representation of the map (e.g., the representation is displayed at a different location on the map, corresponding to the location, for different locations). In some embodiments, the maps element displays the representation of the selected location with a degree of visual prominence greater than the degree of visual prominence associated with the maps element. In some embodiments, the degree of visual prominence corresponds to an amount of opacity, brightness, color, saturation, and/or sharpness of at least a portion of the selected representation of the location. In some embodiments, the representation of the map is displayed in response to detecting the one or more first inputs and before adding the location to the category.

In some embodiments, the electronic device displays the representation of the location concurrently with an icon corresponding to the category. In some embodiments, the electronic device indicates inclusion of the location to a particular category of the plurality of categories in the library of categories by displaying the icon that corresponds to the particular category (e.g., and does not correspond to another category). In some embodiments, displaying the visual representation with the first visual appearance includes displaying the icon corresponding to the category. In some embodiments, the first visual appearance is a modification of one or more visual characteristics of the display of the visual representation of the location in response to adding the location to the category. For example, in response to adding the location to the respective location, the display of the visual representation optionally updates to include a badge (e.g., the first visual appearance) associated with the category. In some embodiments the first visual appearance of the representation of the location includes one or more visual characteristics such as a size, shape, and/or color associated with the category. In some embodiments, first visual appearance comprises displaying the icon as described above partially overlaying the visual representation of the location. In some embodiments, the first visual appearance includes using distinct icons, colors, or labels to represent different categories of locations.

In some embodiments, after adding the location to the category, and while displaying a representation of a map in the maps user interface including a region of the representation of the map that corresponds to the location, (708) in accordance with a determination that the category is a second category, different than the first category, such as the category associated with badge 611b as shown in FIG. 6G, the electronic device displays (712), via the display generation component, the visual representation of the location with a second visual appearance, different than the first visual appearance, overlaying the at least the portion of the representation of the map, such as location 611 displayed including badge 611b as shown in FIG. 6G. In some embodiments, one or more characteristics included in the second visual appearance are different from the one or more visual characteristics of the first visual appearance. For example, the second visual appearance optionally includes an icon partially overlaying the visual representation of the location, the icon being a different size, shape, including a different graphic, and/or color than the icon associated with the first visual appearance. In some embodiments, the second visual appearance is displayed with a color, different than the color associated with the first visual appearance. In some embodiments, the first and the second visual appearance correspond to different respective scales of the visual representation of the location relative to the maps user interface. For example, displaying the representation of the location with the first visual appearance optionally includes displaying an icon with a first size relative to the maps user interface, and displaying the representation of the location with the second visual appearance optionally includes displaying the same icon (and/or a different icon) with a second size relative to the maps user interface. In some embodiments, in accordance with a determination that the category is a third category, the electronic device displays the visual representation with a visual appearance different from the second visual appearance. For example, the electronic device optionally displays the visual representation with a third visual appearance, different than the first and the second visual appearance when the category corresponds to the third category. In some embodiments, the third visual appearance has one or more characteristics similar to or the same as one or more characteristics described with reference to the first and/or the second visual appearances. In some embodiments, the electronic device displays the representation of the location with the third visual appearance in response to detecting input(s) adding the category to a third category of the plurality of categories not corresponding to the first or the second category. In some embodiments, in response to detecting input(s) adding a second location to the category, the electronic device displays of a visual representation of the second location with the first visual appearance when the category corresponds to the first category and/or displays the visual representation of the second location with the second visual appearance when the category corresponds to the second category.

The above method introduces a functionality that allows for efficient organization and visualization of different types of locations on the representation map, enhancing user experience and facilitating quick identification and differentiation between various categories of locations by altering the visual appearance of a respective location based on its category, thus reducing visual clutter in the maps user interface, and thereby reducing cognitive load required by the user.

In some embodiments, after adding the location to the category, and while displaying the representation of the map in the maps user interface including the region of the representation of the map that corresponds to the location (e.g., as described with reference to method 700), such as in accordance with a determination that the category is a third category, different from the first category and different from the second category, the electronic device displays, via the display generation component, the visual representation of the location with a third visual appearance, different than the first visual appearance and the second visual appearance, overlaying at least the portion of the representation of the map, such as a visual appearance including display of badge 611c as shown in FIG. 6Q. In some embodiments, the third visual appearance includes one or more characteristics of the first visual appearance and/or the second visual appearance. For example, the electronic device optionally displays the visual representation including an icon with the third visual appearance similar in size, shape, color and/or opacity as the first and/or second appearances corresponding icon as discussed above. In some embodiments, the electronic device maintains display of the representation of the map in the maps user interface when changing the visual representation of the location, such as changing to the third visual appearance. In some embodiments, the electronic device displays the visual representation of the location with the first visual appearance or the second visual appearance prior to the location being added to the category. In some embodiments, in response to detecting an input adding the location to the category, the electronic device animates the change in the visual representation of the location to correspond to the third visual appearance. For example, in response to detecting the input adding the location to the category, the electronic device optionally displays, at least partially overlaying the visual representation of the location, an icon appearing to grow from a point to a predetermined size. In some embodiments, the third visual appearance including displaying a pushpin shape with a rounded, teardrop-like top that tapers into a point at the bottom. In this example, the pin is additionally (and optionally) displayed with a bright, solid color, such as red and featuring a thin outline and slight shadow or shading. In some embodiments, the electronic device displays the visual representation of the location with aspects of the third visual appearance, the first visual appearance, and/or the second visual appearance simultaneously, such as including a plurality of icons that partially overlay and/or are displayed near the visual representation of the location. In some embodiments, the third visual appearance indicates that the location is associated with the third category. In some embodiments, the third visual appearance includes contextual information associated with the location. For example, after adding the location to the third category, the electronic device optionally displays the visual representation of the location with the third appearance (e.g., the pin as described above), optionally including a text box containing an address associated with the location below the visual representation of the location overlaying a portion of the representation of the map different than the at least portion of the representation of the map.

Displaying the visual representation of the location with differing visual appearances depending on the category the location is added to allows for the user to quickly ascertain the category a respective location belongs to when viewing the representation of the map in the maps user interface and serves as a visual indication the location has been successfully added to the category.

In some embodiments, displaying the maps user interface includes displaying information corresponding to the respective location including an icon with a visual appearance corresponding to a respective first visual appearance, such as selectable option 603 as shown in FIG. 6B. In some embodiments, the information corresponding to the respective location includes one or more characteristics of the contextual information as discussed above with reference to method 700. In some embodiments, the electronic device displays the information corresponding to the respective location in the card associated with the location as previously discussed. In some embodiments, the electronic device displays the card associated with the location included in the maps user interface, overlaying a portion of the maps user interface while leaving the representation of the map visible. In some embodiments, the icon includes one or more characteristics of the selectable option discussed above with reference to method 700. In some embodiments, the icon is one of a plurality of distinct icons displayed within the maps user interface. In some embodiments, the electronic device displays the icon with the respective first visual appearance at a time after the electronic device displays the card associated with the location. In some embodiments the visual appearance of the icon includes one or more characteristics of the first visual appearance, the second visual appearance and/or the third visual appearance as discussed previously. In one particular embodiment, the respective first visual appearance optionally includes a circular icon with a centrally positioned “+” sign (e.g., a “plus” sign), optionally with a light background and a dark plus sign for contrast. In some embodiments, the electronic device displays the plus sign as previously described with a color palette corresponding to the color palette determined by an operating system of the electronic device (e.g., associated with dark mode and/or light mode of a user interface). In some embodiments, the electronic device displays the icon overlaying the representation of the map, and/or not overlaying the card associated with the location.

In some embodiments, in response to detecting the one or more first inputs, and in accordance with a determination that the category corresponds to the third category, the electronic device updates the visual appearance of the icon from the respective first visual appearance to a respective second visual appearance, different than the respective first visual appearance, such as selectable option 603 as shown in FIG. 6C, indicating location 611 corresponds to a category associated with badge 611a. For example, the electronic device optionally changes one or more of a fill pattern, a color, a size, a number and/or which character(s) are included in the icon, a level of opacity, and/or some combination thereof when changing from the respective first visual appearance to the respective second visual appearance of the icon. As one example, the electronic device optionally initially displays the icon including a first text such as a “+” symbol enclosed in a circular shape that is filled with a first color. While displaying the icon with the first text and/or filled with the first color, the electronic device optionally detects selection directed to the icon, and optionally changes the text to correspond to second text such as a checkmark character and/or changes the color to correspond to a second color (e.g., forgoes displaying of the first text and/or the first color). In some embodiments, in response to detecting selection such as a tapping (e.g., one or more first inputs) of a touchscreen where the icon (e.g., plus icon) is displayed, the electronic device displays an animation including an increasing in brightness of the icon and/or enlarging of the icon to indicate the one or more inputs have been registered. In some embodiments, the electronic device optionally, subsequently changes the “+” symbol into the respective second visual appearance (e.g., checkmark). In some embodiments, in response to detecting the one or more first inputs (e.g., selection of the icon), the electronic device updates the icon from the first visual appearance to the second visual appearance while simultaneously adding the location to the second category (e.g., the “pinned” category discussed above with reference to the method 700). In some embodiments, the animation—at times, referred to herein as an update animation—is displayed over a time period during which the electronic device updates the background color of the icon. In some embodiments, the electronic device updates the visual appearance of the icon from the respective first visual appearance to the second visual appearance using any suitable combination of the as previously described operations (e.g., optionally utilizing the update animation but not updating the background color of the icon). In some embodiments, the electronic device detects the one or more inputs directed at the icon, and in response, adds the location to the category corresponding the third category. Updating the visual representation of the icon in accordance with adding the location to a particular category improves the likelihood that the user of the electronic device is able to determine if the respective location has been successfully added to the particular category without requiring additional input to verify whether the respective location is added to the particular category, thereby reducing power consumption required to perform operations associated with the additional input.

In some embodiments, the one or more first inputs including the request to add the location to the category associated with the maps user interface are detected while the electronic device displays the representation of the location with a third visual appearance, different from the first visual appearance and different from the second visual appearance, in the maps user interface, such as the visual appearance of location 612 and/or location 611 as shown in FIG. 6A. In some embodiments, the location is one of a plurality of locations represented in the representation of the map. In some embodiments, a plurality of representations of locations that are represented in the maps user interface includes one or more characteristics of the representation of the location as discussed above with reference to the method 700. In some embodiments, in accordance with a determination that a representation of a location displayed in the representation of the map is not associated with a category (e.g., has not been added to a category), the electronic device displays the representation of the location with a third visual appearance. For example, the representation of the location described with reference to method 700 is optionally displayed with the third visual appearance prior to detecting the one or more inputs adding the location to the category. In some embodiments, the third visual appearance indicates that a location does not correspond to a category. In some embodiments, the third visual appearance does not include an icon (e.g., the icon associated with the first visual appearance discussed above with reference to the method 700) overlaying a portion of the representation of the location.

In some embodiments, the visual representation of the location is changed from the third visual appearance to the first visual appearance (e.g., overlaying the at least the portion of the representation of the map) in response to detecting the one or more first inputs, such as the changing of visual appearance of location 611 from as shown in FIG. 6B to as shown in FIG. 6C. In some embodiments, in response to detecting the one or more first inputs adding the location to the second category, the electronic device updates the visual appearance of the representation of the location from the third visual appearance to the second visual appearance. For example, the electronic device optionally updates the display of the representation of the location to include the icon associated with the second visual appearance overlaying a portion of the representation of the location as discussed above. In some embodiments, the electronic device updates the visual appearance of the representation of the location from the third visual appearance to the first visual appearance with the animation discussed above. In some embodiments, the electronic device maintains display of the plurality of representations of locations with the third visual representation while updating the representation of the location from the third visual appearance to the first (and/or the second) visual appearance.

Updating the representation of the location from the third visual appearance to the first visual appearance indicates that the location has been added to the first category while allowing the user to continue viewing the representation of the map without requiring additional user inputs to view the first category to confirm the addition of the location to the first category, thereby reducing the memory load, CPU load, and other computational resources by avoiding the redundancy of multiple programs running simultaneously.

In some embodiments, the first category corresponds to a collection of locations (e.g., a list of locations, optionally displayed in accordance with a chronology of the most recently added locations) that a user of the electronic device has indicated as favorited locations, such as favorites 622 as shown in FIG. 6L and/or the second category 664 as shown in FIG. 6M. In some embodiments, the favorited locations correspond to locations saved to a category frequently visited by the user and/or the user wants to save for future reference.

In some embodiments, after detecting the one or more first inputs, the electronic device displays, via the display generation component, a representation of the collection of locations (optionally at least partially overlaying a portion of the maps user interface), such as included in menu 600 as shown in FIG. 6M, wherein the representation of the collection of locations includes a plurality of visual indications corresponding to respective locations included in the collection of locations, and wherein a respective visual indication corresponding to the location added to the first category visually indicates one or more respective categories associated with the location, wherein the one or more respective categories include at least the first category, such as representations 610a through 610d as shown in FIG. 6N. In some embodiments, the collection of locations comprises a plurality of locations that the user of the electronic device has indicated as a favorite location prior to detecting the one or more first inputs. In some embodiments, the electronic device displays the representation of the collection of locations included in a card with one or more characteristics of the interactable card described above. In some embodiments, the plurality of visual indications corresponding to the respective locations are displayed with one or more characteristics described with reference to the first visual appearance and/or the second visual appearance. In some embodiments, the collection of locations are grouped according to the category that a respective location in the collection of locations belong to. For example, the electronic device optionally displays a subsection of the plurality of locations belonging to the first category as a first section displayed in the representation of the collection of locations. In some embodiments, the displaying respective visual indication includes the displaying an icon with a visual appearance indicating that the respective location is included in the first category. In some embodiments, the electronic device displays a home page (discussed in further detail below) associated with the maps user interface prior to detecting the one or more first inputs. In some embodiments, the home page includes a plurality of selectable options including a first selectable option. In some embodiments, in response to the one or more first inputs directed to the first selectable option, the electronic device displays a menu including the representation of the collection of the locations. In some embodiments, the menu includes a representation of the first category (e.g., pinned category) and a representation of the second category (e.g., guides category). In some embodiments, while the electronic device displays the menu, the electronic device detects a selection input directed at the representation of the collection of the locations and, in response, displays the plurality of visual indications corresponding to the respective locations. In some embodiments, the plurality of selectable options associated with the home page include a plurality of icons corresponding to the plurality of selectable options. For example, the electronic device optionally displays the first selectable option with a “more” text label. In some embodiments, the plurality of visual indications corresponding to respective locations included in the collection of locations include a first visual indication indicating the respective location belongs to the first category. For example, the electronic device optionally displays the first visual indication with the first visual appearance indicating the category belongs to the first category.

Displaying the representation of the collection of locations reduces user input required to individually cause display and/or search for locations included in the collections, thus reducing cognitive load of the user.

In some embodiments, while displaying the representation of the collection of locations, the electronic device detects, via the one or more input devices, one or more second inputs (e.g., the one or more second inputs optionally include one or more characteristics of the one or more first inputs) directed to a representation of a respective location of the collection of locations, such as a input 610 as shown in FIG. 6D. In some embodiments, the electronic device detects the one or more second inputs at a time after detecting the one or more first inputs. In some embodiments, in response to detecting the one or more second inputs, the electronic device displays a selection animation (e.g., highlight of the representation of the respective location, enlargement, and/or pulse). In some embodiments, the selection animation includes one or more characteristics of the update animation as discussed above. In some embodiments, the representation of the respective location comprises a selectable option configured to receive the one or more second inputs displayed in line with a title of the respective location (e.g., name of the location, address of the location, personalized name created by the user).

In some embodiments, in response to detecting the one or more second inputs, the electronic device displays, via the display generation component, a contextual menu (optionally at least partially overlaying a portion of the of the representation of the collection of locations) associated with the respective location including a first selectable option, such as menu 640 as shown in FIG. 6E, optionally including a selectable option similar to or the same as selectable option 625 as shown in FIG. 6O. In some embodiments, the contextual menu includes one or more characteristics of the interactable card described above with reference to the method 700. In some embodiments, the contextual menu corresponds to a location card associated with the respective location. In this example, the electronic device optionally displays the location card overlaying at least a portion of the maps user interface and includes a plurality of selectable options including the first selectable option. In some embodiments, the location card includes one or more characteristics of the location card discussed in further detail below. In some embodiments, the contextual menu includes a plurality of selectable options including the first selectable option. In some embodiments, the first selectable option is configured to detect one or more third inputs described in further detail below. In some embodiments, the electronic device displays the plurality of selectable options with descriptive text associated with the category. For example, the electronic device optionally displays the contextual menu as a card including the first selectable option with a first icon at the top of the card, with the plurality of icons listed in rows below the first selectable option. In some embodiments, the electronic device displays the first selectable option with a higher visual prominence (e.g., brightness, color saturation, and/or size of representation) than a visual prominence than the plurality of selectable options. In some embodiments, the contextual menu includes information (e.g., descriptive text associated with the respective location, images of the respective location, illustrations associated with the respective location) associated with the respective location (e.g., the location card discussed in further detail below). In some embodiments, the electronic device displays the first selectable option with the first visual appearance as described above. In some embodiments, the first selectable option corresponds to the first category. In some embodiments, the electronic device displays the first selectable option with a visual appearance corresponding to a pin icon as described above. In some embodiments, the contextual menu includes a second selectable option (e.g., a share button) configured to transmit the respective location to a second computer system and/or virtual database/website. In some embodiments, the contextual menu includes a third selectable option configured to, in response to the electronic device detecting a user input, remove the respective location from the collection of locations and/or the category.

In some embodiments, while displaying the contextual menu, the electronic device detects, via the one or more input devices, one or more third inputs (e.g., the one or more third inputs optionally include one or more characteristics of the one or more first inputs and/or the one or more second inputs) directed to the first selectable option, such as input 610 as shown in FIG. 6O. In some embodiments, in response to detecting the one or more third inputs the electronic device adds the respective location to a third category, different from the first category and different from the second category, such as corresponding to badge 611c as shown in FIG. 6P. In some embodiments, the third category corresponds to the “pinned” category as described above. In some embodiments, the method of adding the respective location to the third category includes one or more characteristics of the method 700 of adding the respective location to the first category and/or the second category. In some embodiments, in response to adding the respective location to the third category, the electronic device additionally removes the respective location from the first category and/or the second category. For example, prior to the electronic device detecting the one or more third inputs, the respective location belongs to the first category (e.g., “places” category as discussed previously), and in response to the electronic device detecting the one or more third inputs, the electronic device removes the respective location from the first category and adds the respective location to the third category (e.g., the “pinned” category).

In some embodiments, while displaying the contextual menu, the electronic device displays, via the display generation component, a respective second visual indication corresponding to the location included in the collection of locations to visually indicate that the representation of the location in the collection is associated with the third category, such as badge 611c as shown in FIG. 6P. In some embodiments, the electronic device displays, in response to detecting the one or more second inputs, a card (e.g., a contextual menu) including a selectable option overlaying at least a portion of the location card. In this example, the electronic device optionally detects the one or more inputs directed at the selectable option displayed on the card, and in response, optionally adds the respective location to the third category while simultaneously displaying the respective second visual indication. In some embodiments, the respective second visual indication corresponds to the first visual appearance as described above. In some embodiments, the electronic device displays the second visual indication with an updated visual appearance, such as displaying the above-described pin icon. For example, in response to detecting the input adding the respective location to the third location, the electronic device optionally displays the first selectable option with the pin icon highlighted with a color (e.g., green) indicating that the respective location has been added to the category. In some embodiments, the electronic device, in response to adding the respective location to the third category, updates the visual appearance of the respective visual representation of the location to the third visual appearance. In some embodiments, the respective location belongs to the first and/or second category and, in response to detecting the one or more third inputs, the electronic device updates the display of the representation of the respective location at the representation of the map to include the respective second visual indication while the electronic device maintains display of the respective visual appearance(s) corresponding to the first and/or the second category. In some embodiments, when adding the respective location to the third category, the electronic device replaces the respective visual appearance of the representative of the location with the respective second visual indication. Displaying the contextual menu associated with the respective location of the collection of locations increases the number of ways the user may add a respective location to a category based on a user's preference.

In some embodiments, before detecting the one or more first inputs, the electronic device detects, via the one or more input devices, one or more second inputs (e.g., the one or more second inputs include one or more characteristics of the one or more second inputs discussed above) directed to the visual representation of the location, such as input 610 as shown in FIG. 6A. In some embodiments, in response to detecting the one or more second inputs, the electronic device displays, via the display generation component, a user interface (e.g., location card) corresponding to the location including a first selectable option and a second selectable option, wherein the first selectable option is displayed with a first respective visual appearance, and wherein the one or more first inputs includes a first input directed to a respective selectable option included in the user interface corresponding to the location, such as card 630 as shown in FIG. 6B including selectable option 603. In some embodiments, the electronic device displays the representation of the map including the representation of the location prior to detecting the one or more second inputs. In some embodiments, the one or more second inputs include selection of the representation of the location. In response to detecting such a selection, the electronic device optionally displays the user interface that corresponds to the selected location. For example, the electronic device optionally displays buttons included in a location card (e.g., the user interface corresponding to the location).

In some embodiments, the buttons are selectable to perform different operations associated with the location. In some embodiments, the first selectable option is selectable to add the location to a category associated with the library described with reference to method 700. In some embodiments, the second selectable option is selectable to display additional selectable options, respectively selectable to perform further operations related to the location. In some embodiments, the electronic device displays the second selectable option with a third visual characteristic, different than the first visual characteristic (e.g., the visual appearance of the second selectable option is different from the visual appearance of the first selectable option). In some embodiments, the electronic device displays the first selectable option at a location on the location card different than a location of the second selectable option. In some embodiments, the user interface includes descriptive information associated with the location (e.g., location name, address, distance/time away from current location). For example, the location optionally corresponds to a store, and the user interface corresponding to the store optionally includes a plurality of selectable options are optionally selectable to perform functions associated with the store (e.g., open a caller application with the store's website, open the store's website, and/or display a route from the electronic device location to the store). In some embodiments, the first selectable option that is displayed with the first respective visual appearance includes one or more characteristics of the “plus” icon discussed above. In some embodiments, the electronic device updates a visual appearance of the representation of the location in response to the first input as discussed in further detail herein, such as changing the icon to include a checkmark.

Including the first selectable option and the second selectable option at the user interface (optionally the location card) allows the user to perform functions associated with the location while still maintaining a view of the descriptive information associated with the location ensuring greater flexibility with interacting with the maps user interface.

In some embodiments, while displaying the user interface corresponding to the location in response to detecting of the first input directed to the respective selectable option, and in accordance with a determination that the respective selectable option corresponds to the first selectable option, the electronic device updates, via the display generation component, a visual appearance of the first selectable option to be a second respective visual appearance, different from the first respective visual appearance, wherein the location is added to the category in response to detecting the first input that is included in the one or more first inputs, such as the visual appearance of selectable option 603 from as shown in FIG. 6B to as shown in FIG. 6C. For example, when the selection input is directed to the “plus” icon described above, the electronic device optionally updates the visual appearance of the icon in a manner similar to or the same as described above. In some embodiments, the electronic device updates the visual appearance of the first selectable option by displaying the update animation previously discussed above. In some embodiments, the category corresponds to the first category, the second category, and/or the third category as discussed above. In some embodiments, the electronic device displays the visual appearance of the first selectable option as described with reference to the checkmark and/or the plus sign discussed above. In some embodiments, the second respective visual appearance is a predetermined appearance set by the operating system of the electronic device. In some embodiments, in response to detecting the first input, the electronic device changes the color, size, fill pattern, saturation, level of opacity, inclusion of one or more graphics and/or icons, and/or some combination of such aspects of the visual appearance.

In some embodiments, in response to detecting (optionally with the one or more input devices) of the first input directed at the respective selectable option (optionally different than the respective option described above), and in accordance with a determination that the respective selectable option corresponds to the second selectable option, the electronic device displays, via the display generation component, a menu that comprises a plurality of selectable options, wherein each selectable option included in the menu is selectable to initiate an operation associated with the location, such as selectable option 682 as shown in FIG. 6D. For example, the electronic device optionally detects selection of a button or icon that is optionally selectable to display additional or alternative buttons and/or icons that are respectively selectable to perform operations related to the selected location. In some embodiments, the electronic device displays the menu overlaying at least a portion of the maps user interface and/or overlaying the user interface corresponding to the location card. In some embodiments, the electronic device displays the plurality of selectable options as list. In some embodiments, the list is predetermined by the electronic device. In some embodiments, the electronic device displays the list in a ranked order determined by the user and/or a ranked order from most commonly used to least commonly used selectable options by the user. In some embodiments, the plurality of selectable options each include a respective indication corresponding to a respective operation associated with the location. For example, a selectable option of the plurality of selectable options optionally corresponds to an operation to download a map to the location. In this example, the electronic device optionally displays the respective indication corresponding to the operation to download the map as a downward arrow enclosed within an icon. In some embodiments, in response detecting the input adding the location to the first selectable category, the electronic device displays the menu corresponding to the location and/or updates the first visual characteristic of the respective indication to a fourth visual characteristic, different than the first visual characteristic, the second visual characteristic, and the third visual characteristic (e.g., the symbol, color, fill pattern, and/or some combination of those visual characteristics are changed when the location is downloaded). Including the first selectable option and the second selectable option within a single interface allows the user to perform two unrelated operations associated with the location without navigating to a separate interface, streamlining user inputs, and allows the user to perform actions at the menu while the maps user interface remains visible.

In some embodiments, while displaying the menu, the electronic device detects, via the one or more input devices, a selection input directed to a respective first selectable option of the plurality of selectable options, such as input 610 directed to selectable option 640c as shown in FIG. 6H. In some embodiments, the selection input includes one or more characteristics of the one or more first inputs described above with reference to the method 700.

In some embodiments, in response to detecting the selection input directed to the respective first selectable option, the electronic device displays, via the display generation component, a content entry field (e.g., partially overlaying at least a portion of the menu), such as field 635 as shown in FIG. 6J. In some embodiments, the electronic device displays the content entry field as a blank area below the representation of the map that includes a text prompt for the user (e.g., “ADD A NOTE”). In some embodiments, the electronic device displays the content entry field with a visual appearance different than a visual appearance of the maps user interface. For example, the electronic device optionally displays the content entry field with a light color palette (e.g., white, cream, beige), while in contrast, the electronic device optionally displays the maps user interface not overlaid by the content entry field with a dark color palette (e.g., black, grey, silver).

In some embodiments, while displaying the content entry field, the electronic device detects, via the one or more input devices, one or more third inputs including a request to enter information into the content entry field, such as input detected by electronic device from as shown in FIG. 6H to as shown in FIG. 6I. For example, the one or more third inputs have one or more characteristics of one or more inputs described herein, such as of a selection input. In some embodiments, the one or more third inputs includes text entry and/or a selection input directed to a button or icon committing the entered text into the location card.

In some embodiments, after (e.g., and/or in response to) detecting the one or more third inputs, the electronic device displays, via the display generation component, the user interface corresponding to the location including the information added to the content entry field, such as text 635a as shown in FIG. 6J. In some embodiments, the selection input includes one or more characteristics of the first one or more inputs, the second one or more inputs, and/or the one or more third inputs discussed above. In some embodiments, the electronic device displays the first selectable option first in the list discussed above. In some embodiments, the electronic device detects the selection input at a time prior to or after detecting the first selection input discussed in further detail below. In some embodiments, in response to detecting the selection input, the electronic device ceases displaying the menu while maintaining the display of the user interface. In some embodiments, the electronic device updates the display of the user interface to include the content entry field. In some embodiments, the content entry field is configured to receive text input from the user. In some embodiments, the text input corresponds to the one or more third inputs. For example, the user optionally types (e.g., one or more third inputs) “I love this place!” within the content entry field. In some embodiments, the one or more third inputs comprises: the user manually typing, using a keyboard (virtual/mechanical), a copy and paste action, a voice input using speech-to-text technology, autofill utilizing saved text, and/or a drag and drop text transfer between applications. In some embodiments, in response to detecting the one or more third inputs directed at a location in the maps user interface outside the area corresponding to the content entry field (e.g., the user directing the one or more third inputs outside a virtual keyboard), the electronic device cancels the request to enter information into the content entry field and ceases displaying the content entry field. In some embodiments, the content entry field includes a selectable option configured to save the information in the content entry field. In some embodiments, in response to detecting input directed at the previously mentioned selectable option, the electronic device saves the information in the content entry field and ceases displaying the content entry field. In one example, after the one or more third inputs, the user optionally selects a respective representation of a respective location, different than the location, and in response, the electronic device optionally displays a user interface corresponding to the respective location. In this example, after a time period, the user selects the representation of the location and, in response, the electronic device optionally displays the user interface corresponding to the location including the information added to the content entry field (e.g., displays the location card including the user-entered text).

Including the information added to the content entry field at the user interface associated with the location allows the user to include personalized information associated with a respective location that is easily accessible from the user interface (e.g., location card) allowing for greater customizability of the maps user interface.

In some embodiments, while displaying the menu, the electronic device detects, via the one or more input devices, a first selection input directed to the second selectable option, wherein the first selection input is included in the one or more first inputs, such as input 610 directed to selectable option 640b as shown in FIG. 6E. For example, the electronic device optionally detects an input directed to an “add to guide” button, selectable to add the selected location to a guide category. In some embodiments, the first selection input includes one or more characteristics of the one or more second inputs and/or the one or more second inputs. In some embodiments, the electronic device detects the first selection input at a time after detecting the selection input described above. In some embodiments, the electronic device detects the first selection input at a time prior to detecting the selection input described above. In some embodiments, the second selectable option includes one or more characteristics of the first selection option described above. In one example, the second selectable option corresponds to an operation to add the location to a guide. In this example, the electronic device optionally displays the second selectable option as a plus sign enclosed within an icon.

In some embodiments, in response to detecting the first selection input directed to the second selectable option associated with a plurality of collections of locations, the electronic device displays, via the display generation component, a plurality of representations of the plurality of collections of locations (e.g., partially overlaying at least a portion of the selectable list), such as selectable option 650a (e.g., “guides 1”) as shown in FIG. 6F, and/or additional or alternative selectable options. In some embodiments, each of the plurality of representations of the plurality of collections of the locations include a label (e.g., text note, icon, color), where each label is visually distinct. In some embodiments, the plurality of the representations of the plurality of the collections of the locations are configured to detect a second selection input described in further detail below. In some embodiments, the plurality of representations includes a representation corresponding to the creation of a new collection of locations (e.g., the electronic device displays a button to create a new guide and/or to add the location to the newly created guide). In some embodiments, the electronic device detects the one or more inputs directed at the representation corresponding to the creation of the new collection of locations, and in response, the electronic device adds the location to a new collection of locations (e.g., and/or creates the guide based on input specifying a title and/or other information associated with the new guide). In some embodiments, in response to detecting the first selection input, the electronic device ceases displaying the menu while displaying the user interface corresponding to the location. In some embodiments, in response to detecting the first selection input, the electronic device ceases displaying the menu and the user interface corresponding to the location while displaying the home page discussed in further detail below. In some embodiments, the plurality of representations of the plurality of locations are displayed as a scrollable list. For example, the electronic device optionally displays an upper portion of the scrollable list in the maps user interface, and optionally detects an input (e.g., a swiping motion) directed at the plurality of representations of the plurality of collections of locations, and in response, the electronic device optionally displays a lower portion of the scrollable list in the maps user interface.

In some embodiments, while displaying the plurality of representations of the plurality of collections of locations, the electronic device detects, via the one or more input devices, a second selection input, different from the first selection input, that is included in the one or more first inputs and is directed to a respective representation of a respective collection associated with the plurality of representations of the collections, wherein the second selection input adds the location to the category, such as input 610 as shown in FIG. 6F. For example, the electronic device optionally detects selection input directed to a guide (e.g., “Mexico,” “Paris,” or “Denmark”) and optionally adds the location to the guide, additionally or alternatively determining that the location is added to the “Guides” category. In some embodiments, the second selection input includes one or more characteristics of the one or more first inputs described above with reference to the method 700. In some embodiments the electronic device detects the second selection input at a time prior to detecting the first selection input. In some embodiments, the electronic device detects the second selection input at a time after detecting the first selection input. In some embodiments, representation of the respective collection comprises a plurality of locations previously selected by the user. In some embodiments, the representation of the respective collection corresponds to a button or icon selectable to create a new collection. In some embodiments, the representation of the respective collection corresponds to a button or icon selectable to add a new category and/or a new collection. In some embodiments, the electronic device displays the respective representation of the respective collection with an icon corresponding to the plurality of locations within the respective collection. In some embodiments, the respective representation of the respective collection is associated with an empty collection (e.g., doesn't contain a plurality of locations). In some embodiments, in response to detecting the second selection input the electronic device generates the respective collection as described in further detail below. In some embodiments, the electronic device adds the location to the “Guides” category, and/or displays an animation including one or more characteristics of the animation described above. In some embodiments, the electronic device displays a confirmation indication overlaying a portion of the respective representation of the respective collection configured to detect a third selection input. In some embodiments, that in response to detecting the third selection input directed to the respective representation, the electronic device adds the location to the respective collection. In some embodiments, the respective representation of the respective collection optionally corresponds to a one or more characteristics of the plurality of locations in the respective collection. For example, the electronic device optionally displays the respective representation with a label, such as “MEXICO”, where the plurality of locations in the respective collection are each within the geographical bounds of the country of Mexico. In some embodiments, the respective collection includes one or more characteristics of a virtual folder.

Displaying the plurality of representations of the collections of locations allows the user to select a respective collection of locations to add the location while ensuring easy access to the menu (e.g., less than a few user inputs) thereby reducing the cognitive load on the user.

In some embodiments, the respective collection exists before the second selection input is detected, such as the collection corresponding to selectable option 650a as shown in FIG. 6F. For example, the electronic device optionally detects input adding the location to a guide related to New York City that the user created prior to displaying the location card corresponding to the added location. In some embodiments, the respective collection includes a plurality of locations added by the user at a time prior to the electronic device detecting the second selection input. In some embodiments, the respective collection does not include a plurality of locations. For example, the user optionally creates a respective collection with a respective representation labeled “Future Vacation Ideas” that is optionally filled with location(s) at a later time period (e.g., in response to detecting the one or more first inputs) by the user of the electronic device. In some embodiments, in response to detecting the second selection input, the electronic device displays the respective collection as an empty virtual folder prior to adding the location to the respective collection. In some embodiments, the respective collection is a predetermined collection automatically generated by the operating system of the electronic device. In some embodiments, the respective representation of the respective collection is automatically generated by the operating system of the electronic device. In some embodiments, the respective collection exists after the electronic device detects the one or more first inputs and before the electronic device detects the second selection input. In some embodiments, the respective collection exists before the electronic device detects the second selection input and after the electronic device detects the first selection input.

Storing respective collection(s) prior to detecting the one or more first inputs ensures that locations of interest to the user that have been previously selected by the user are stored in an easily accessible location, lowering the cognitive load borne by the user of the electronic device.

In some embodiments, the respective collection is generated in response to detecting the second selection input, such as a new collection generated in response to detecting input directed to selectable option 650b as shown in FIG. 6F. In some embodiments, the electronic device generates the respective collection automatically in response to detecting the second selection input. For example, the second selection input is optionally directed to a “New Guide” button, which is optionally selectable to initiate adding of the location and/or creation of the new guide. In some embodiments, the respective representation of the respective collection is automatically generated by the operating system of the electronic device in response to the electronic device detecting the second selection input. For example, in response to detecting the second selection input, the electronic device optionally generates a label “Guide 1” that corresponds to the representation of the respective collection In some embodiments, the respective collection includes a plurality of locations that include one or more characteristics of the location being added to the respective collection. For example, the plurality of locations and the location each optionally share the same zip code (e.g., 20500). Generating the respective collection allows for greater flexibility for collections where the user is not limited to only adding the respective location to a plurality of predetermined collections but is able to create new collections that better capture the category corresponding to the respective location, increasing the customizability of the maps user interface thus reducing the complexity of categorizing respective locations according to the user's preference.

In some embodiments, after detecting the one or more first inputs that adds the location to the category and while displaying the user interface corresponding to the location including the first selectable option that is displayed with the second respective visual appearance, the electronic device detects, via the one or more input devices, a second input, different from the first input, directed to the first selectable option, such as input 610 as shown in FIG. 6C detected while selectable option 603 includes the check mark. For example, the electronic device optionally detects a selection input directed to the button that was previously selected to add the location to the category. In response to detecting such a selection input, the electronic device optionally removes the location from the category, and/or optionally updates the visual appearance of the button (e.g., first selectable option) to indicate that the location is not saved to the category. In some embodiments, the category is the first category, the second category, or the third category. In some embodiments, the user interface corresponding to the location includes one or more characteristics of the user interface corresponding to the location discussed above. In some embodiments, the electronic device displays the first selectable option with the second respective visual appearance as the “checkmark” described above. In some embodiments, the electronic device detects the one or more first inputs and the second input sequentially (e.g., one immediately after the other). In some embodiments, the second input is one of the one or more first inputs. In some embodiments, the electronic device detects the first input prior to detecting the second input.

In some embodiments, in response to detecting the second input directed to the first selectable option, the electronic device removes, via the one or more input devices, the location from the category (e.g., the first category, the second category and/or the third category), such as removing location 611 form the category as indicated by the visual appearance of location 611 as shown in FIG. 6D. In some embodiments, in response to detecting the second input, the electronic device additionally removes a representation of the location from the card corresponding to the category and/or updates the visual appearance of the first selectable option discussed in further detail below. In some embodiments, prior to detecting the second input and while the electronic device displays the user interface corresponding to the location, the electronic device displays the representation of the location including the badge associated with the category overlaying a portion of the representation of the map (e.g., while the location is included in the category). In this example, in response to the electronic device detecting the second input, the electronic device optionally ceases displaying the badge at the representation of the location.

In some embodiments, in response to detecting the second input directed to the first selectable option, the electronic device updates the visual appearance of the first selectable option from the second respective visual appearance to the first respective visual appearance, such as the visual appearance of selectable option 603 from as shown in FIG. 6C to as shown in FIG. 6D. For example, the electronic device optionally changes the icon from including the checkmark to including a plus sign. In some embodiments, the electronic device updates the visual appearance of the first selectable option from the second respective visual appearance to the first respective visual appearance by displaying the update animation discussed above. In some embodiments, the electronic device removes the location from the category concurrently with updating the appearance of the first selectable option. In some embodiments, the first respective appearance corresponds to the plus sign as discussed above. In some embodiments, the electronic device displays the first selectable option as the button enclosing the plus/checkmark as discussed above. For example, the electronic device optionally updates the visual appearance of the inner content of the first selectable option (e.g., the plus/checkmark) while maintaining displaying the button of the first selectable option.

Updating the visual appearance of the first selectable option when removing the location from the category serves as a visual indication to the user that the location has been removed from the category thus reducing the cognitive load for the user to determine that the location has been successfully removed from the category.

In some embodiments, while displaying the maps user interface, the electronic device displays, via the display generation component, a home page associated with the maps user interface, wherein the home page includes a representation of the library of categories, such as card 620 as shown in FIG. 6L. In some embodiments, the home page associated with the maps user interface includes one or more characteristics of the home page discussed above. In some embodiments, the electronic device displays the home page in response to detecting the one or more first inputs. In some embodiments, the one or more inputs described with reference to method 700 are at least partially directed to content included in the home page. In some embodiments, the electronic device automatically displays the home page when opening the application corresponding to the maps user interface prior to detecting the one or more first inputs. In some embodiments, the home page includes the representation of the library of categories represented as a series of interactable buttons. For example, the electronic device optionally displays the representation of the library of categories with the series of buttons at a virtual shelf at a lower portion of the home page. In some embodiments, the virtual shelf is a two-dimensional box enclosing the series of buttons with a visual appearance different than the visual appearance of the maps user interface. In some embodiments, the electronic device displays the series of buttons aligned with an edge of the of the two-dimensional box described above. In this example, each button optionally corresponds to a respective category and is visually distinct. In some embodiments the library of categories includes the first category, the second category, and/or the third category. In some embodiments, the representation of the library of categories corresponds to a virtual button displayed on the virtual shelf. For example, the electronic device optionally displays a button labeled “More” on an edge of the virtual shelf configured to detect a first selection input discussed in further detail below.

In some embodiments, while displaying the representation of the library of categories, the electronic device detects, via the one or more input devices, a first selection input directed to the representation of the library of categories, such as input 610 as shown in FIG. 6L and/or as shown in FIG. 6M. In some embodiments, the first selection input is one of the one or more first inputs. In some embodiments, the electronic device detects the first selection input at a time prior to detecting the one or more first inputs. In some embodiments, the first selection input is directed at the virtual shelf corresponding to the representation of the library of categories. In some embodiments, the electronic device detects the first selection input directed at the button labeled “More” (e.g., the representation of the library of categories). In some embodiments, the electronic device detects the first selection input prior to detecting the second selection input described above.

In some embodiments, in response to detecting the first selection input, the electronic device displays, via the display generation component, a plurality of representations of the plurality of categories that includes the category, such as categories 662 through 670 as shown in FIG. 6M. In some embodiments, the electronic device displays the plurality of representations of the plurality of categories as a card overlaying a portion of the maps user interface including the home page. In some embodiments, the electronic device ceases displaying the home page in response to detecting the first selection input and/or displays the plurality of representations of the plurality of categories overlaying at least a portion of the maps user interface. In some embodiments, the plurality of representations of the plurality of categories are displayed as a card that includes one or more characteristics of the card(s) described previously. For example, the electronic device optionally displays the card in response to detecting the first selection input directed to a list of categories. In some embodiments, the plurality of representations corresponds to a plurality of labels, images, graphics, and/or videos describing and/or representing the respective category. In some embodiments, the electronic device displays the plurality of representations of the plurality of categories overlaying at least a portion of the representation of the map while the electronic device maintains displaying the home page. In some embodiments, the electronic device displays the category at the top of the vertical list of the plurality of representations of the plurality of categories.

Displaying the home page and/or the representation of the categories reduces user input required to individually navigate to the categories, thereby reducing processing required to perform operations related to excess inputs.

In some embodiments, while displaying the plurality of representations of the plurality of categories, the electronic device detects, via the one or more input devices, a second selection input, different from the first selection input, directed to a visual representation of the first category included in the plurality of representations of the plurality of categories, such as input 610 as shown in FIG. 6M selecting second category 664. In some embodiments, the electronic device detects selection input directed to a category (e.g., a “Guides,” “pins,” or “places” library described with reference to method 700), and in response, displays locations corresponding to the selected category. For example, the second selection input optionally has one or more characteristics described with reference to input(s) selecting a representation of a category above. In some embodiments, the second selection input is one of the one or more first inputs. In some embodiments, the electronic device detects the second input after detecting the first selection input and prior to detecting the one or more first inputs or any combination herein. In some embodiments, the visual representation of the first category corresponds to the category discussed above with reference to the home page. In some embodiments, the visual representation of the first category is visually distinct over the plurality of representations of the plurality of categories. For example, the electronic device optionally displays the visual representation of the first category as highlighted while concurrently displaying the plurality of representations with no highlight. In some embodiments, the visual representation of the first category includes one or more characteristics of the first category discussed above with reference to the method 700.

In some embodiments, in response to detecting the second selection input of the visual representation of the first category, the electronic device displays, via the display generation component, a plurality of representations of locations associated with the first category and a selectable option that is selectable to initiate a search operation associated with the first category, such as representations 610a through 610d as shown in FIG. 6N. For example, the electronic device optionally displays the text and/or images that correspond to locations included in a category that is selected (e.g., in response to the second selection input). In some embodiments, the selectable option corresponding to the search operation is a button and/or icon, such as including text, a magnifying class, and/or a text entry bar or region. In some embodiments, the electronic device detects selection of the selectable option, and in response, initiates a process to search for locations that the user is able to add to the first category. In some embodiments, the electronic device displays the plurality of representations of locations associated with the first category and the selectable option include one or more behaviors of the electronic device displaying the plurality of representations of the plurality of categories that includes the first category. In some embodiments the electronic device displays the plurality of representations overlaying at least a portion of the plurality of representations of the plurality of categories that includes the first category as discussed above. In some embodiments, the selectable option includes one or more characteristics of the first selectable option and/or the second selectable option as discussed above. In some embodiments, the search operation corresponds to an identification command of a respective location of the first category. Responding to the second selection input with displaying the plurality of representations of locations associated with the first category and a selectable option allows the user to visually inspect the respective locations associated with the first category from a centralized location (e.g., the home page), reducing the number of user inputs required to locate a desired location, resulting in a reduced cognitive load for the user.

In some embodiments, while displaying the plurality of representations of locations associated with the first category and the selectable option, the electronic device detects, via the one or more input devices, a third selection input, different than the first selection input and the second selection input, directed to the selectable option, such as input 610 as shown in FIG. 6Q directed to selectable option 621. In some embodiments, the third selection input is an input of the one or more first inputs of the method 700. In some embodiments, the electronic device detects the third input only with the third selection input is directed at the selectable option. In some embodiments, the electronic device detects the third selection input after detecting the first selection input and the second selection input or any combination herein. In some embodiments, the electronic device detects the third selection input prior to detecting the one or more first inputs. In some embodiments the electronic device detects the third selection input after detecting the one or more first inputs.

In some embodiments, in response to detecting the third selection input, the electronic device displays, via the display generation component, a search user interface, wherein the search user interface includes a selectable query option, such as user interface 660 as shown in FIG. 6R including search bar 644. In some embodiments, the electronic device displays the search user interface overlaying at least a portion of the plurality of representations of locations associated with the first category. In some embodiments, in response to detecting the third selection input, the electronic device displays the search user interface at a location at the maps user interface directly underneath the selectable option while overlaying the at least the portion of the plurality of representations of the locations associated with the first category. In some embodiments, the electronic device displays the search user interface including the selectable query option as a search bar disposed at a location above the plurality of the representations of the plurality of locations. For example, the electronic device optionally displays the selectable query option as a search bar (e.g., such as typically found in webpages or application windows) with a visible border and placeholder text (e.g., “Search . . . ”) optionally next to a search icon, such a magnifying glass, configured to detect a user input (e.g., one or more first inputs) to submit a query by the user. In some embodiments, the search user interface includes a plurality of locations associated with the first location discussed in further detail below. In some embodiments, the search user interface includes a list of prior search requests at the search user interface.

In some embodiments, while displaying the search user interface and the selectable query option, the electronic device detects, via the one or more input devices, a fourth selection input directed to the selectable query option, different from the first selection input, the second selection input, and the third selection input, such as input directed to search bar 644 as shown in FIG. 6R. In some embodiments, the fourth selection input is an input of the one or more first inputs of the method 700. In some embodiments, the electronic device detects the fourth selection input after detecting the first selection input, the second selection input, and the third selection input or any combination herein. In some embodiments, the electronic device detects the fourth selection input prior to detecting the one or more first selection inputs. In some embodiments, the electronic device detects the fourth selection input after detecting the one or more first inputs. In some embodiments, the fourth selection input comprises a text input. For example, the electronic device optionally detects the text input (e.g., the fourth selection input) directed at the selectable query option (e.g., search bar discussed above), wherein the user of the electronic device types “Gas stations near me” and in response, the electronic device displays a plurality of suggested locations corresponding to the text input. In this example, the electronic device optionally detects a further fifth selection input directed to the search icon discussed above, confirming the search request, and in response, the electronic device optionally displays at the representation of the map, a plurality of representations of locations corresponding to the search request and the plurality of suggest locations corresponding to the text input.

In some embodiments, in response to detecting the fourth selection input directed to the selectable query option, the electronic device displays, via the display generation component, a plurality of suggested search requests, such as similar to or the same as locations 624 including location 624a as shown in FIG. 6R. In some embodiments, the electronic device displays the plurality of suggested search results prior to detecting the fourth selection input. In some embodiments, the electronic device displays the plurality of suggested search results while detecting the fourth selection input (e.g., an autocomplete feature). In some embodiments, the plurality of suggested search results is updated while the electronic device detects the fourth selection input. For example, the user optionally beings to type “Par” into the selectable query option, and in response, the electronic device optionally displays a list of suggested nearby parks In this example, the user optionally completes the fourth selection input with “Paris”, and in response, the electronic device optionally updates the list of suggested gas stations to a list of suggested locations associated with the city of Paris.

Showing a search process through a series of user inputs, each triggering specific changes in the display allows the electronic device to dynamically adapt to user actions, providing relevant tools and/or locations at appropriate times, and offering suggested search terms to facilitate quicker and more efficient information retrieval

In some embodiments, in response to detecting the second selection input directed to the visual representation of the first category, the electronic device displays, via display generation component, a plurality of visual indications, wherein the plurality of visual indications indicates an association between respective locations of the plurality of locations and one or more of the plurality of categories, such as indications included in and/or corresponding to representations 610a through 610d as shown in FIG. 6Q. For example, the electronic device optionally displays an icon and/or badge visually indicating that locations visually represented in the user interface are included in one or more categories. In some embodiments, the plurality of visual indications includes one or more characteristics of the visual appearance of the visual representation of the location with the first visual appearance discussed above with reference to the method 700. For example, the plurality of visual indications optionally includes one or more characteristics of the badge associated with the representation of the location discussed above. In some embodiments, the second selection input includes one or more characteristics of the second selection input discussed above with reference to the plurality of representations of the locations associated with the first category and the selectable option, and the plurality of suggested search requests. In some embodiments, the electronic device displays the plurality of visual indications overlaying at least a portion of the home page. In some embodiments, in response to detecting the second selection input, the electronic device ceases displaying the plurality of representations of the plurality of categories while generating the display of the plurality of visual indications. In some embodiments, the electronic device displays the home page, the plurality of representations of the plurality of categories, and the plurality of visual indications concurrently In some embodiments, a visual indication of the plurality of visual indications corresponds to the badge associated with the representation of the location the electronic device displays at the representation of the map. For example, the electronic device optionally displays a representation of a location associated with the first category. In this example, the electronic device displays the representation of the location with the first appearance (e.g., badge corresponding to the first appearance), and in the plurality of visual indications, the electronic device displays a location with a visual indication corresponding to the first appearance (e.g., the same badge displayed at the representation of the location). In some embodiments, the electronic device displays a plurality of visual for a single location (e.g., the location belongs to a plurality of categories). In some embodiments, the electronic device displays the plurality of visual indications enclosed in a card with one or more characteristics of the card(s) described above. Including a visual indication associated with the category for a respective location creates a quick visual association for the user to identify the category the respective location belongs to, reducing user error when identifying locations belonging to a respective category.

In some embodiments, while displaying the plurality of representations of locations associated with the first category the electronic device detects, via the one or more input devices, one or more second inputs, different from the one or more first inputs, directed to one or more representations of locations of the plurality of locations, such as input directed to representation 610a and/or input 610 directed to selectable option 613a as shown in FIG. 6N. For example, the electronic device optionally detects selection of one or more locations, changing a state of selection associated with those collections. In some embodiments, the one or more second inputs include an input to add the selected locations to a category. In some embodiments, the one or more second inputs include at least one characteristic of the one or more first inputs described above with reference to the method 700. In some embodiments, the electronic device detects the one or more second inputs while displaying the plurality of representations of locations associated with the first category. In some embodiments, the electronic device detects the one or more second inputs prior or after detecting the one or more first inputs. In some embodiments, the electronic device detects the one or more second inputs directed at a single representation of the one or more representations of locations at a time (e.g., electronic device cannot detect inputs directed at one or more representations of locations simultaneously). In some embodiments, the one or more second inputs select a subsection of the plurality of locations to perform an operation related to the subsection of the plurality of locations discussed in further detail below. In some embodiments, the one or more second inputs are directed to the one or more representations of locations sequentially. For example, the electronic device optionally detects the one or more second inputs directed at a first location of the plurality of locations at a first time and detects the one or more second inputs directed at a second location of the plurality of locations at a second time after the first time.

In some embodiments, in response to detecting the one or more second inputs the electronic device adds the one or more locations to the second category, such as the pinned category indicated by badge 611c displayed in response to detecting input 610 as shown in FIG. 6O. In some embodiments, the electronic device adds the one or more locations to the second category immediately in response to detecting the one or more second inputs. In some embodiments, the electronic device removes the one or more locations from their respective categories while adding the one or more locations to the second category. In some embodiments, when the electronic device determines a respective location of the one or more locations belongs to the second category, the electronic device forgoes adding the respective location to the second category. In some embodiments, in response to detecting the one or more second inputs, the electronic device updates the representations of the one or more locations displayed on the representation of the map with a respective visual appearance corresponding to the second category, such as displaying an icon and/or badge correspond to the second category that was previously displayed.

In some embodiments, in response to detecting the one or more second inputs the electronic device displays, via the display generation component, respective first visual indications included in the plurality of visual indications to indicate the association between the second category and the one or more locations of the plurality of locations, such as location 611 including badge 611c as shown in FIG. 6P. In some embodiments, the respective first visual indications are displayed with and/or have one or more characteristics of the first visual appearance, the second visual appearance, and/or the third visual appearance of the representation of the location as previously discussed with reference to the method 700. In some embodiments, electronic device updates the respective visual indication with the update animation previously discussed above. In some embodiments, the electronic device displays the respective first visual indication after adding the one or more locations to the second category. In some embodiments, the electronic device displays the representations of the one or more locations with the respective visual appearance associated with the second category while the electronic device displays the respective first visual indications (e.g., the electronic device displays icons indicating that the location belons in a given category in the representation of the map and/or in the maps user interface). In some embodiments, the association between the second location and the second category is indicated with a visual appearance distinct from the first visual appearance, the second visual appearance, and/or the third visual appearance.

Displaying the respective first visual indications illustrates for the user of the electronic device a quick and easy method of identification that the one or more locations have been successfully added to the second category without the need for the user to navigate to a different portion of the maps user interface, reducing the number of required user inputs required to otherwise navigate to the different portion of the maps user interface, resulting in a reduced computational and user cognitive load.

It should be understood that the particular order in which the operations in FIG. 7 have been described is merely exemplary and is not intended to indicate that the described order is the only order in which the operations could be performed. One of ordinary skill in the art would recognize various ways to reorder the operations described herein. Additionally, it should be noted that details of other processes described herein with respect to other additional or alternative operations are also applicable in an analogous manner to method 700 described above with respect to FIG. 7. For brevity, these details are not repeated here.

The operations in the information processing methods described above are, optionally, implemented by running one or more functional modules in an information processing apparatus such as general purpose processors (e.g., as described with respect to FIGS. 1A-1B, 3, 5A-5H) or application specific chips. Further, the operations described above with reference to FIG. 7 are, optionally, implemented by components depicted in FIGS. 1A-1B. For example, displaying operations 710, 712, detecting operation 704, and adding operation 706, are, optionally, implemented by event sorter 170, event recognizer 180, and event handler 190. When a respective predefined event or sub-event is detected, event recognizer 180 activates an event handler 190 associated with the detection of the event or sub-event. Event handler 190 optionally utilizes or calls data updater 176 or object updater 177 to update the application internal state 192. In some embodiments, event handler 190 accesses a respective GUI updater 178 to update what is displayed by the application. Similarly, it would be clear to a person having ordinary skill in the art how other processes can be implemented based on the components depicted in FIGS. 1A-1B.

As described above, one aspect of the present technology is tracking and displaying content. The present disclosure contemplates that in some instances, the data utilized may include personal information data that uniquely identifies or can be used to contact or locate a specific person. Such personal information data can include demographic data, event data, content consumption activity, location-based data, telephone numbers, email addresses, twitter ID's, home addresses, data relating to a person's likeness, name, date of birth, or any other identifying or personal information.

The present disclosure recognizes that the use of such personal information data, in the present technology, can be used to the benefit of users. For example, using information from patterns of interaction with a physical environment and/or a mapping application. Accordingly, use of such personal information data enables users to use electronic devices to perform enhanced operations with interacting with representations of maps and/or locations. Further, other uses for personal information data that benefit the user are also contemplated by the present disclosure. For instance, presenting locations and/or information associated with locations.

The present disclosure contemplates that the entities responsible for the collection, analysis, disclosure, transfer, storage, or other use of such personal information data will comply with well-established privacy policies and/or privacy practices. In particular, such entities should implement and consistently use privacy policies and practices that are generally recognized as meeting or exceeding industry or governmental requirements for maintaining personal information data private and secure. Such policies should be easily accessible by users, and should be updated as the collection and/or use of data changes. Personal information from users should be collected for legitimate and reasonable uses of the entity and not shared or sold outside of those legitimate uses. Further, such collection/sharing should occur after receiving the informed consent of the users. Additionally, such entities should consider taking any needed steps for safeguarding and securing access to such personal information data and ensuring that others with access to the personal information data adhere to their privacy policies and procedures. Further, such entities can subject themselves to evaluation by third parties to certify their adherence to widely accepted privacy policies and practices. In addition, policies and practices should be adapted for the particular types of personal information data being collected and/or accessed and adapted to applicable laws and standards, including jurisdiction-specific considerations. For instance, in the US, collection of or access to certain health data may be governed by federal and/or state laws, such as the Health Insurance Portability and Accountability Act (HIPAA); whereas health data in other countries may be subject to other regulations and policies and should be handled accordingly. Hence different privacy practices should be maintained for different personal data types in each country.

Despite the foregoing, the present disclosure also contemplates embodiments in which users selectively block the use of, or access to, personal information data. That is, the present disclosure contemplates that hardware and/or software elements can be provided to prevent or block access to such personal information data. For example, in the case of location services, the present technology can be configured to allow users to select to “opt in” or “opt out” of participation in the collection of personal information data during registration for services or anytime thereafter. In another example, users can select not to enable recording of personal information data in a specific application (e.g., first application and/or second application). In addition to providing “opt in” and “opt out” options, the present disclosure contemplates providing notifications relating to the access or use of personal information. For instance, a user may be notified upon initiating content collection that their personal information data will be accessed and then reminded again just before personal information data is accessed by the device(s).

Moreover, it is the intent of the present disclosure that personal information data should be managed and handled in a way to minimize risks of unintentional or unauthorized access or use. Risk can be minimized by limiting the collection of data and deleting data once it is no longer needed. In addition, and when applicable, including in certain health related applications, data de-identification can be used to protect a user's privacy. De-identification may be facilitated, when appropriate, by removing specific identifiers (e.g., date of birth, etc.), controlling the amount or specificity of data stored (e.g., collecting location data a city level rather than at an address level), controlling how data is stored (e.g., aggregating data across users), and/or other methods.

Therefore, although the present disclosure broadly covers use of personal information data to implement one or more various disclosed embodiments, the present disclosure also contemplates that the various embodiments can also be implemented without the need for accessing such personal information data. That is, the various embodiments of the present technology are not rendered inoperable due to the lack of all or a portion of such personal information data. For example, an electronic device optionally displays a representation of a location and/or information associated with the location without associating the content with personal user data.

It is well understood that the use of personally identifiable information should follow privacy policies and practices that are generally recognized as meeting or exceeding industry or governmental requirements for maintaining the privacy of users. In particular, personally identifiable information data should be managed and handled so as to minimize risks of unintentional or unauthorized access or use, and the nature of authorized use should be clearly indicated to users.

The foregoing description, for purpose of explanation, has been described with reference to specific embodiments. However, the illustrative discussions above are not intended to be exhaustive or to limit the invention to the precise forms disclosed. Many modifications and variations are possible in view of the above teachings. The embodiments were chosen and described in order to best explain the principles of the invention and its practical applications, to thereby enable others skilled in the art to best use the invention and various described embodiments with various modifications as are suited to the particular use contemplated.

What is claimed is:

1. A method comprising:
at an electronic device in communication with one or more input devices and a display generation component:
while displaying, via the display generation component, a maps user interface:
detecting, via the one or more input devices, one or more first inputs including a request to add a location to a category associated with a plurality of categories in a library of categories associated with the maps user interface; and
in response to detecting the one or more first inputs, adding the location to the category; and
after adding the location to the category, and while displaying a representation of a map in the maps user interface including a region of the representation of the map that corresponds to the location:
in accordance with a determination that the category is a first category of the plurality of categories, displaying, via the display generation component, a visual representation of the location with a first visual appearance overlaying at least a portion of the representation of the map; and
in accordance with a determination that the category is a second category, different than the first category, displaying, via the display generation component, the visual representation of the location with a second visual appearance, different than the first visual appearance, overlaying the at least the portion of the representation of the map.

2. The method of claim 1, further comprising:
after adding the location to the category, and while displaying the representation of the map in the maps user interface including the region of the representation of the map that corresponds to the location:
in accordance with a determination that the category is a third category, different from the first category and different from the second category, displaying, via the display generation component, the visual representation of the location with a third visual appearance, different than the first visual appearance and the second visual appearance, overlaying at least the portion of the representation of the map.

3. The method of claim 2, wherein displaying the maps user interface includes displaying information corresponding to the respective location including an icon with a visual appearance corresponding to a respective first visual appearance; and in response to detecting the one or more first inputs, and in accordance with a determination that the category corresponds to the third category, updating the visual appearance of the icon from the respective first visual appearance to a respective second visual appearance, different than the respective first visual appearance.

4. The method of claim 1, wherein:
the one or more first inputs including the request to add the location to the category associated with the maps user interface are detected while the electronic device displays the representation of the location with a third visual appearance, different from the first visual appearance and different from the second visual appearance, in the maps user interface, and
the visual representation of the location is changed from the third visual appearance to the first visual appearance in response to detecting the one or more first inputs.

5. The method of claim 1, wherein the first category corresponds to a collection of locations that a user of the electronic device has indicated as favorited locations, the method further comprising:
after detecting the one or more first inputs, displaying, via the display generation component, a representation of the collection of locations, wherein the representation of the collection of locations includes a plurality of visual indications corresponding to respective locations included in the collection of locations, and wherein a respective visual indication corresponding to the location added to the first category visually indicates one or more respective categories associated with the location, wherein the one or more respective categories include at least the first category.

6. The method of claim 5, further comprising:
while displaying the representation of the collection of locations:
detecting, via the one or more input devices, one or more second inputs directed to a representation of a respective location of the collection of locations;
in response to detecting the one or more second inputs, displaying, via the display generation component, a contextual menu associated with the respective location including a first selectable option; and
while displaying the contextual menu, detecting, via the one or more input devices, one or more third inputs directed to the first selectable option; and
in response to detecting the one or more third inputs:
adding the respective location to a third category, different from the first category and different from the second category; and
displaying, via the display generation component, a respective second visual indication corresponding to the location included in the collection of locations to visually indicate that the representation of the location in the collection is associated with the third category.

7. The method of the claim 1, further comprising:
before detecting the one or more first inputs, detecting, via the one or more input devices, one or more second inputs directed to the visual representation of the location; and
in response to detecting the one or more second inputs, displaying, via the display generation component, a user interface corresponding to the location including a first selectable option and a second selectable option, wherein the first selectable option is displayed with a first respective visual appearance, and wherein the one or more first inputs includes a first input directed to a respective selectable option included in the user interface corresponding to the location.

8. The method of claim 7, further comprising:
while displaying the user interface corresponding to the location:
in response to detecting of the first input directed to the respective selectable option, and in accordance with a determination that the respective selectable option corresponds to the first selectable option, updating, via the display generation component, a visual appearance of the first selectable option to be a second respective visual appearance, different from the first respective visual appearance, wherein the location is added to the category in response to detecting the first input that is included in the one or more first inputs; and
in response to detecting of the first input directed at the respective selectable option, and in accordance with a determination that the respective selectable option corresponds to the second selectable option displaying, via the display generation component, a menu that comprises a plurality of selectable options, wherein each selectable option included in the menu is selectable to initiate an operation associated with the location.

9. The method of claim 8, further comprising, while displaying the menu:
detecting, via the one or more input devices, a selection input directed to a respective first selectable option of the plurality of selectable options;
in response to detecting the selection input directed to the respective first selectable option, displaying, via the display generation component, a content entry field;
while displaying the content entry field, detecting, via the one or more input devices, one or more third inputs including a request to enter information into the content entry field; and
after detecting the one or more third inputs, displaying, via the display generation component, the user interface corresponding to the location including the information added to the content entry field.

10. The method of claim 8, further comprising:
while displaying the menu, detecting, via the one or more input devices, a first selection input directed to the second selectable option, wherein the first selection input is included in the one or more first inputs;
in response to detecting the first selection input directed to the second selectable option associated with a plurality of collections of locations, displaying, via the display generation component, a plurality of representations of the plurality of collections of locations; and
while displaying the plurality of representations of the plurality of collections of locations, detecting, via the one or more input devices, a second selection input, different from the first selection input, that is included in the one or more first inputs and is directed to a respective representation of a respective collection associated with the plurality of representations of the collections, wherein the second selection input adds the location to the category.

11. The method of claim 10, wherein the respective collection exists before the second selection input is detected.

12. The method of claim 10, wherein the respective collection is generated in response to detecting the second selection input.

13. The method of claim 7, further comprising:
after detecting the one or more first inputs that adds the location to the category and while displaying the user interface corresponding to the location including the first selectable option that is displayed with the second respective visual appearance, detecting, via the one or more input devices, a second input, different from the first input, directed to the first selectable option; and
in response to detecting the second input directed to the first selectable option:
removing, via the one or more input devices, the location from the category; and
updating the visual appearance of the first selectable option from the second respective visual appearance to the first respective visual appearance.

14. The method of claim 1, further comprising:
while displaying the maps user interface, displaying, via the display generation component, a home page associated with the maps user interface, wherein the home page includes a representation of the library of categories;
while displaying the representation of the library of categories, detecting, via the one or more input devices, a first selection input directed to the representation of the library of categories; and
in response to detecting the first selection input, displaying, via the display generation component, a plurality of representations of the plurality of categories that includes the category.

15. The method of claim 14, further comprising:
while displaying the plurality of representations of the plurality of categories, detecting, via the one or more input devices, a second selection input, different from the first selection input, directed to a visual representation of the first category included in the plurality of representations of the plurality of categories; and
in response to detecting the second selection input of the visual representation of the first category, displaying, via the display generation component, a plurality of representations of locations associated with the first category and a selectable option that is selectable to initiate a search operation associated with the first category.

16. The method of claim 15, further comprising:
while displaying the plurality of representations of locations associated with the first category and the selectable option, detecting, via the one or more input devices, a third selection input, different than the first selection input and the second selection input, directed to the selectable option;
in response to detecting the third selection input, displaying, via the display generation component, a search user interface, wherein the search user interface includes a selectable query option;
while displaying the search user interface and the selectable query option, detecting, via the one or more input devices, a fourth selection input directed to the selectable query option, different from the first selection input, the second selection input, and the third selection input; and
in response to detecting the fourth selection input directed to the selectable query option, displaying, via the display generation component, a plurality of suggested search requests.

17. The method of claim 15, further comprising:
in response to detecting the second selection input directed to the visual representation of the first category, displaying, via display generation component, a plurality of visual indications, wherein the plurality of visual indications indicates an association between respective locations of the plurality of locations and one or more of the plurality of categories.

18. The method of claim 5, further comprising, while displaying the plurality of representations of locations associated with the first category:
detecting, via the one or more input devices, one or more second inputs, different from the one or more first inputs, directed to one or more representations of locations of the plurality of locations; and in response to detecting the one or more second inputs:
adding the one or more locations to the second category; and
displaying, via the display generation component, respective first visual indications included in the plurality of visual indications to indicate the association between the second category and the one or more locations of the plurality of locations.

19. An electronic device that is in communication with one or more display generation components and one or more input devices, the electronic device comprising:
one or more processors;
memory; and
one or more programs, wherein the one or more programs are stored in the memory and configured to be executed by the one or more processors, the one or more programs including instructions for:
while displaying, via the display generation component, a maps user interface:
detecting, via the one or more input devices, one or more first inputs including a request to add a location to a category associated with a plurality of categories in a library of categories associated with the maps user interface; and
in response to detecting the one or more first inputs, adding the location to the category; and
after adding the location to the category, and while displaying a representation of a map in the maps user interface including a region of the representation of the map that corresponds to the location:
in accordance with a determination that the category is a first category of the plurality of categories, displaying, via the display generation component, a visual representation of the location with a first visual appearance overlaying at least a portion of the representation of the map; and
in accordance with a determination that the category is a second category, different than the first category, displaying, via the display generation component, the visual representation of the location with a second visual appearance, different than the first visual appearance, overlaying the at least the portion of the representation of the map.

20. A non-transitory computer readable storage medium storing one or more programs, the one or more programs comprising instructions, which when executed by one or more processors of an electronic device, cause the electronic device to perform a method comprising:
while displaying, via a display generation component, a maps user interface:
detecting, via one or more input devices, one or more first inputs including a request to add a location to a category associated with a plurality of categories in a library of categories associated with the maps user interface; and
in response to detecting the one or more first inputs, adding the location to the category; and
after adding the location to the category, and while displaying a representation of a map in the maps user interface including a region of the representation of the map that corresponds to the location:
in accordance with a determination that the category is a first category of the plurality of categories, displaying, via the display generation component, a visual representation of the location with a first visual appearance overlaying at least a portion of the representation of the map; and
in accordance with a determination that the category is a second category, different than the first category, displaying, via the display generation component, the visual representation of the location with a second visual appearance, different than the first visual appearance, overlaying the at least the portion of the representation of the map.
